(19) United States
(12) Patent Application Publication
(10) Pub. No.: US 2012/0191434 A1
(43) Pub. Date: Jul. 26, 2012

(54) ARTICLES OF MANUFACTURE AND METHODS FOR MODELING CHINESE HAMSTER OVARY (CHO) CELL METABOLISM

(75) Inventor: Imandokht Famili, San Diego, CA (US)

(73) Assignee: GT LIFE SCIENCES, INC., San Diego, CA (US)

(21) Appl. No.: 13/217,178

(22) Filed: Aug. 24, 2011

Related U.S. Application Data
(60) Provisional application No. 61/402,273, filed on Aug. 25, 2010.
(60) Provisional application No. 61/379,366, filed on Sep. 1, 2010.

(51) Int. Cl. G06G 7/60; G06F 19/12

(52) U.S. Cl. 703/11

(57) ABSTRACT

The invention provides a Chinese Hamster Ovary (CHO) cell model and methods of using such a model. The invention provides methods and computer readable medium or media containing such models and methods.

This application claims the benefit of priority of U.S. Provisional application Ser. No. 61/402,273, filed Aug. 25, 2010, and U.S. Provisional application Ser. No. 61/379,366, filed Sep. 1, 2010, the entire contents of each application are incorporated herein by reference.

Tables 1-3 and 5-7 associated with this application are provided via EFS-Web in lieu of a paper copy, and are hereby incorporated by reference into the specification. The files containing Tables 1-3 and 5-7 are entitled 448164-999008_Table1.txt; 448164-999008_Table2.txt; 448164-999008_Table3.txt; 448164-999008_Table5.txt; 448164-999008_Table6.txt; and 448164-999008_Table7.txt, which are 97.3 KB, 14.8 KB, 3.2 KB, 89.7 KB, 14.7 KB, and 66.7 KB, in size, respectively, and were created on Aug. 24, 2011.

LENGTHY TABLES
The patent application contains a lengthy table section. A copy of the table is available in electronic form from the USPTO web site (http://seqdata.uspto.gov/?pageRequest=docDetail&DocID=US20120191434A1). An electronic copy of the table will also be available from the USPTO upon request and payment of the fee set forth in 37 CFR 1.19(b)(3).

### BACKGROUND OF THE INVENTION

The present invention relates generally analysis of the activity of chemical reaction networks and, more specifically, to computational methods for simulating and predicting the activity of CHO cell metabolism.

Protein-based therapeutic products have contributed immensely to healthcare and constitute a large and growing percentage of the total pharmaceutical market. Therapeutic proteins first entered the market less than 20 years ago and have already grown to encompass 10-30% of the total US market for pharmaceuticals. The trend towards therapeutic proteins is accelerating. In recent years, more than half of the new molecular entities to receive FDA approval were biologics produced mostly in mammalian cell systems, and an estimated 700 or more protein-based therapeutics are at various stages of clinical development, with 150 to 200 in late-stage trials.

Over the past two decades, substantial progress has been made to overcome some of the key barriers to large-scale mammalian cell culture, including improvements in vector design, host cell engineering, medium development, screening methods and process engineering, resulting in yield improvements of up to 100-fold over titers seen in the mid 1980's. Despite these improvements, developing new biopharmaceutical products remains an expensive and lengthy process, typically taking six years from pre-clinical process development to product launch, where 20-30% of the total cost is associated with process development and clinical manufacturing. Production costs by mammalian cell culture remain high, and new methods to provide a more effective approach to optimize overall process development are of highest interest to the industry, particularly as regulatory constraints on development timelines remain stringent and production demands for new therapeutics are rapidly rising, especially for the quantities required for treatment of chronic diseases. Production costs are a major concern for management planning, especially with intense product competition, patent expirations, introduction of second-generation therapeutics and accompanying price pressure, and pricing constraints imposed by regulators and reimbursement agencies. Reducing the cost of therapeutic protein development and manufacturing would do much to ensure that the next generation of medicines can be created in amounts large enough to meet patients' needs, and at a price low enough that patients can afford.

Thus, there exists a need for a model that describes Chinese Hamster Ovary (CHO) cells metabolic network, which can be used for bioproduction of desired products such as biologics. The present invention satisfies this need and provides related advantages as well.

### SUMMARY OF INVENTION

The invention provides models and methods useful for modeling a CHO cell. The invention provides methods and computer readable medium or media containing such methods. Such a computer readable medium or media can comprise commands for carrying out a method of the invention. The methods of the invention can be utilized to model characteristics of a CHO cell line, for example, product production, growth, culture characteristics, and the like. The invention provides models and methods useful for optimizing CHO cell lines. The invention provides computer readable medium or media. Such a computer readable medium or media can comprise a data structure relating a plurality of reactants to a plurality of reactions from a CHO cell and in some aspects of the invention the data structure further comprises relating a plurality of reactants to a plurality of reactions from a CHO cell transcriptome, each of the reactions comprising a reactant identified as a substrate of the reaction, a reactant identified as a product of the reaction and a stoichiometric coefficient relating the substrate and the product; a constraint set for said plurality of reactions for said data structures, and commands for determining at least one flux distribution that minimizes or maximizes an objective function when the constraint set is applied to the data structure, wherein the at least one flux distribution is predictive of a physiological function of the CHO cell. The invention additionally provides methods for predicting a physiological function of a CHO cell, such as, growth, energy production, redox equivalent production, biomass production, production of biomass precursors, production of a protein, production of an amino acid, production of a purine, production of a pyrimidine, production of a lipid, production of a fatty acid, production of a cofactor, transport of a metabolite, and consumption of carbon, nitrogen, sulfur, phosphate, hydrogen or oxygen.

### BRIEF DESCRIPTION OF THE DRAWINGS

FIG. 1 shows a model-driven media optimization in CHO cell culture. Reported is the % increase over baseline (control) performance that model-based media formulations to reduce byproducts and increase growth and product titer achieved (Designs 1, 2, and 3), as well as an industry standard depletion analysis (Depletion).

### DETAILED DESCRIPTION OF THE INVENTION

The invention provides in silico models of Chinese Hamster Ovary (CHO) cells that describe the interconnections between genes in a cell genome and their associated reactions and reactants. As disclosed herein, protein-based therapeutic products have contributed immensely to healthcare and constitute a large and growing percentage of the total pharmaceutical drugs. The majority of these FDA approved products are manufactured using mammalian cell culture systems. Over the past 10-20 years substantial progress has been made to overcome some of the key barriers to large-scale mammalian cell culture. Despite these improvements, the development of new biopharmaceutical products remains an expensive and lengthy process, where 20-30% of the total cost is associated with process development and clinical manufacturing. Production of therapeutic protein in mammalian cell lines is hampered by a number of standing issues. For example, selection of high-producing mammalian cell lines represents a bottleneck in process development for the production of biopharmaceuticals. Production of therapeutic proteins in mammalian cell lines has been dominated by the use of selection markers that have metabolic origin. However, the current selection methods are hampered by a number of disadvantages, including extensive development timelines and cost. In addition, most process optimization strategies are currently performed using a trial and error approach where cells are treated as a ‘black box’ and process outputs are improved over several months by laborious experimentation. These empirical optimization techniques are widely used because in most cases little is known about the underlying physiological interactions that impact growth and protein production in the host cell lines. A fundamental understanding of cell line physiology and metabolism, enabled by computational modeling and simulation technologies, can greatly improve and accelerate media and process development in mammalian cell line systems.

The invention provides a computer readable medium or media having stored thereon computer executable commands for performing the steps of providing a data structure relating a plurality of reactants to a plurality of reactions, wherein the plurality of reactants and the plurality of reactions are a selection of reactants and reactions as shown in Tables 1, 3 and 4 for a Chinese hamster ovary (CHO) cell, and wherein the data structure relates a plurality of reactants and a plurality of reactions selected from the reactants and reactions as shown in Tables 1 and 2 for a CHO cell transcriptome; providing a constraint set for the plurality of reactions for the data structure; and determining at least one flux distribution that minimizes or maximizes an objective function when the constraint set is applied to the data structure, wherein the at least one flux distribution is predictive of a physiological function of the CHO cell or a culture condition for the CHO cell.

The invention provides a computer readable medium or media having stored thereon computer executable commands for performing the steps of providing a data structure relating a plurality of reactants to a plurality of reactions, wherein the plurality of reactants and the plurality of reactions are a selection of reactants and reactions as shown in Tables 5, 8, and 9 for a Chinese hamster ovary (CHO) cell, and wherein the data structure relates a plurality of reactants and a plurality of reactions selected from the reactants and reactions as shown in Tables 5, 6 and 7 for a CHO cell transcriptome; providing a constraint set for the plurality of reactions for the data structure; and determining at least one flux distribution that minimizes or maximizes an objective function when the constraint set is applied to the data structure, wherein the at least one flux distribution is predictive of a physiological function of the CHO cell or a culture condition for the CHO cell.

The objective function can be, for example, uptake rate of two or more nutrients, wherein the two or more nutrients are carbon sources, product formation, energy synthesis, biomass production, or a combination thereof, decreasing byproduct formation. In the computer readable medium or media of the invention, the culture condition can be selected from the group consisting of optimized culture medium for the cell, optimized cell culture process, optimized cell productivity, and metabolic engineering of the cell. In a particular embodiment, the optimized cell productivity can be increased biomass production or increased product yield. Additionally, the culture condition can be reduced scale up variability, reduced batch to batch variability, reduced clonal variability, improved cell growth, or viable cell density or cell productivity in exponential growth phase or stationary phase.

In a computer readable medium or media of the invention, the physiological function can be selected from the group consisting of growth, energy production, redox equivalent production, biomass production, production of biomass precursors, production of a protein, production of an amino acid, production of a purine, production of a pyrimidine, production of a lipid, production of a fatty acid, production of a cofactor, transport of a metabolite, and consumption of carbon, nitrogen, sulfur, phosphate, hydrogen or oxygen.

In another embodiment, the computer readable medium or media of the invention can include a plurality of reactions comprising at least one reaction from peripheral metabolic pathway. A peripheral metabolic pathway can be, for example, amino acid biosynthesis, amino acid degradation, purine biosynthesis, pyrimidine biosynthesis, lipid biosynthesis, fatty acid metabolism, cofactor biosynthesis or transport processes. In still another embodiment, computer readable medium or media of the invention can include a data structure comprising a reaction network, including a plurality of reaction networks. In a particular embodiment, the cell of the computer readable medium or media produces a product selected from an exogenous growth factor, monoclonal antibody, hormone, cytokine, fusion protein, enzyme, vaccine, virus, anticoagulant, and nucleic acid.

In yet another embodiment, the computer readable medium or media of the invention contains a data structure comprising a set of linear algebraic equations. In another embodiment of the computer readable medium or media of the invention, at least one reactant in the plurality of reactants or at least one reaction in the plurality of reactions is annotated with an assignment to a subsystem or compartment. In still another embodiment, at least a first substrate or product in the plurality of reactions is assigned to a first compartment and at least a second substrate or product in the plurality of reactions is assigned to a second compartment.

The invention additionally provides a method for predicting a culture condition for a CHO cell. Such a method can include the steps of providing a data structure relating a plurality of reactants to a plurality of reactions from a CHO cell, wherein the plurality of reactants and the plurality of reactions are a selection of reactants and reactions as shown in Table 1, 3 and 4 for a Chinese hamster ovary (CHO) cell, and wherein the data structure relates a plurality of reactants and a plurality of reactions selected from the reactants and reactions as shown in Tables 1 and 2 for a CHO cell transcriptome, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the data structure; providing an objective function, wherein the objective function is uptake rate of two or more nutrients, wherein the two or more nutrients are carbon sources; and determining at least one flux distribution that minimizes or maximizes the objective function when the constraint set is applied to the data structure, wherein the at least one flux distribution is predictive of a culture condition for the eukaryotic cell.

The invention additionally provides a method for predicting a culture condition for a CHO cell. Such a method can include the steps of providing a data structure relating a plurality of reactants to a plurality of reactions from a CHO cell, wherein the plurality of reactants and the plurality of reactions are a selection of reactants and reactions as shown in Tables 5, 8 and 9 for a Chinese hamster ovary (CHO) cell, and wherein the data structure relates a plurality of reactants and a plurality of reactions selected from the reactants and reactions as shown in Tables 5, 6 and 7 for a CHO cell transcriptome, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the data structure; providing an objective function, wherein the objective function is uptake rate of two or more nutrients, wherein the two or more nutrients are carbon sources; and determining at least one flux distribution that minimizes or maximizes the objective function when the constraint set is applied to the data structure, wherein the at least one flux distribution is predictive of a culture condition for the eukaryotic cell.

In such a method, the objective function can further comprise product formation, energy synthesis, biomass production, or a combination thereof or decreasing byproduct formation. In such a method, the culture condition can be selected from optimized culture medium for the cell, optimized cell culture process, optimized cell productivity, including increased biomass production or increased product yield, metabolic engineering of the cell, reduced scale up variability, reduced batch to batch variability, reduced clonal variability, or improved cell growth, viable cell density or cell productivity in exponential growth phase or stationary phase.

The data structure can comprise, for example, a reaction network, including a plurality of reaction networks. In a particular embodiment, the cell produces a product selected from the group consisting of an exogenous growth factor, monoclonal antibody, hormone, cytokine, fusion protein, enzyme, vaccine, virus, anticoagulant, and nucleic acid. Further, the data structure c of a method of the invention can comprise a set of linear algebraic equations. In one embodiment, at least one reactant in the plurality of reactants or at least one reaction in the plurality of reactions is annotated with an assignment to a subsystem or compartment. In still another embodiment, at least a first substrate or product in the plurality of reactions is assigned to a first compartment and at least a second substrate or product in the plurality of reactions is assigned to a second compartment.

The invention further provides method for optimizing a Chinese hamster ovary (CHO) cell to produce a product. The method can include the steps of providing a data structure relating a plurality of reactants to a plurality of reactions, wherein the plurality of reactants and the plurality of reactions are a selection of reactants and reactions as shown in Tables 1, 3, and 4 for a CHO cell, and wherein the data structure relates a plurality of reactants and a plurality of reactions selected from the reactants and reactions as shown in Tables 1 and 2 for a CHO cell transcriptome; providing a constraint set for the plurality of reactions for the data structure; determining at least one flux distribution that minimizes or maximizes an objective function when the constraint set is applied to the data structure, wherein the at least one flux distribution is predictive of producing a product in the CHO cell; and modifying the CHO cell as determined above. In a particular embodiment, the product can be selected from the group consisting of an exogenous growth factor, monoclonal antibody, hormone, cytokine, fusion protein, enzyme, vaccine, virus, anticoagulant, and nucleic acid.

The invention further provides method for optimizing a Chinese hamster ovary (CHO) cell to produce a product. The method can include the steps of providing a data structure relating a plurality of reactants to a plurality of reactions, wherein the plurality of reactants and the plurality of reactions are a selection of reactants and reactions as shown in Tables 5, 8 and 9 for a CHO cell, and wherein the data structure relates a plurality of reactants and a plurality of reactions selected from the reactants and reactions as shown in Tables 5, 6 and 7 for a CHO cell transcriptome; providing a constraint set for the plurality of reactions for the data structure; determining at least one flux distribution that minimizes or maximizes an objective function when the constraint set is applied to the data structure, wherein the at least one flux distribution is predictive of producing a product in the CHO cell; and modifying the CHO cell as determined above. In a particular embodiment, the product can be selected from the group consisting of an exogenous growth factor, monoclonal antibody, hormone, cytokine, fusion protein, enzyme, vaccine, virus, anticoagulant, and nucleic acid.

In a particular embodiment of such a method of the invention, the objective function can further comprise product formation, energy synthesis, biomass production, or a combination thereof or decreasing byproduct formation. In a method of the invention, a culture condition is selected from the group consisting of optimized culture medium for the cell, optimized cell culture process, optimized cell productivity, and metabolic engineering of the cell. In a particular embodiment, the objective function can be production of the product. In a further embodiment, the two or more nutrients can be carbon sources.

In one embodiment, the present invention provides cell line metabolic models of CHO cells. Using a computational platform, a number of metabolic network reconstructions have been generated for production mammalian cell lines, in particular CHO. The integrated computational and experimental modeling platform allows for the development of metabolic models of mammalian cells, media and process optimization and development, understanding metabolism under different genetic and environmental conditions, engineering cell lines, and developing novel selection systems. Thus, the invention provides methods and in silico models to simulate cell line metabolism, improve and optimize cell culture media and cell culture processes, improve and increase protein production, identify new selection systems, identify biomarkers for cell culture contamination, for example, with viruses or bacteria, and improving metabolic characteristics of a cell line.

In another embodiment, the invention provides media and/or process optimization and development. A computational modeling platform and expertise can be used in metabolic modeling and mammalian cell culture to reduce byproduct formation in CHO cells. As disclosed herein, the model can be used to develop nutritional modifications to the basal media to reduce byproduct formation and improve growth and productivity. This media and process optimization platform can significantly improve the existing timelines associated with therapeutic protein production in mammalian cell lines. The media and process optimization platform can be used by: (1) reconstructing, refining, and expanding metabolic models of CHO cell lines, (2) integrating a transient flux balance approach for quantitative implementation of media designs, and (3) validating the final framework using case studies for antibody production in production cell lines. This platform can be used to reduce the timelines to develop an optimized media that results in lower byproduct formation and higher productivity in cell culture through rational selection of nutrient supplementation and process optimization strategies.

In another embodiment, the invention models allow understanding of metabolism in mammalian cell lines and cell line engineering. Using an integrated computational and experimental approach, the invention also allows characterization of metabolism in production cell lines. For example, the effect of sodium butyrate supplementation, commonly used to enhance protein expression, on CHO cell metabolism can be studied using its metabolic network reconstruction and predicted alternative strategies that result in similar metabolic characteristics without the addition of sodium butyrate. The reconstructed networks can be used to develop a rational approach for recombinant protein production in CHO cell lines to: (a) generate fundamental understanding for cell line response to environmental and genetic changes, and (b) develop novel metabolic interventions for improved protein production.

In yet another embodiment, the invention provides cell line engineering and novel selection system design. In addition, the methods and models of the invention can utilize the knowledge of a whole cell metabolism and is capable to provide rational designs for identifying new selection systems. An integrated computational and experimental approach can be used to identify novel selection systems in CHO cell line and experimentally implement the most promising and advantageous candidate to validate the approach. This approach can be implemented in three stages: (1) identify essential metabolic reactions that are candidate targets for designing novel and superior selection systems using a reconstructed metabolic model of a cell line such as CHO, rank-order and prioritize the candidate targets based on a number of criteria including the predicted stringent specificity of the new selection system and improved cell physiology, (2) experimentally implement the top candidate selection system in a cell line using experimental techniques such as by first creating an auxotrophic clone, transiently transfecting cells with a selection vector that includes an antibody-expressing gene, and selecting protein producing cell lines based on their auxotrophy, and (3) evaluate the development and implementation of a model-based selection system in CHO cells by comparing experimentally generated cell culture data with those calculated by the reconstructed model. This integrated computational and experimental platform allows for design of new and superior metabolic selection systems in mammalian based protein production by computationally identifying and experimentally developing novel selection systems.

As disclosed herein, in one embodiment, a computational modeling approach is used for the design of mammalian cell culture media to reduce byproduct formation and increase protein production. The computational modeling and experimental implementation are applicable to any cell lines such as mammalian cell line, in particular Chinese Hamster Ovary (CHO), including modified versions of such cell lines, such as CHO DHFR. It is understood that such cell lines are merely exemplary and that the methods are applicable to any cell line for which sufficient information on metabolic reactions is known or can be deduced from other cells or related organisms, as disclosed herein. The methods of the invention can additionally be applied to other cell lines such as plant or insect cells and to design or modify media, process and cell lines. Such cell lines are useful for production of biologics, including but not limited to growth factors, monoclonal antibodies, hormones, cytokines, fusion proteins, recombinant enzymes, recombinant vaccines, viruses, anticoagulants, and nucleic acids. In one embodiment, the cell lines are derived from a multicellular organism such as an animal, for example, a human, a plant or an insect.

As disclosed herein, the methods of the invention are useful in applying computational metabolic models for a cell line, in particular a mammalian cell line, such as Chinese Hamster Ovary (CHO), and any variation of those, for example, CHO DHFR cell lines, that are used for production of biologics such as protein products. Exemplary biologics include, but are not limited to, growth factors, monoclonal antibodies, hormones, cytokines, fusion proteins, recombinant enzymes, recombinant vaccines, viruses, anticoagulants, and nucleic acids. In addition, the methods of the invention can be used to develop a computational metabolic model for engineering and optimizing cell culture media, that is, media optimization, designing cell culture process, that is, process design, and engineering the cell, that is, cell line engineering, to improve biomass production, product yield, and/or product titers, that is, to improve the overall cell culture productivity, reduce byproduct formation, or improve any desired metabolic characteristic in a cell culture. In an embodiment, maximization of the nutrient uptake rates or energy maintenance can be used as the objective function for simulating mammalian cell line physiology and cell culture.

The models of the invention are based on a data structure relating a plurality of reactants to a plurality of reactions, wherein each of the reactions includes a reactant identified as a substrate of the reaction, a reactant identified as a product of the reaction and a stoichiometric coefficient relating the substrate and the product. The reactions included in the data structure can be those that are common to all or most cells or to a particular type or species of cell, for example a particular cell line, such as core metabolic reactions, or reactions specific for one or more given cell type.

As used herein, the term “reaction” is intended to mean a conversion that consumes a substrate or forms a product that occurs in or by a cell. The term can include a conversion that occurs due to the activity of one or more enzymes that are genetically encoded by a genome of the cell. The term can also include a conversion that occurs spontaneously in a cell. Conversions included in the term include, for example, changes in chemical composition such as those due to nucleophilic or electrophilic addition, nucleophilic or electrophilic substitution, elimination, isomerization, deamination, phosphorylation, methylation, reduction, oxidation or changes in location such as those that occur due to a transport reaction that moves a reactant from one cellular compartment to another. In the case of a transport reaction, the substrate and product of the reaction can be chemically the same and the substrate and product can be differentiated according to location in a particular cellular compartment. Thus, a reaction that transports a chemically unchanged reactant from a first compartment to a second compartment has as its substrate the reactant in the first compartment and as its product the reactant in the second compartment. It will be understood that when used in reference to an in silico model or data structure, a reaction is intended to be a representation of a chemical conversion that consumes a substrate or produces a product.

As used herein, the term “reactant” is intended to mean a chemical that is a substrate or a product of a reaction that occurs in or by a cell. The term can include substrates or products of reactions performed by one or more enzymes encoded by a genome, reactions occurring in cells or organisms that are performed by one or more non-genetically encoded macromolecule, protein or enzyme, or reactions that occur spontaneously in a cell. Metabolites are understood to be reactants within the meaning of the term. It will be understood that when used in reference to an in silico model or data structure, a reactant is intended to be a representation of a chemical that is a substrate or a product of a reaction that occurs in or by a cell.

As used herein the term “substrate” is intended to mean a reactant that can be converted to one or more products by a reaction. The term can include, for example, a reactant that is to be chemically changed due to nucleophilic or electrophilic addition, nucleophilic or electrophilic substitution, elimination, isomerization, deamination, phosphorylation, methylation, reduction, oxidation or that is to change location such as by being transported across a membrane or to a different compartment.

As used herein, the term “product” is intended to mean a reactant that results from a reaction with one or more substrates. The term can include, for example, a reactant that has been chemically changed due to nucleophilic or electrophilic addition, nucleophilic or electrophilic substitution, elimination, isomerization, deamination, phosphorylation, methylation, reduction or oxidation or that has changed location such as by being transported across a membrane or to a different compartment.

As used herein, the term “product formation” or “formation of a product,” when used in reference to a cell or cell model, either an actual cell or an in silico model, refers to the production of a desired product by the cell or cell model. One skilled in the art would readily understand the meaning of these terms as referring to the production or formation of a product by a cell or cell model.

As used herein, the term “stoichiometric coefficient” is intended to mean a numerical constant correlating the number of one or more reactants and the number of one or more products in a chemical reaction. Typically, the numbers are integers as they denote the number of molecules of each reactant in an elementally balanced chemical equation that describes the corresponding conversion. However, in some cases the numbers can take on non-integer values, for example, when used in a lumped reaction or to reflect empirical data.

As used herein, the term “plurality,” when used in reference to reactions or reactants is intended to mean at least 2 reactions or reactants. The term can include any number of reactions or reactants in the range from 2 to the number of naturally occurring reactants or reactions for a particular of cell or cells. Thus, the term can include, for example, at least 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 33, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 105, 110, 115, 120, 125, 130, 135, 140, 145, 150, 155, 160, 165, 170, 175, 180, 185, 190, 195, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000 or more reactions or reactants. The number of reactions or reactants can be expressed as a portion of the total number of naturally occurring reactions for a particular cell or cells including a CHO cell or cells, such as at least 20%, 30%, 50%, 60%, 75%, 90%, 95%, 98% or 99% of the total number of naturally occurring reactions that occur in a CHO cell.

As used herein, the term “data structure” is intended to mean a physical or logical relationship among data elements, designed to support specific data manipulation functions. The term can include, for example, a list of data elements that can be added combined or otherwise manipulated such as a list of representations for reactions from which reactants can be related in a matrix or network. The term can also include a matrix that correlates data elements from two or more lists of information such as a matrix that correlates reactants to reactions. Information included in the term can represent, for example, a substrate or product of a chemical reaction, a chemical reaction relating one or more substrates to one or more products, a constraint placed on a reaction, or a stoichiometric coefficient.

As used herein, the term “constraint” is intended to mean an upper or lower boundary for a reaction. A boundary can specify a minimum or maximum flow of mass, electrons or energy through a reaction. A boundary can further specify directionality of a reaction. A boundary can be a constant value such as zero, infinity, or a numerical value such as an integer. Alternatively, a boundary can be a variable boundary value as set forth below.

As used herein, the term “variable,” when used in reference to a constraint is intended to mean capable of assuming any of a set of values in response to being acted upon by a constraint function. The term “function,” when used in the context of a constraint, is intended to be consistent with the meaning of the term as it is understood in the computer and mathematical arts. A function can be binary such that changes correspond to a reaction being off or on. Alternatively, continuous functions can be used such that changes in boundary values correspond to increases or decreases in activity. Such increases or decreases can also be binned or effectively digitized by a function capable of converting sets of values to discreet integer values. A function included in the term can correlate a boundary value with the presence, absence or amount of a biochemical reaction network participant such as a reactant, reaction, enzyme or gene. A function included in the term can correlate a boundary value with an outcome of at least one reaction in a reaction network that includes the reaction that is constrained by the boundary limit. A function included in the term can also correlate a boundary value with an environmental condition such as time, pH, temperature or redox potential.

As used herein, the term “activity,” when used in reference to a reaction, is intended to mean the amount of product produced by the reaction, the amount of substrate consumed by the reaction or the rate at which a product is produced or a substrate is consumed. The amount of product produced by the reaction, the amount of substrate consumed by the reaction or the rate at which a product is produced or a substrate is consumed can also be referred to as the flux for the reaction.

As used herein, the term “activity,” when used in reference to a cell, is intended to mean the magnitude or rate of a change from an initial state to a final state. The term can include, for example, the amount of a chemical consumed or produced by a cell, the rate at which a chemical is consumed or produced by a cell, the amount or rate of growth of a cell or the amount of or rate at which energy, mass or electrons flow through a particular subset of reactions.

Depending on the application, the plurality of reactions for a cell model or method of the invention, can include reactions selected from core metabolic reactions or peripheral metabolic reactions. As used herein, the term “core,” when used in reference to a metabolic pathway, is intended to mean a metabolic pathway selected from glycolysis/gluconeogenesis, the pentose phosphate pathway (PPP), the tricarboxylic acid (TCA) cycle, glycogen storage, electron transfer system (ETS), the malate/aspartate shuttle, the glycerol phosphate shuttle, and plasma and mitochondrial membrane transporters. As used herein, the term “peripheral,” when used in reference to a metabolic pathway, is intended to mean a metabolic pathway that includes one or more reactions that are not a part of a core metabolic pathway.

As used herein, the term “transcriptome” refers the set of all RNA molecules transcribed in a cell, including mRNA, rRNA, tRNA, and non-coding RNA produced in a cell. The term can be applied to the total set of transcripts in a given organism, or to the specific subset of transcripts present in a particular cell type. When used herein in reference to a CHO model, the transcriptome refers to the transcripts present in a CHO cell or a representation of transcripts from a single CHO cell, which are derived from a plurality of CHO cells. It is understood that a CHO cell transcriptome can also include less than the total transcripts present in a single CHO cell. For example, the CHO model described herein can, in some aspects, include all of the transcriptome reactions identified or fewer than the total number of transcriptome reactions identified in Tables 1, 2, 5, 6 or 7. It is also understood that the transcriptome in a CHO cell will depend on the conditions in which the cell is placed. Unlike the genome, which is roughly fixed for a given cell line (excluding mutations), the transcriptome can vary with external environmental conditions. For example, changes in media, nutrients, temperature or other culture conditions, and the like, can alter gene expression such that a transcriptome can change under a different set of conditions. Because it includes all mRNA transcripts in the cell, the transcriptome reflects the genes that are being actively expressed at any given time, with the exception of mRNA degradation phenomena such as transcriptional attenuation. Transcriptome analysis can be performed with well known expression profiling techniques, including nucleic acid microarray methods, PCR methods, and the like.

A plurality of reactants can be related to a plurality of reactions in any data structure that represents, for each reactant, the reactions by which it is consumed or produced. Thus, the data structure, which is referred to herein as a “reaction network data structure,” serves as a representation of a biological reaction network or system. An example of a reaction network that can be represented in a reaction network data structure of the invention is the collection of reactions that constitute the metabolic reactions of cell lines, as described in the Examples. The choice of reactions to include in a particular reaction network data structure, from among all the possible reactions that can occur in a cell being modeled depends on the cell type and the physiological condition being modeled, and can be determined experimentally or from the literature, as described further below. Thus, the choice of reactions to include in a particular reaction network data structure can be selected depending on whether media optimization, cell line optimization, process development, or other methods and desired results disclosed herein are selected.

The reactions to be included in a particular network data structure can be determined experimentally using, for example, gene or protein expression profiles, where the molecular characteristics of the cell can be correlated to the expression levels. The expression or lack of expression of genes or proteins in a cell type can be used in determining whether a reaction is included in the model by association to the expressed gene(s) and or protein(s). Thus, it is possible to use experimental technologies to determine which genes and/or proteins are expressed in a specific cell type, and to further use this information to determine which reactions are present in the cell type of interest. In this way a subset of reactions from all of those reactions that can occur in cells in generally, for example, mammalian cells, are selected to comprise the set of reactions that represent a specific cell type. cDNA expression profiles have been demonstrated to be useful, for example, for classification of breast cancer cells (Sorlie et al., Proc. Natl. Acad. Sci. U.S.A. 98(19):10869-10874 (2001)).

Media composition plays an important role in mammalian cell line protein production. The composition of the feed medium can affect cell growth, protein production, protein quality, and downstream protein purification (Rose et al., Handbook of Industrial Cell Culture (Humana Press, Totowa), pp. 69-103 (2003)). Inadequate medium formulation can lead to cell death and reduced productivity or posttranslational processing. On the other hand, a medium with too high a concentration of nutrients can shift metabolism, causing toxic accumulation of byproducts such as lactate and ammonia (Rose et al., supra, 2003). Most large-scale processes are operated using animal serum free media. Excluding serum from the cell culture media minimizes the risk of viral contamination and adventitious agents transmission. Added benefits in using serum free media include increased consistency in growth and productivity, a more simplified downstream purification process, and reduced medium formulation costs (Rose et al., supra, 2003).

Low biomass concentration in standard mammalian cell culture reduces productivity and product titers in mammalian cell cultures compared to microbial systems (Sheikh et al., Biotechnol Prog. 21:112-121 (2005)). Byproduct formation of lactate, alanine, and ammonia in mammalian cell culture can reduce biomass yield and protein production, cause toxic accumulation, and inhibit cell growth (Rose et al., supra, 2003; Namjoshi et al., Biotechnol Bioeng 81:80-91 (2003)). Although byproduct formation in mammalian cell lines is similar to what is observed in E. coli and yeast, its underlying mechanism remains unclear (Sheikh et al., supra, 2005). In microbial systems, this metabolic overflow is reduced by maintaining glucose at low levels. In mammalian cell culture however, low substrate concentrations induce apoptosis and cell death, which limits the use of this strategy in large-scale protein production processes (Cotter and al Rubeai, Trends Biotechnol 13:150-155 (1995)). Cell line engineering strategies to knockout lactate dehyrogenase in hybridoma and express yeast pyruvate carboxylase in baby hamster kidney (BHK) cell lines have also shown moderate improvements in biomass and product titer (Chen et al., Biotechnol Bioeng 72:55-61 (2001); Irani et al., J Biotechnol 93:269-282 (2002)). In addition, generating a stable engineered cell line can be time consuming and laborious. Alternative strategies are needed to reduce byproduct formation with minimum or no cell line engineering approaches.

Currently, most process optimization strategies are performed using a trial and error approach, where process outputs are improved laboriously by experimentation. In general, nutrient components in the cell culture media are determined using one or a combination of the following strategies (Rose et al., supra, 2003): borrowing—adopting a medium composition from the published literature; component swapping—swapping one media component for another at the same usage level; depletion analysis—continuously supplying the media with the depleting nutrients; one-at-a-time—adjusting one component at a time and maintaining the others the same; statistical approaches, including but not limited to full factorial design, partial factorial design, and Plackett-Burman design; optimization techniques, including but not limited to response surface methodology, simplex search and multiple linear regression; computational methods, including but not limited to evolutionary algorithm, genetic algorithm, particle swarm optimization, neural networks and fuzzy logic.

Computational strategies listed above require large sets of experimental data for algorithmic training and in general do not provide a complete solution for media development and optimization in mammalian cell culture. An optimized medium using a laboratory scale cell culture is often not robust to scale-up changes at the manufacturing stage, and requires re-optimization. The lot-to-lot variability in serum-based media components generates inconsistency in growth and protein productivity in mammalian cell cultures. Repeated runs on a media formula can show different nutrient depletion patterns that are in general unexplainable by the existing media design strategies. Overall, media optimization is often performed with little knowledge about how, why, or where the nutrients are used and whether the depleted components are catabolized by the cell or simply degraded without any metabolic benefits to the cell culture. In essence, the cell is treated as a black box. Opening this black box and understanding the fundamental physiological interaction of the cell can lead to more informed and rational approaches for media optimization and cell line engineering and can greatly improve the protein production in mammalian cell lines.

Recent efforts in stoichiometric modeling of mammalian cell lines has been made. Unlike the trial and error strategies that are commonly used in therapeutic protein production, metabolic modeling provides a clear definition for metabolism in the host cell lines and offers a rational approach for designing and optimizing protein production. Computational metabolic modeling can serve as a design and diagnostic tool to: identify what pathways are being used under specified genetic and environmental conditions; determine the fate of nutrients in the cell; identify the source of waste products; examine the effect of eliminating existing reactions or adding new pathways to the host cell line, analyze the effect of adding nutrients to the media, interpret process changes, for example, scale-up, at the metabolic level, and generate rational design strategies for media optimization, process development, and cell engineering.

Computational models have been developed to study protein production in mammalian cell lines using a variety of modeling approaches including metabolic flux analysis (MFA) or flux balance analysis (FBA) (Sheikh et al., supra, 2005; Xie and Wang, Biotechnol Bioeng 52:579-590 (1996); Xie and Wang, Biotechnol Bioeng 52:591-601 (1996); Savinell and Palsson, J. Theor. Biol 154:421-454 (1992a); Savinell and Palsson, J. Theor. Biol 154:455-473 (1992b)). MFA-based models have been used to develop strategies for media design in batch and fed-batch hybridoma cell culture using a lumped “black box” model containing simplified stoichiometric equations (Xie and Wang, Cytotechnology 15:17-29 (1994); Xie and Wang, Biotechnol Bioeng 95:270-284 (2006); Xie and Wang, Biotechnol Bioeng 43:1164-1174 (1994)). FBA-based models have also been used to study hybridoma cell culture (Sheikh et al., supra, 2005; Savinell and Paulsson, supra, 1992a; Savinell and Palsson, supra, 1992b). As described previously, four objective functions were used to study metabolism in a hybridoma: (1) minimizing ATP production, (2) minimizing moles of nutrient uptake, (3) minimizing mass nutrient uptake, and (4) minimizing NADH production (Savinell and Palsson, supra, 1992a). Although no single objective was found to govern cell behavior, minimizing redox production gave results that were most similar to hybridoma cell behavior. Also described previously, three alternative objective functions were examined, including maximizing growth, minimizing substrate uptake rate, and production of monoclonal antibody (Sheikh et al., supra, 2005). The model correctly predicted growth, lactate, and ammonia production when glucose, oxygen, and glutamine uptake was constrained to experimentally measured values. However, the model did not predict the production of alanine and did not provide any explanation for why animal cells oxidize glutamine partially. Neither of the FBA-based models described previously (Savinell and Palsson, supra, 1992a; Sheikh et al., supra, 2005) were utilized to design or optimize cell culture media.

Metabolic models can be used for rational bioprocess design. Any attempt to improve protein production by overcoming fundamental metabolic limitations requires a platform for the comprehensive analysis of cellular metabolic systems. Genome-scale models of metabolism offer the most effective way to achieve a high-level characterization and representation of metabolism. These models reconcile all of the existing genetic, biochemical, and physiological data into a metabolic reconstruction encompassing all of the metabolic capabilities and fitness of an organism. These in silico models serve as the most concise representation of collective biological knowledge on the metabolism of a microorganism. As such they become the focal point for the integrative analysis of vast amounts of experimental data and a central resource to design experiments, interpret experimental data, and drive research programs. It is recognized that the construction of genome-scale in silico models is important to integrate large amounts of diverse high-throughput datasets and to prospectively design experiments to systematically fill in gaps in the knowledge base of particular organisms (Ideker et al., Science 292:929-934 (2001)).

Constructing and demonstrating the use of genome-scale models of metabolism has been described. Previously published in silico representations of metabolism include those for Escherichia coli MG1655 (Edwards and Palsson, Proc. Natl. Acad. Sci. USA 97:5528-5533 (2000)), H. influenzae Rd (Edwards and Palsson, J. Biol. Chem. 274:17410-17416 (1999); Schilling and Palsson, J. Theor. Biol. 203:249-283 (2000)), H. pylori (Schilling et al., J. Bacteriol. 184:4582-4593 (2002)), and S. cerevisiae (Forster et al., Genome Res 13:244-253 (2003)). The general process has been previously published along with various applications of the in silico models (Schilling et al., Biotechnol. Prog. 15:288-295 (1999)); Covert et al., Trends Biochem. Sci. 26:179-186 (2001)).

In combination with appropriate simulation methods, these models can also be used to generate hypotheses to guide experimental design efforts and to improve the efficiency of bioprocess design and optimization. When properly integrated with experimental technologies, an extremely powerful combined platform for metabolic engineering can be implemented for a wide range of applications within industrial pharmaceutical and biotechnology for production and development of healthcare products, therapeutic proteins, and biologics.

In one embodiment, the invention provides a computer readable medium or media, comprising a data structure relating a plurality of reactants to a plurality of reactions from a cell based on the CHO models described herein, each of the reactions comprising a reactant identified as a substrate of the reaction, a reactant identified as a product of the reaction and a stoichiometric coefficient relating the substrate and the product; a constraint set for said plurality of reactions for said data structures, and commands for determining at least one flux distribution that minimizes or maximizes an objective function when the constraint set is applied to the data structure, wherein the at least one flux distribution is predictive of a physiological function of the cell. For example, the data structure can comprise a reaction network. In addition, the data structure can comprise a plurality of reaction networks.

In a particular embodiment, the computer readable medium or media can comprise at least one reaction that is annotated to indicate an associated gene or protein. In addition, the computer readable medium or media can further comprise a gene database having information characterizing the associated gene. At least one of the reactions in the data structure can be a regulated reaction. In addition, the constraint set can include a variable constraint for the regulated reaction.

In another embodiment, the cell can be optimized to increase product yield, to minimize scale up variability, to minimize batch to batch variability or optimized to minimize clonal variability. Additionally, the cell can be optimized to improve cell productivity in stationary phase.

In another embodiment, the cell is derived from an animal, plant or insect. As used herein, a “derived from an animal, plant or insect” refers to a cell that is of animal, plant or insect origin that has been obtained from an animal, plant or insect. Such a cell can be an established cell line or a primary culture. Cell lines are commercially available and can be obtained, for example, from sources such as the American Type American Type Culture Collection (ATCC)(Manassas Va.) or other commercial sources. In a particular embodiment, the cell can be a mammalian cell, such as a Chinese Hamster Ovary (CHO). It is understood that cell variants, such as CHO DHFR-cells, and the like, which can be used with non-selection systems, as disclosed herein. Generally the cells of the invention are obtained from a multicellular organism, in particular a eukaryotic cell from a multicellular organism, in contrast to a cell that exists as a single celled organism such as yeast. Thus, a eukaryotic cell from a multicellular organism as used herein specifically excludes yeast cells.

The invention provides a method for predicting a culture condition for a eukaryotic cell from the CHO cell model described herein. The method can include the steps of providing a data structure relating a plurality of reactants to a plurality of reactions from a cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the data structure; providing an objective function, wherein the objective function is uptake rate of two or more nutrients, wherein the two or more nutrients are carbon sources; and determining at least one flux distribution that minimizes or maximizes the objective function when the constraint set is applied to the data structure, wherein the at least one flux distribution is predictive of a culture condition for the eukaryotic cell. In such a method, the objective function can further comprise product formation, energy synthesis, biomass production, or a combination thereof. Alternatively, the objective function can further comprise decreasing byproduct formation.

Additionally in such a method of the invention, the culture condition can be optimized culture medium for the cell, optimized cell culture process, optimized cell productivity, and metabolic engineering of the cell. The optimized cell productivity can be, for example, increased biomass production or increased product yield. The culture condition can be reduced scale up variability, reduced batch to batch variability, reduced clonal variability, improved cell growth, viable cell density or cell productivity in exponential growth phase or stationary phase or other desired culture conditions.

It is understood that the methods of the invention disclosed herein are generally performed on a computer. Thus, the methods of the invention can be performed, for example, with appropriate computer executable commands stored on a computer readable medium or media that carry out the steps of any of the methods disclosed herein. For example, if desired, a data structure can be stored on a computer readable medium or media and accessed to provide the data structure for use with a method of the invention. Additionally, if desired, any and up to all commands for performing the steps of a method of the invention can be stored on a computer readable medium or media and utilized to perform the steps of a method of the invention. Thus, the invention provides a computer readable medium or media having stored thereon computer executable commands for performing the steps of any method of the invention.

In one embodiment, the invention provides a computer readable medium or media having stored thereon commands for performing the computer executable steps of providing a data structure relating a plurality of reactants to a plurality of reactions from a cell based on the CHO cell model disclosed herein, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the data structure; providing an objective function, wherein the objective function is uptake rate of two or more nutrients, wherein the two or more nutrients are carbon sources; and determining at least one flux distribution that minimizes or maximizes the objective function when the constraint set is applied to the data structure, wherein the at least one flux distribution is predictive of a culture condition for the eukaryotic cell. The computer readable medium or media can include additional steps of such a method of the invention, as disclosed herein.

As used herein, a “culture condition” when used in reference to a cell refers to the state of a cell under a given set of conditions in a cell culture. Such a culture condition can be a condition of a cell culture or an in silico model of a cell in culture. A cell culture or tissue culture is understood by those skilled in the art to include an in vitro culture of a cell, in particular a cell culture of a eukarotic cell from a multicellular organism. Such an in vitro culture refers to the well known meaning of occurring outside an organism, although it is understood that such cells in culture are living cells. A culture condition can refer to the base state or steady state of a cell under a set of conditions or the state of a cell when such conditions are altered, either in an actual cell culture or in an in silico model of a cell culture. For example, a culture condition can refer to the state of a cell, in culture, as calculated based on the cell modeling methods, as disclosed herein. In addition, a culture condition can refer to the state of a cell under an altered set of conditions, for example, the state of a cell as calculated under the conditions of an optimized cell culture medium, optimized cell culture process, optimized cell productivity or after metabolic engineering, including any or all of these conditions as calculated using the in silico models as disclosed herein. Additional exemplary culture conditions include, but are not limited to, reduced scale up variability, reduced batch to batch variability, reduced clonal variability, improved cell growth, viable cell density or cell productivity in exponential growth phase or stationary phase. Such altered conditions can be included in a model of the invention or methods of producing such a model by applying an appropriate constraint set and objective function to achieve the desired result, as disclosed herein and as understood by those skilled in the art.

The methods of the invention as disclosed herein can be used to produce an in silico model of a CHO cell culture. Such an in silico model is generally produced to obtain a culture condition that is the base state of a cell. Once a base model is established, the model can be further refined or altered by selecting a different constraint set or objective function than used in the base state model to achieve a desired outcome. The selection of appropriate constraint sets and/or objective functions to achieve a desired outcome are well known to those skilled in the art.

In embodiments of the invention, an objective function can be the uptake rate of two or more nutrients. In a cell culture, it is understood that a nutrient is provided from the extracellular environment, generally in the culture media, although a nutrient can also be provided from a second cell in a co-culture if such a cell secretes a product that functions as a nutrient for the other cell in the co-culture. The components of a culture medium for providing nutrients to a cell in culture, either to maintain cell viability or cell growth, are well known to those skilled in the art. Such nutrients include, but are not limited to, carbon source, inorganic salts, metals, vitamins, amino acids, fatty acids, and the like (see, for example, Harrison and Rae, General Techniques of Cell Culture, chapter 3, pp. 31-59, Cambridge University Press, Cambridge United Kingdom (1997)). Such nutrients can be provided as a defined medium or supplemented with nutrient sources such as serum, as is well known to those skilled in the art. The culture medium generally includes carbohydrate as a source of carbon. Exemplary carbohydrates that can be used as a carbon source include, but are not limited to, sugars such as glucose, galactose, fructose, sucrose, and the like. It is understood that any nutrient that contains carbon and can be utilized by the cell in culture as a carbon source can be considered a nutrient that is a carbon source. Nutrients in the extracellular environment available to a cell include those substrates or products of an extracellular exchange reaction, including transport or transformation reactions. Thus, any reaction that allows transport or transformation of a nutrient in the extracellular environment, including but not limited to those shown in Tables 1-4 as exemplary reactions, for utilization inside the cell where the nutrient contains carbon is considered to be a nutrient that is a carbon source. Numerous commercial sources are available for various culture media. In particular embodiments of the invention, the methods of the invention utilize an objective function that includes the uptake rate of two or more nutrients that are carbon sources, although it is understood that the uptake of other nutrients can additionally or alternatively be used in the methods of the invention as a parameter of an objective function. As disclosed herein, cells from a multicellular organism have evolved to be bathed in nutrients. A cell from a multicellular organism therefore generally has an inefficient uptake of nutrients. Previously, it was considered that a cell in culture would generally uptake one carbon source. The present invention is based, in part, on the observation and unexpected results obtained by modeling the uptake of two or more nutrients, in particular two or more carbon sources.

As disclosed herein, the invention can be used to generate models of a cultured CHO cell that allow various culture conditions to be tested and, if desired, optimized, by selecting appropriate constraint sets and/or objective functions that achieve a desired culture condition. Exemplary culture conditions are disclosed herein and include, but are not limited to, product formation, energy synthesis, biomass production, byproduct formation, optimizing cell culture medium for a cell, optimizing a cell culture process, optimizing cell productivity, metabolically engineering a cell, reducing scale up variability, reducing batch to batch variability, reducing clonal variability, and the like. In some cases, a desired culture condition includes increasing or improving on a condition, for example, increasing product yield, biomass, cell growth, viable cell density, cell productivity, and the like. In other cases, a desired culture condition includes decreasing, reducing or minimizing an effect, for example, decreasing byproduct formation, reducing scale up variability, reducing batch to batch variability, reducing clonal variability, and the like. It is further understood that any number of desirable culture conditions can be combined, either simultaneously or sequentially, for calculation by a method of the invention to achieve a desired outcome. For example, it can be desirable to increase cell productivity by increasing biomass and/or increasing the yield or titer of a product. Therefore, increased biomass and increased product yield can be included, for example, as an objective function or as a component of an objective function combined with another component, for example, uptake rate of a nutrient. Additionally, it can be desirable to both increase product yield and decrease byproduct formation, so these could similarly be combined, for example, as an objective function. It is understood that any combination of desired culture conditions can be utilized to achieve an improved or optimized culture condition. One skilled in the art, based on the methods disclosed herein and those well known to those skilled in the art, can select an appropriate constraint set and/or objective function to achieve a desired outcome of a culture condition. As used herein, when used in the context of a culture condition, an optimized culture condition such as optimized growth medium, optimized cell culture process, or optimized cell productivity is intended to mean an improvement relative to another condition. The use of the term optimized or improved culture condition is distinct from an optimization problem as known to those skilled in the mathematical arts.

The methods of the invention can be used to optimize or improve a culture medium to increase growth or viability of a cell in culture, for example, growth rate, cell density in suspension culture, product production in exponential growth or stationary phase, and the like. Additionally, the methods of the invention can be used to optimize or increase a cell culture process, also referred to herein as process design. Process design as used herein generally refers to the design and engineering of scale up from small to large scale processes, in particular as they are used in an industrial and commercial scale for culture of cells. Process design is well known to those skilled in the art and can include, for example, the size and type of culture vessels, oxygenation, replenishment of media and nutrients, removal of media containing growth inhibitory byproducts, harvesting of a desired product, and the like. The methods disclosed herein can be used to model culture conditions relating to process design to improve or optimize a cell culture process. The methods of the invention can further be used to optimize or improve cell productivity, for example, increasing biomass production or increasing product yield or titer, or a combination thereof. The methods of the invention can also be used to identify the distinct and significant difference between, for example, (a) laboratory and large scale cell cultures (to reduce scale-up variability), (b) different bioreactor and/or shake flask culture conditions performed with the same cells, media, and cell culture parameters (to reduce batch-to-batch variability), and (c) different clones (to reduce clonal variability).

To optimize a culture condition, the model generated by a method of the invention is used to simulate flux distribution for each condition using the maximization of uptake of nutrients, alone or in combination with maximization or minimization of energy production, byproduct formation, growth, and/or product formation. As disclosed herein, Flux Variability Analysis (FVA) or other suitable analytical methods can be performed for each cultivation conditions. For example, in the case of reducing scale up variability, that is laboratory scale versus large scale conditions, FVA can be performed for each condition to identify a range of flux values for each reaction in the metabolic model. Next, significantly reduced or significantly elevated fluxes in the different cultivation conditions are compared for each reaction. From this comparison, significant metabolic changes can be identified that are indicative of the observed differences. The knowledge obtained by analyzing the data in the context of the reconstructed model is used to identify design parameters that should be monitored or controlled in cell culture to prevent variability in cell culture condition that would result in scale up variability or batch to batch variability. In addition, by determining the variability under different culture conditions and optimizing or improving the conditions of a cell culture, for example by determining limiting nutrient(s) and providing increased amounts of such nutrients in the media, clonal variability can be reduced by reducing selective pressures that could result in the selection of clones with a phenotype that differs from a desired parental cell line. One skilled in the art will readily know appropriate selection of a constraint set or objective function to achieve a desired outcome of a culture condition using the methods and models of the invention.

The models and methods of the invention are particularly useful to optimize cells, culture medium or production of a desired product, as disclosed herein. Exemplary desired products include, but are not limited to, growth factors, monoclonal antibodies, hormones, cytokines, fusion proteins, enzymes, vaccines, viruses, anticoagulants, and nucleic acids. It is understood that, with respect to a cell producing a desired product, the product is produced at an increased level relative to a native parental cell and therefore is considered to be an exogenous product. The models and methods of the invention are based on selecting a desired objective function and generating a model based on the methods disclosed herein. For example, the methods and models can be used to optimize uptake rate of one or more nutrients, energy synthesis, biomass production, or a combination thereof. In addition, the methods and models of the invention can be used to optimize a culture medium for the cell, optimize a cell culture process, optimize cell productivity, or metabolic engineering of said cell. For example, optimized cell productivity can include increased biomass production, increased product yield, or increased product titers.

“Exogenous” as it is used herein is intended to mean that the referenced molecule or the referenced activity is introduced into the host organism. The molecule can be introduced, for example, by introduction of an encoding nucleic acid into the host genetic material such as by integration into a host chromosome or as non-chromosomal genetic material such as a plasmid. Therefore, the term as it is used in reference to expression of an encoding nucleic acid refers to introduction of the encoding nucleic acid in an expressible form into the host organism. When used in reference to a biosynthetic activity, the term refers to an activity that is introduced into the host reference organism. The source can be, for example, a homologous or heterologous encoding nucleic acid that expresses the referenced activity following introduction into the host organism. Therefore, the term “endogenous” refers to a referenced molecule or activity that is present in the host. Similarly, the term when used in reference to expression of an encoding nucleic acid refers to expression of an encoding nucleic acid contained within the organism. The term “heterologous” refers to a molecule or activity derived from a source other than the referenced species whereas “homologous” refers to a molecule or activity derived from the host organism. Accordingly, exogenous expression of an encoding nucleic acid of the invention can utilize either or both a heterologous or homologous encoding nucleic acid. Thus, it is understood that a desired product produced by a cell of the invention is an exogenous product, that is, a product introduced that is not normally expressed by the cell or having an increased level of expression relative to a native parental cell. Therefore, such a cell line has been engineered, either recombinantly or by selection, to have increased expression of a desired product, including but not limited to growth factors, monoclonal antibodies, hormones, cytokines, fusion proteins, enzymes, vaccines, viruses, anticoagulants, and nucleic acids. Such an increased expression can occur by recombinantly expressing a nucleic acid that is a desired product or a nucleic acid encoding a desired product. Alternatively, increased expression can occur by genetically modifying the cell to increase expression of a promoter and/or enhancer, either constitutively or by introducing an inducible promoter and/or enhancer.

As disclosed herein, the data structure can comprise a set of linear algebraic equations. In addition, the commands can comprise an optimization problem. In another embodiment, at least one reactant in the plurality of reactants or at least one reaction in the plurality of reactions can be annotated with an assignment to a subsystem or compartment. For example, a first substrate or product in the plurality of reactions can be assigned to a first compartment and a second substrate or product in the plurality of reactions can be assigned to a second compartment. Furthermore, at least a first substrate or product, or more substrates or products, in the plurality of reactions can be assigned to a first compartment and at least a second substrate or product, or more substrates or products, in the plurality of reactions can be assigned to a second compartment. In addition, a plurality of reactions can be annotated to indicate a plurality of associated genes and the gene database can comprise information characterizing the plurality of associated genes.

In another embodiment, the invention provides a method for predicting a physiological function of a CHO cell. The method can include the steps of providing a data structure relating a plurality of reactants to a plurality of reactions from a cell, each of the reactions comprising a reactant identified as a substrate of the reaction, a reactant identified as a product of the reaction and a stoichiometric coefficient relating the substrate and the product; providing a constraint set for said plurality of reactions for said data structures; providing an objective function, and determining at least one flux distribution that minimizes or maximizes an objective function when the constraint set is applied to the data structure, wherein the at least one flux distribution is predictive of a physiological function of the cell. In methods of the invention, the data structure can comprise a reaction network. In addition, the data structure can comprise a plurality of reaction networks.

If desired, at least one of the reactions can be annotated to indicate an associated gene. In addition, the method can further comprise a gene database having information characterizing the associated gene. In another embodiment, at least one of the reactions can be a regulated reaction. In yet another embodiment, the constraint set can include a variable constraint for the regulated reaction.

As disclosed herein, the methods and models of the invention provide computational metabolic models for cells, such as a mammalian cell line, that can be used for production of a desired product or biologic, including but not limited to growth factors, monoclonal antibodies, hormones, cytokines, fusion proteins, recombinant enzymes, recombinant vaccines, viruses, anticoagulants, and nucleic acids. The use of a computational metabolic model can be used for engineering and optimizing cell culture media (media optimization), designing cell culture process (process design), and engineering the cell (cell line engineering) to improve biomass production, product yield, and/or product titers, that is, to improve the overall cell culture productivity. For example, maximization of the nutrient uptake rates can be used as the objective function in methods of the invention for simulating a cell's physiology and or growth and/or productivity in cell culture.

As disclosed herein, the methods and models of the invention can be used for media optimization, process optimization and/or development, cell line engineering, selection system design, cell line models, including models as disclosed herein such as Hybridoma, NS0, CHO. The invention additional provides models of cell lines based on reactions as found, for example, in Tables 1-4, including deletion designs and metabolic models. The methods and models can be used, for example, to improve yield of desired products; to address and optimize scale-up variability, for example, using the model to understand scale-up variability; to address and optimize batch-to-batch variability, for example, using the models to better understand batch to batch variability; to address and optimize clonal differences, for example, using the models to study the metabolic differences in clones following transfection; to improved productivity in stationary phase, for example, using the models to better understand the impact of changes to media when cells are growing in the stationary phase; and to develop novel selection systems, for example, to identify novel selection systems using the model and develop experimentally additional selection systems for engineering a host organism.

The methods and models of the invention can additionally be used, for example, to identify biofluid-based biomarkers for human inborn errors of metabolism; to identify biomarkers for the progression, development, and onset of diseases such as cancer; to identify biomarkers for assessing toxicology and clinical safety of therapeutic compounds; and to identify biomarkers for use in drug discovery to determine the effect(s) of a therapeutic agent through an analysis and comparison to an untreated individual. Such methods and models are based on selecting a suitable system and applying the methods disclosed herein to achieve a desired outcome, for example, selecting a suitable individual or group of individuals having inborn errors of metabolism, having a disease diagnosis such as cancer diagnosis or a predisposition to develop a disease, exposure to toxic chemicals, treatment with a therapeutic agent, and the like. The identified biomarkers can be used in various applications, including, but not limited to, diagnostics, therapy selection, and monitoring of therapeutic effectiveness.

The invention additionally provides computer readable medium or media, comprising a data structure relating a plurality of reactants to a plurality of reactions from a CHO cell, each of the reactions comprising a reactant identified as a substrate of the reaction, a reactant identified as a product of the reaction and a stoichiometric coefficient relating the substrate and the product; a constraint set for the plurality of reactions for the data structures, and commands for determining at least one flux distribution that minimizes or maximizes an objective function when the constraint set is applied to the data structure, wherein the objective function identifies a target selectable marker reaction or reactant and wherein the at least one flux distribution is predictive of a physiological function of the cell. Thus, as disclosed herein, the invention provides a method to identify novel target pathways, reactions or reactants that can be used as new selectable markers for engineering a recombinant cell line.

The invention additionally provides a method for identifying a target selectable marker for a cell. The method can include the steps of providing a first data structure relating a plurality of reactants to a plurality of reactions from a cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the first data structure; providing an objective function, wherein the objective function is uptake rate of two or more nutrients, wherein the two or more nutrients are carbon sources; determining at least one flux distribution that minimizes or maximizes the objective function when the constraint set is applied to the data structure; deleting a reaction from the data structure to generate a second data structure and repeating steps of providing a constraint set, providing an objective function and determining at least one flux distribution as discussed above; optionally repeating the deleting step by deleting a different reaction, wherein the at least one flux distribution determined with the second data structure is predictive of a reaction required for cell growth or cell viability, thereby identifying a target selectable marker reaction or reactant. Such a method can further comprise providing the second data structure; providing one or more extracellular substrates or products corresponding to one or more reactions of the one or more extracellular exchange reactions to the second data structure to generate a third data structure; providing a constraint set for the plurality of reactions for the third data structure; providing an objective function, wherein the objective function is cell viability or growth; and determining at least one flux distribution that minimizes or maximizes the objective function when the constraint set is applied to the third data structure, wherein the at least one flux distribution determined with the third data structure is predictive of an extracellular substrate or product that complements the target selectable marker reaction or reactant, thereby identifying a selectable marker reaction or reactant. In such a method, the objective function can further comprise uptake rate of the one or more extracellular substrates or products.

The invention additionally provides a computer readable medium or media having stored thereon computer executable commands for performing the steps of providing a first data structure relating a plurality of reactants to a plurality of reactions from a cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the first data structure; providing an objective function, wherein the objective function is uptake rate of two or more nutrients, wherein the two or more nutrients are carbon sources; determining at least one flux distribution that minimizes or maximizes the objective function when the constraint set is applied to the data structure; deleting a reaction from the data structure to generate a second data structure and repeating steps of providing a constraint set, providing an objective function and determining at least one flux distribution as discussed above; optionally repeating the deleting step by deleting a different reaction, wherein the at least one flux distribution determined with the second data structure is predictive of a reaction required for cell growth or cell viability, thereby identifying a target selectable marker reaction or reactant. A computer readable medium or media can further comprise commands for performing the steps of providing the second data structure; providing one or more extracellular substrates or products corresponding to one or more reactions of the one or more extracellular exchange reactions to the second data structure to generate a third data structure; providing a constraint set for the plurality of reactions for the third data structure; providing an objective function, wherein the objective function is cell viability or growth; and determining at least one flux distribution that minimizes or maximizes the objective function when the constraint set is applied to the third data structure, wherein the at least one flux distribution determined with the third data structure is predictive of an extracellular substrate or product that complements the target selectable marker reaction or reactant, thereby identifying a selectable marker reaction or reactant.

As used herein, a “selectable marker” is well known to those skilled in molecular biology and refers to a gene whose expression allows the identification of cells that have been transformed or transfected with a vector containing the marker gene, that is, the presence or absence of the gene (selectable marker) can be selected for, generally based on an altered growth or cell viability characteristic of the cell. Well known exemplary selectable markers used routinely in cell culture include, for example, the dihydrofolate reductase (DHFR) and glutamine synthetase (GS) selection systems. The methods of the invention allow the identification of target selectable markers by using in silico models of a cell to identify a reaction that is required for cell viability or cell growth, that is, an essential reaction. Generally, selectable markers are utilized such that a cell will either die in the absence of a product produced by the selectable marker or will not grow, either case of which will prevent a cell lacking a complementary product from growing. The methods of the invention are based on deleting a reaction from a data structure containing a plurality of reactions and determining whether the deletion has an effect on cell viability or growth. If the deletion results in no cell growth or in cell death, then the deleted reaction is a target selectable marker. The method can be used to determine any of a number of target selectable markers by optionally repeating deleting different reactions. In a method of the invention, a single reaction is deleted to test for the effect on cell growth or viability, although multiple reactions can be deleted, if desired. In general, if a reaction is deleted from a data structure and the deletion has no effect on cell growth or viability, then a different reaction is deleted from the data structure and tested for its effect on cell growth or viability. Accordingly, in such a method, the data structure generally has only one reaction deleted at a time to test for the effect on cell growth or viability. As used herein, inhibiting cell growth generally includes preventing cell division or slowing the rate of cell division so that the doubling time of the cell is substantially reduced, for example, at least 2-fold, 3-fold, 4-fold, 5-fold, 10-fold, or even further reduction in doubling time, so long as the difference in growth rate from a cell containing the selectable marker is sufficient to differentiate the presence or absence of the selectable marker.

After identifying a target selectable marker reaction or reactant, the deleted data structure that identifies a reaction or reactant required for cell growth or viability can be tested for the ability to support cell growth or viability by the addition of an extracellular reaction to the data structure that complements the deleted reaction. For example, if a reaction is deleted and the deletion results in cell death or no cell growth, the product of that reaction can be used to complement the missing reaction and cause the cell to resume cell growth or viability. To be particularly useful as a selectable marker and selection system, it is desirable to be able to complement the missing reaction by addition of a component to the cell culture medium. Therefore, for a deleted reaction to be useful as a selectable marker, the deleted product must either be provided in the culture medium and transported into the cell or a precursor of the product transported into the cell and either transformed or converted to the missing product. To test for this possibility, one or more extracellular exchange reactions, which could potentially result in transport of the deleted product or a precursor of the product, is added to the data structure with the deleted reaction, and the cell is tested for whether cell growth or viability is recovered or resumed. If cell growth and viability is recovered with the addition of the extracellular substrate or product that can be transported, transformed or converted into the product intracellularly, then the deleted reaction and the complementary extracellular product or substrate can function as a selectable marker system. As used herein, a substrate or product that “complements” a target selectable marker refers to a substrate or product that, when added to a cell culture (in vitro or in silico), allows a cell having a deleted reaction (target selectable marker) required for cell growth or cell viability to restore cell growth or viability to the cell. Thus, the methods of the invention can be used to identify target selectable marker reactions or reactants and a selectable marker reaction or reactant with a complementary substrate or product that restores cell growth or viability.

The invention also provides a method for predicting a physiological function of a cell, comprising providing a data structure relating a plurality of reactants to a plurality of reactions from a cell, each of the reactions comprising a reactant identified as a substrate of the reaction, a reactant identified as a product of the reaction and a stoichiometric coefficient relating the substrate and the product; providing a constraint set for the plurality of reactions for the data structures; providing an objective function, and determining at least one flux distribution that minimizes or maximizes an objective function when the constraint set is applied to the data structure, wherein the objective function identifies a target selectable marker reaction or reactant and wherein the at least one flux distribution is predictive of a physiological function of the cell.

The invention additionally provides a method for predicting a biomarker for a contaminant of a cell culture of a eukaryotic cell from a CHO cell. The method can include the steps of providing a first data structure relating a plurality of reactants to a plurality of reactions from a non-contaminated cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a second data structure relating a plurality of reactants to a plurality of reactions from a contaminated cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the first and second data structures; providing an objective function, wherein the objective function is uptake rate of one or more nutrients, wherein the two or more nutrients are carbon sources; determining at least one flux distribution that minimizes or maximizes the objective function when the constraint set is applied to the first data structure; determining at least one flux distribution that minimizes or maximizes the objective function when the constraint set is applied to the second data structure; comparing the at least one flux distribution determined for the first data structure with the at least one flux distribution determined for the second data structure, wherein a difference in the at least one flux distribution for the first and second data structures is predictive of a biomarker for a contaminant of the cell culture. In such a method, the objective function can further comprise secretion rate of one or more products.

The invention additionally provides a computer readable medium or media having stored thereon computer executable commands for performing the steps of providing a first data structure relating a plurality of reactants to a plurality of reactions from a non-contaminated CHO cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a second data structure relating a plurality of reactants to a plurality of reactions from a contaminated cell, each of the reactions comprising a reactant identified as a substrate of the reaction, a reactant identified as a product of the reaction and a stoichiometric coefficient relating the substrate and the product, wherein the plurality of reactions comprises one or more extracellular exchange reactions; providing a constraint set for the plurality of reactions for the first and second data structures; providing an objective function, wherein the objective function is uptake rate of one or more nutrients, wherein the two or more nutrients are carbon sources; determining at least one flux distribution that minimizes or maximizes the objective function when the constraint set is applied to the first data structure; determining at least one flux distribution that minimizes or maximizes the objective function when the constraint set is applied to the second data structure; comparing the at least one flux distribution determined for the first data structure with the at least one flux distribution determined for the second data structure, wherein a difference in the at least one flux distribution for the first and second data structures is predictive of a biomarker for a contaminant of the cell culture.

As disclosed herein, a biomarker for a cell culture contaminant such as a viral or bacterial contaminant can be identified using methods of the invention. The differences between a contaminated versus non-contaminated cell culture allow the identification of biomarker, that is, a marker produced by the cell that differentiates between a contaminated versus non-contaminated cell culture, useful for monitoring for potential contamination of a cell culture.

As disclosed herein, the methods of the invention can be used to generate models of an organism in culture. For example, exemplary models have been generated using methods of the invention. In particular, exemplary models have been generated for a CHO cell line (Table 1-9). The invention additionally provides a model comprising a selection of reactions of any of those shown in Tables 1-9, including up to all of the reactions in Tables 1-9 for the respective models.

The invention also provides a computer readable medium or media having stored thereon computer executable commands for performing methods utilizing any of the models of Tables 1-9. In one embodiment, the invention provides a computer readable medium or media containing commands to perform the steps of providing a data structure relating a plurality of reactants to a plurality of reactions, wherein the plurality of reactants and plurality of reactions are a selection of reactants and reactions as shown in Table 1-9 for a Chinese hamster ovary (CHO) cell; providing a constraint set for the plurality of reactions for the data structure; and determining at least one flux distribution that minimizes or maximizes an objective function when the constraint set is applied to the data structure, wherein the at least one flux distribution is predictive of a physiological function of the CHO cell.

As used herein, a “selection of reactants and reactions” when used with reference to a model of the invention means that a suitable number of the reactions and reactants, including up to all the reactions and reactants, can be selected from a list of reactions for use of the model. For example, any and up to all the reactions as shown in Tables 1-9 can be a selection of reactants and reactions, so long as the selected reactions are sufficient to provide an in silico model suitable for a desired purpose, such as those disclosed herein. It is understood that, if desired, a selection of reactions can include a net reaction between more than one of the individual reactions shown in Tables 1-9. For example, if reaction 1 converts substrate A to product B, and reaction 2 converts substrate B to product C, a net reaction of the conversion of substrate A to product C can be used in the selection of reactions and reactants for use of a model of the invention. One skilled in the art will recognize that such a net reaction conserves stoichiometry between the conversion of A to B to C or A to C and will therefore satisfy the requirements for utilizing the model. In a particular embodiment, the invention provides a model of a CHO cell with all the reactions of Table 1-9, either individually as shown in Tables 1-9 or with one or more net reactions, as discussed above.

The reactants to be used in a reaction network data structure of the invention can be obtained from or stored in a compound database. As used herein, the term “compound database” is intended to mean a computer readable medium or media containing a plurality of molecules that includes substrates and products of biological reactions. The plurality of molecules can include molecules found in multiple organisms or cell types, thereby constituting a universal compound database. Alternatively, the plurality of molecules can be limited to those that occur in a particular organism or cell type, thereby constituting an organism-specific or cell type-specific compound database. Each reactant in a compound database can be identified according to the chemical species and the cellular compartment in which it is present. Thus, for example, a distinction can be made between glucose in the extracellular compartment versus glucose in the cytosol. Additionally each of the reactants can be specified as a metabolite of a primary or secondary metabolic pathway. Although identification of a reactant as a metabolite of a primary or secondary metabolic pathway does not indicate any chemical distinction between the reactants in a reaction, such a designation can assist in visual representations of large networks of reactions.

As used herein, the term “compartment” is intended to mean a subdivided region containing at least one reactant, such that the reactant is separated from at least one other reactant in a second region. A subdivided region included in the term can be correlated with a subdivided region of a cell. Thus, a subdivided region included in the term can be, for example, the intracellular space of a cell; the extracellular space around a cell; the interior space of an organelle such as a mitochondrium, endoplasmic reticulum, Golgi apparatus, vacuole or nucleus; or any subcellular space that is separated from another by a membrane or other physical barrier. For example, a mitochondrial compartment is a subdivided region of the intracellular space of a cell, which in turn, is a subdivided region of a cell or tissue. A subdivided region also can include, for example, different regions or systems of a tissue, organ or physiological system of an organism. Subdivided regions can also be made in order to create virtual boundaries in a reaction network that are not correlated with physical barriers. Virtual boundaries can be made for the purpose of segmenting the reactions in a network into different compartments or substructures.

As used herein, the term “substructure” is intended to mean a portion of the information in a data structure that is separated from other information in the data structure such that the portion of information can be separately manipulated or analyzed. The term can include portions subdivided according to a biological function including, for example, information relevant to a particular metabolic pathway such as an internal flux pathway, exchange flux pathway, central metabolic pathway, peripheral metabolic pathway, or secondary metabolic pathway. The term can include portions subdivided according to computational or mathematical principles that allow for a particular type of analysis or manipulation of the data structure.

The reactions included in a reaction network data structure can be obtained from a metabolic reaction database that includes the substrates, products, and stoichiometry of a plurality of metabolic reactions of a cell line that exhibit biochemical or physiological interactions. The reactants in a reaction network data structure can be designated as either substrates or products of a particular reaction, each with a stoichiometric coefficient assigned to it to describe the chemical conversion taking place in the reaction. Each reaction is also described as occurring in either a reversible or irreversible direction. Reversible reactions can either be represented as one reaction that operates in both the forward and reverse direction or be decomposed into two irreversible reactions, one corresponding to the forward reaction and the other corresponding to the backward reaction.

Reactions included in a reaction network data structure can include intra-system or exchange reactions. Intra-system reactions are the chemically and electrically balanced interconversions of chemical species and transport processes, which serve to replenish or drain the relative amounts of certain metabolites. These intra-system reactions can be classified as either being transformations or translocations. A transformation is a reaction that contains distinct sets of compounds as substrates and products, while a translocation contains reactants located in different compartments. Thus a reaction that simply transports a metabolite from the extracellular environment to the cytosol, without changing its chemical composition is solely classified as a translocation, while a reaction that takes an extracellular substrate and converts it into a cytosolic product is both a translocation and a transformation. Further, intra-system reactions can include reactions representing one or more biochemical or physiological functions of an independent cell, tissue, organ or physiological system. An “extracellular exchange reaction” as used herein refers in particular to those reactions that traverse the cell membrane and exchange substrates and products between the extracellular environment and intracellular environment of a cell. Such extracellular exchange reactions include, for example, translocation and transformation reactions between the extracellular environment and intracellular environment of a cell.

Exchange reactions are those which constitute sources and sinks, allowing the passage of metabolites into and out of a compartment or across a hypothetical system boundary. These reactions are included in a model for simulation purposes and represent the metabolic demands placed a cell. While they may be chemically balanced in certain cases, they are typically not balanced and can often have only a single substrate or product. As a matter of convention the exchange reactions are further classified into demand exchange and input/output exchange reactions.

The metabolic demands placed on a cell metabolic reaction network can be readily determined from the dry weight composition of the cell, which is available in the published literature or which can be determined experimentally. The uptake rates and maintenance requirements for a cell line can also be obtained from the published literature or determined experimentally.

Input/output exchange reactions are used to allow extracellular reactants to enter or exit the reaction network represented by a model of the invention. For each of the extracellular metabolites a corresponding input/output exchange reaction can be created. These reactions are always reversible with the metabolite indicated as a substrate with a stoichiometric coefficient of one and no products produced by the reaction. This particular convention is adopted to allow the reaction to take on a positive flux value (activity level) when the metabolite is being produced or removed from the reaction network and a negative flux value when the metabolite is being consumed or introduced into the reaction network. These reactions will be further constrained during the course of a simulation to specify exactly which metabolites are available to the cell and which can be excreted by the cell.

A demand exchange reaction is always specified as an irreversible reaction containing at least one substrate. These reactions are typically formulated to represent the production of an intracellular metabolite by the metabolic network or the aggregate production of many reactants in balanced ratios such as in the representation of a reaction that leads to biomass formation, also referred to as growth.

A demand exchange reactions can be introduced for any metabolite in a model of the invention. Most commonly these reactions are introduced for metabolites that are required to be produced by the cell for the purposes of creating a new cell such as amino acids, nucleotides, phospholipids, and other biomass constituents, or metabolites that are to be produced for alternative purposes. Once these metabolites are identified, a demand exchange reaction that is irreversible and specifies the metabolite as a substrate with a stoichiometric coefficient of unity can be created. With these specifications, if the reaction is active it leads to the net production of the metabolite by the system meeting potential production demands. Examples of processes that can be represented as a demand exchange reaction in a reaction network data structure and analyzed by the methods of the invention include, for example, production or secretion of an individual protein; production or secretion of an individual metabolite such as an amino acid, vitamin, nucleoside, antibiotic or surfactant; production of ATP for extraneous energy requiring processes such as locomotion or muscle contraction; or formation of biomass constituents.

In addition to these demand exchange reactions that are placed on individual metabolites, demand exchange reactions that utilize multiple metabolites in defined stoichiometric ratios can be introduced. These reactions are referred to as aggregate demand exchange reactions. An example of an aggregate demand reaction is a reaction used to simulate the concurrent growth demands or production requirements associated with cell growth that are placed on a cell, for example, by simulating the formation of multiple biomass constituents simultaneously at a particular cellular growth rate.

Constraint-based modeling can be used to model and predict cellular behavior in reconstructed networks. In order to analyze, interpret, and predict cellular behavior using approaches other than the constraint-based modeling approach, each individual step in a biochemical network is described, normally with a rate equation that requires a number of kinetic constants. However, it is currently not possible to formulate this level of description of cellular processes on a genome scale. The kinetic parameters cannot be estimated from the genome sequence, and these parameters are not available in the literature in the abundance required for accurate modeling. In the absence of kinetic information, it is still possible to assess the capabilities and performance of integrated cellular processes and incorporate data that can be used to constrain these capabilities.

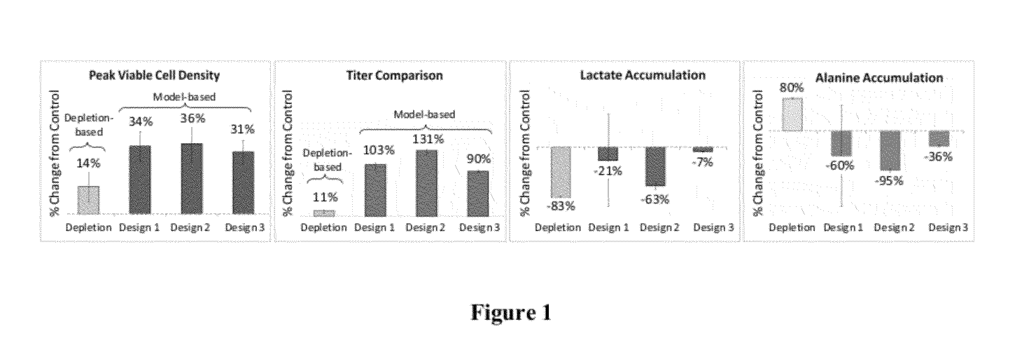

To accomplish suitable modeling, a constraint-based approach for modeling can be implemented. Rather than attempting to calculate and predict exactly what a metabolic network does, the range of possible phenotypes that a metabolic system can display is narrowed based on the successive imposition of governing physico-chemical constraints (Palsson, Nat. Biotechnol. 18:1147-1150 (2000)). Thus, instead of calculating an exact phenotypic solution, that is, exactly how the cell behaves under given genetic and environmental conditions, the feasible set of phenotypic solutions in which the cell can operate is determined (FIG. 1).

Such a constraint-based approach provides a basis for understanding the structure and function of biochemical networks through an incremental process. This incremental refinement presently occurs in the following four steps, each of which involves consideration of fundamentally different constraints: (1) the imposition of stoichiometric constraints that represent flux balances; (2) the utilization of limited thermodynamic constraints to restrict the directional flow through enzymatic reactions; (3) the addition of capacity constraints to account for the maximum flux through individual reactions; and (4) the imposition of regulatory constraints, where available.

Each step provides increasing amounts of information that can be used to further reduce the range of feasible flux distributions and phenotypes that a metabolic network can display. Each of these constraints can be described mathematically, offering a concise geometric interpretation of the effects that each successive constraint places on metabolic function (FIG. 1). In combination with linear programming, constraint-based modeling has been used to represent probable physiological functions such as biomass and ATP production. Constraint-based modeling approaches have been reviewed in detail (Schilling et al., Biotechnol. Prog. 15:288-295 (1999); Varma and Palsson, Bio/Technology 12:994-998 (1994); Edwards et al., Environ. Microbiol. 4:133-140 (2002); Price et al., Nat. Rev. Microbiol. 2:886-897 (2004)).

Transient flux balance analysis can also be used. A number of computational modeling methods have been developed based on the basic premise of the constraint-based approach, including the transient flux balance analysis (Varma and Palsson, Appl. Environ. Microbiol. 60:3724-3731 (1994); Price et al., Nat. Rev. Microbiol. 2:886-897 (2004)). Transient flux balance analysis is a well-established approach for computing the time profile of consumed and secreted metabolites in a bioreactor, predicted based on the computed values from a steady state constraint-based metabolic model (Covert et al., J. Theor. Biol. 213:73-88 (2001)); Varma and Palsson, Appl. Environ. Microbiol. 60:3724-3731 (1994); Covert and Palsson, J. Biol. Chem. 277:28058-28064 (2002)). This approach has been successfully used to predict growth and metabolic byproduct secretion in wild-type E. coli in aerobic and anaerobic batch and fed-batch bioreactors (FIG. 2), and to improve the predictability of the metabolic models using transcriptional regulatory constraints (Varma and Palsson, supra, 2004; Covert and Palsson, supra, 2002).

Briefly, a time profile of metabolite concentrations is calculated by the transient flux balance analysis in an iterative two-step process, where: (1) uptake and secretion rate of metabolites are determined using a metabolic network and linear optimization, and (2) the metabolite concentrations in the bioreactor are calculated using the dynamic mass balance equation (FIG. 3). A set of uptake rates of nutrients can be used to constrain the flux balance calculation in the metabolic network. Using linear optimization, an intracellular flux distribution is calculated and metabolite secretion rates are determined in the metabolic network. The calculated secretion rates are then used to determine the concentration of metabolites in the bioreactor media using the standard dynamic mass balance equations,

S−Sₒ=qₛ∫Xᵥdt Equation (1),

where S is a consumed nutrient or produced metabolite concentration, Sₒ is the initial or previous time point metabolite concentration, and Xᵥ is the viable cell concentration. Cell specific growth rate is computed using standard growth equation,

Xᵥ=X_{v,o}e^{μt} Equation (2),

where X_{v,o} is the initial cell concentration and μ is cell specific growth rate. This procedure is repeated in small arbitrary time intervals for the duration of bioreactor or cell culture experiment from which a time profile of metabolite and cell concentration can be graphically displayed (see, for example, FIG. 2). Transient analysis can thus estimate the time profile of the metabolite concentrations and determine the duration of the cell culture, that is, when the cells run out of nutrients and growth of the cell culture ceases.

The SimPheny™ method or similar modeling method can also be used (see U.S. publication 20030233218). Exemplary modeling methods are also described in U.S. publications 2004/0029149 and 2006/0147899. Improving the efficiency of biological discovery and delivering on the potential of model-driven systems biology requires the development of a computational infrastructure to support collaborative model development, simulation, and data integration/management. In addition, such a high performance-computing platform should embrace the iterative nature of modeling and simulation to allow the value of a model to increase in time as more information is incorporated. One such modeling method is called SimPheny™, short for Simulating Phenotypes, which allows the integration of simulation based systems biology for solving complex biological problems (FIG. 4). SimPheny™ was developed to support multi-user research in concentrated or distributed environments to allow effective collaboration. It serves as the basis for a model-centric approach to biological discovery. The SimPheny™ method has been described previously (see U.S. publication 2003/0233218; WO03106998).

The SimPheny™ method allows the modeling of biochemical reaction networks and metabolism in organism-specific models. The platform supports the development of metabolic models, all of the necessary simulation activities, and the capability to integrate various experimental data. The system is divided into a number of discrete modules to support various activities associated with modeling and simulation. The modules include: (1) universal data, (2) model development, (3) atlas design, (4) simulation, (5) content mining, (6) experimental data analysis, and (7) pathway predictor.

Each of these modules encapsulates activities that are crucial to supporting the iterative model development process. They are all fully integrated with each other so that information created in one module can be utilized where appropriate in other modules. Within the universal data module, all of the data concerning chemical compounds, reactions, and organisms is maintained, providing the underlying information required for constructing cellular models. The model-development module is used to create a model and assign all the appropriate reactions to a model along with specifying any related information such as the genetic associations (FIG. 5) and reference information related to the reaction in the model and the model in general. The atlas design module is used to design metabolic maps and organize them into collections or maps (an atlas). Models are used to simulate the phenotypic behavior of an organism under changing genetic circumstances and environmental conditions. These simulations are performed within the simulation module that enables the use of optimization strategies to calculate cellular behavior. In addition to calculated simulation results, this module allows for the viewing of results in a wide variety of contexts. In order to browse and mine the biological content of all the models and associated genomics for the model organisms, a separate module for data mining can be used. Thus, SimPheny™ represents an exemplary tool that provides the power of modeling and simulation within a systems biology research strategy.

The representation of a reaction network with a set of linear algebraic equations presented as a stoichiometric matrix has been described (U.S. publication 2006/0147899). A reaction network can be represented as a set of linear algebraic equations which can be presented as a stoichiometric matrix S, with S being an m×n matrix where m corresponds to the number of reactants or metabolites and n corresponds to the number of reactions taking place in the network. Each column in the matrix corresponds to a particular reaction n, each row corresponds to a particular reactant m, and each Sₘₙ element corresponds to the stoichiometric coefficient of the reactant m in the reaction denoted n. The stoichiometric matrix can include intra-system reactions which are related to reactants that participate in the respective reactions according to a stoichiometric coefficient having a sign indicative of whether the reactant is a substrate or product of the reaction and a value correlated with the number of equivalents of the reactant consumed or produced by the reaction. Exchange reactions are similarly correlated with a stoichiometric coefficient. The same compound can be treated separately as an internal reactant and an external reactant such that an exchange reaction exporting the compound is correlated by stoichiometric coefficients of −1 and 1, respectively. However, because the compound is treated as a separate reactant by virtue of its compartmental location, a reaction which produces the internal reactant but does not act on the external reactant is correlated by stoichiometric coefficients of 1 and 0, respectively. Demand reactions such as growth can also be included in the stoichiometric matrix being correlated with substrates by an appropriate stoichiometric coefficient.

As disclosed herein, a stoichiometric matrix provides a convenient format for representing and analyzing a reaction network because it can be readily manipulated and used to compute network properties, for example, by using linear programming or general convex analysis. A reaction network data structure can take on a variety of formats so long as it is capable of relating reactants and reactions in the manner exemplified herein for a stoichiometric matrix and in a manner that can be manipulated to determine an activity of one or more reactions using methods such as those exemplified herein. Other examples of reaction network data structures that are useful in the invention include a connected graph, list of chemical reactions or a table of reaction equations.

A reaction network data structure can be constructed to include all reactions that are involved in metabolism occurring in a cell line or any portion thereof. A portion of an cell's metabolic reactions that can be included in a reaction network data structure of the invention includes, for example, a central metabolic pathway such as glycolysis, the TCA cycle, the PPP or ETS; or a peripheral metabolic pathway such as amino acid biosynthesis, amino acid degradation, purine biosynthesis, pyrimidine biosynthesis, lipid biosynthesis, fatty acid metabolism, vitamin or cofactor biosynthesis, transport processes and alternative carbon source catabolism. Examples of individual pathways are described in the Examples. Other examples of portions of metabolic reactions that can be included in a reaction network data structure of the invention include, for example, TAG biosynthesis, muscle contraction requirements, bicarbonate buffer system and/or ammonia buffer system. Specific examples of these and other reactions are described further below and in the Examples. Depending upon a particular application, a reaction network data structure can include a plurality of reactions including any or all of the reactions known in a cell or organism.

For some applications, it can be advantageous to use a reaction network data structure that includes a minimal number of reactions to achieve a particular activity under a particular set of environmental conditions. A reaction network data structure having a minimal number of reactions can be identified by performing the simulation methods described below in an iterative fashion where different reactions or sets of reactions are systematically removed and the effects observed. Accordingly, the invention provides a computer readable medium, containing a data structure relating a plurality of reactants to a plurality of reactions.

Depending upon the particular cell type, the physiological conditions being tested, and the desired activity of a model or method of the invention, a reaction network data structure can contain smaller numbers of reactions such as at least 200, 150, 100 or 50 reactions. A reaction network data structure having relatively few reactions can provide the advantage of reducing computation time and resources required to perform a simulation. When desired, a reaction network data structure having a particular subset of reactions can be made or used in which reactions that are not relevant to the particular simulation are omitted. Alternatively, larger numbers of reactions can be included in order to increase the accuracy or molecular detail of the methods of the invention or to suit a particular application. Thus, a reaction network data structure can contain at least 300, 350, 400, 450, 500, 550, 600 or more reactions up to the number of reactions that occur in a cell or organism or that are desired to simulate the activity of the full set of reactions occurring in a cell or organism. A reaction network data structure that is substantially complete with respect to the metabolic reactions of a cell or organism provides an advantage of being relevant to a wide range of conditions to be simulated, whereas those with smaller numbers of metabolic reactions are specific to a particular subset of conditions to be simulated.

A reaction network data structure can include one or more reactions that occur in or by a cell or organism and that do not occur, either naturally or following manipulation, in or by another organism, such as CHO cells. It is understood that a reaction network data structure of a particular cell type can also include one or more reactions that occur in another cell type. Addition of such heterologous reactions to a reaction network data structure of the invention can be used in methods to predict the consequences of heterologous gene transfer and protein expression.

The reactions included in a reaction network data structure of the invention can be metabolic reactions. A reaction network data structure can also be constructed to include other types of reactions such as regulatory reactions, signal transduction reactions, cell cycle reactions, reactions involved in apoptosis, reactions involved in responses to hypoxia, reactions involved in responses to cell-cell or cell-substrate interactions, reactions involved in protein synthesis and regulation thereof, reactions involved in gene transcription and translation, and regulation thereof, and reactions involved in assembly of a cell and its subcellular components.

A reaction network data structure or index of reactions used in the data structure such as that available in a metabolic reaction database, as described above, can be annotated to include information about a particular reaction. A reaction can be annotated to indicate, for example, assignment of the reaction to a protein, macromolecule or enzyme that performs the reaction, assignment of a gene(s) that codes for the protein, macromolecule or enzyme, the Enzyme Commission (EC) number of the particular metabolic reaction, a subset of reactions to which the reaction belongs, citations to references from which information was obtained, or a level of confidence with which a reaction is believed to occur in a cell or organism. A computer readable medium or media of the invention can include a gene database containing annotated reactions. Such information can be obtained during the course of building a metabolic reaction database or model of the invention as described below.

As used herein, the term “gene database” is intended to mean a computer readable medium or media that contains at least one reaction that is annotated to assign a reaction to one or more macromolecules that perform the reaction or to assign one or more nucleic acid that encodes the one or more macromolecules that perform the reaction. A gene database can contain a plurality of reactions, some or all of which are annotated. An annotation can include, for example, a name for a macromolecule; assignment of a function to a macromolecule; assignment of an organism that contains the macromolecule or produces the macromolecule; assignment of a subcellular location for the macromolecule; assignment of conditions under which a macromolecule is regulated with respect to performing a reaction, being expressed or being degraded; assignment of a cellular component that regulates a macromolecule; an amino acid or nucleotide sequence for the macromolecule; an mRNA isoform, enzyme isoform, or any other desirable annotation or annotation found for a macromolecule in a genome database such as those that can be found in Genbank, a site maintained by the NCBI (ncbi.nlm.gov), the Kyoto Encyclopedia of Genes and Genomes (KEGG) (www.genome.ad.jp/kegg/), the protein database SWISS-PROT (ca.expasy.org/sprot/), the LocusLink database maintained by the NCBI (www.ncbi.nlm.nih.gov/LocusLink/), the Enzyme Nomenclature database maintained by G. P. Moss of Queen Mary and Westfield College in the United Kingdom (www.chem.qmw.ac.uk/iubmb/enzyme/).

A gene database of the invention can include a substantially complete collection of genes or open reading frames in a cell or organism, substantially complete collection of the macromolecules encoded by the cell's or organism's genome. Alternatively, a gene database can include a portion of genes or open reading frames in an organism or a portion of the macromolecules encoded by the organism's genome, such as the portion that includes substantially all metabolic genes or macromolecules. The portion can be at least 10%, 15%, 20%, 25%, 50%, 75%, 90% or 95% of the genes or open reading frames encoded by the organism's genome, or the macromolecules encoded therein. A gene database can also include macromolecules encoded by at least a portion of the nucleotide sequence for the organism's genome such as at least 10%, 15%, 20%, 25%, 50%, 75%, 90% or 95% of the organism's genome. Accordingly, a computer readable medium or media of the invention can include at least one reaction for each macromolecule encoded by a portion of a cell or organism's genome.

An in silico model of cell of the invention can be built by an iterative process which includes gathering information regarding particular reactions to be added to a model, representing the reactions in a reaction network data structure, and performing preliminary simulations wherein a set of constraints is placed on the reaction network and the output evaluated to identify errors in the network. Errors in the network such as gaps that lead to non-natural accumulation or consumption of a particular metabolite can be identified as described below and simulations repeated until a desired performance of the model is attained. Combination of the central metabolism and the cell specific reaction networks into a single model produces, for example, a cell specific reaction network.

Information to be included in a data structure of the invention can be gathered from a variety of sources including, for example, annotated genome sequence information and biochemical literature. Sources of annotated human genome sequence information include, for example, KEGG, SWISS-PROT, LocusLink, the Enzyme Nomenclature database, the International Human Genome Sequencing Consortium and commercial databases. KEGG contains a broad range of information, including a substantial amount of metabolic reconstruction. The genomes of 304 organisms can be accessed here, with gene products grouped by coordinated functions, often represented by a map (e.g., the enzymes involved in glycolysis would be grouped together). The maps are biochemical pathway templates which show enzymes connecting metabolites for various parts of metabolism. These general pathway templates are customized for a given organism by highlighting enzymes on a given template which have been identified in the genome of the organism. Enzymes and metabolites are active and yield useful information about stoichiometry, structure, alternative names and the like, when accessed.

SWISS-PROT contains detailed information about protein function. Accessible information includes alternate gene and gene product names, function, structure and sequence information, relevant literature references, and the like. LocusLink contains general information about the locus where the gene is located and, of relevance, tissue specificity, cellular location, and implication of the gene product in various disease states.

The Enzyme Nomenclature database can be used to compare the gene products of two organisms. Often the gene names for genes with similar functions in two or more organisms are unrelated. When this is the case, the E.C. (Enzyme Commission) numbers can be used as unambiguous indicators of gene product function. The information in the Enzyme Nomenclature database is also published in Enzyme Nomenclature (Academic Press, San Diego, Calif., 1992) with 5 supplements to date, all found in the European Journal of Biochemistry (Blackwell Science, Malden, Mass.).

Sources of biochemical information include, for example, general resources relating to metabolism, resources relating specifically to a particular cell's or organism's metabolism, and resources relating to the biochemistry, physiology and pathology of specific cell types.

Sources of general information relating to metabolism, which can be used to generate human reaction databases and models, include J. G. Salway, Metabolism at a Glance, 2^{nd} ed., Blackwell Science, Malden, Mass. (1999) and T. M. Devlin, ed., Textbook of Biochemistry with Clinical Correlations, 4^{th} ed., John Wiley and Sons, New York, N.Y. (1997). Human metabolism-specific resources include J. R. Bronk, Human Metabolism: Functional Diversity and Integration, Addison Wesley Longman, Essex, England (1999).

In the course of developing an in silico model of metabolism, the types of data that can be considered include, for example, biochemical information which is information related to the experimental characterization of a chemical reaction, often directly indicating a protein(s) associated with a reaction and the stoichiometry of the reaction or indirectly demonstrating the existence of a reaction occurring within a cellular extract; genetic information, which is information related to the experimental identification and genetic characterization of a gene(s) shown to code for a particular protein(s) implicated in carrying out a biochemical event; genomic information, which is information related to the identification of an open reading frame and functional assignment, through computational sequence analysis, that is then linked to a protein performing a biochemical event; physiological information, which is information related to overall cellular physiology, fitness characteristics, substrate utilization, and phenotyping results, which provide evidence of the assimilation or dissimilation of a compound used to infer the presence of specific biochemical event (in particular translocations); and modeling information, which is information generated through the course of simulating activity of cells, tissues or physiological systems using methods such as those described herein which lead to predictions regarding the status of a reaction such as whether or not the reaction is required to fulfill certain demands placed on a metabolic network. Additional information that can be considered includes, for example, cell type-specific or condition-specific gene expression information, which can be determined experimentally, such as by gene array analysis or from expressed sequence tag (EST) analysis, or obtained from the biochemical and physiological literature.

The majority of the reactions occurring in a cell's or organism's reaction networks are catalyzed by enzymes/proteins, which are created through the transcription and translation of the genes found within the chromosome in the cell. The remaining reactions occur either spontaneously or through non-enzymatic processes. Furthermore, a reaction network data structure can contain reactions that add or delete steps to or from a particular reaction pathway. For example, reactions can be added to optimize or improve performance of a model for multicellular interactions in view of empirically observed activity. Alternatively, reactions can be deleted to remove intermediate steps in a pathway when the intermediate steps are not necessary to model flux through the pathway. For example, if a pathway contains 3 nonbranched steps, the reactions can be combined or added together to give a net reaction, thereby reducing memory required to store the reaction network data structure and the computational resources required for manipulation of the data structure.

The reactions that occur due to the activity of gene-encoded enzymes can be obtained from a genome database which lists genes identified from genome sequencing and subsequent genome annotation. Genome annotation consists of the locations of open reading frames and assignment of function from homology to other known genes or empirically determined activity. Such a genome database can be acquired through public or private databases containing annotated nucleic acid or protein sequences, including sequences from CHO cells. If desired, a model developer can perform a network reconstruction and establish the model content associations between the genes, proteins, and reactions as described, for example, in Covert et al. Trends in Biochemical Sciences 26:179-186 (2001) and Palsson, WO 00/46405.

As reactions are added to a reaction network data structure or metabolic reaction database, those having known or putative associations to the proteins/enzymes which allow/catalyze the reaction and the associated genes that code for these proteins can be identified by annotation. Accordingly, the appropriate associations for all of the reactions to their related proteins or genes or both can be assigned. These associations can be used to capture the non-linear relationship between the genes and proteins as well as between proteins and reactions. In some cases one gene codes for one protein which then perform one reaction. However, often there are multiple genes which are required to create an active enzyme complex and often there are multiple reactions that can be carried out by one protein or multiple proteins that can carry out the same reaction. These associations capture the logic (i.e. AND or OR relationships) within the associations Annotating a metabolic reaction database with these associations can allow the methods to be used to determine the effects of adding or eliminating a particular reaction not only at the reaction level, but at the genetic or protein level in the context of running a simulation or predicting an activity.

A reaction network data structure of the invention can be used to determine the activity of one or more reactions in a plurality of reactions occurring in a cell independent of any knowledge or annotation of the identity of the protein that performs the reaction or the gene encoding the protein. A model that is annotated with gene or protein identities can include reactions for which a protein or encoding gene is not assigned. While a large portion of the reactions in a cellular metabolic network are associated with genes in the organism's genome, there are also a substantial number of reactions included in a model for which there are no known genetic associations. Such reactions can be added to a reaction database based upon other information that is not necessarily related to genetics such as biochemical or cell based measurements or theoretical considerations based on observed biochemical or cellular activity. For example, there are many reactions that can either occur spontaneously or are not protein-enabled reactions. Furthermore, the occurrence of a particular reaction in a cell for which no associated proteins or genetics have been currently identified can be indicated during the course of model building by the iterative model building methods of the invention.

The reactions in a reaction network data structure or reaction database can be assigned to subsystems by annotation, if desired. The reactions can be subdivided according to biological criteria, such as according to traditionally identified metabolic pathways (glycolysis, amino acid metabolism and the like) or according to mathematical or computational criteria that facilitate manipulation of a model that incorporates or manipulates the reactions. Methods and criteria for subdviding a reaction database are described in further detail in Schilling et al., J. Theor. Biol. 203:249-283 (2000), and in Schuster et al., Bioinformatics 18:351-361 (2002). The use of subsystems can be advantageous for a number of analysis methods, such as extreme pathway analysis, and can make the management of model content easier. Although assigning reactions to subsystems can be achieved without affecting the use of the entire model for simulation, assigning reactions to subsystems can allow a user to search for reactions in a particular subsystem which may be useful in performing various types of analyses. Therefore, a reaction network data structure can include any number of desired subsystems including, for example, 2 or more subsystems, 5 or more subsystems, 10 or more subsystems, 25 or more subsystems or 50 or more subsystems.

The reactions in a reaction network data structure or metabolic reaction database can be annotated with a value indicating the confidence with which the reaction is believed to occur in a cell or organism. The level of confidence can be, for example, a function of the amount and form of supporting data that is available. This data can come in various forms including published literature, documented experimental results, or results of computational analyses. Furthermore, the data can provide direct or indirect evidence for the existence of a chemical reaction in a cell based on genetic, biochemical, and/or physiological data.

Constraints can be placed on the value of any of the fluxes in the metabolic network using a constraint set. These constraints can be representative of a minimum or maximum allowable flux through a given reaction, possibly resulting from a limited amount of an enzyme present. Additionally, the constraints can determine the direction or reversibility of any of the reactions or transport fluxes in the reaction network data structure. Based on the in vivo environment where multiple cells interact, such as in a human organism, the metabolic resources available to the cell for biosynthesis of essential molecules can be determined.

As described previously (see U.S. publication 2006/014789), for a reaction network, constraints can be placed on each reaction, with the constraints provided in a format that can be used to constrain the reactions of a stoichiometric matrix. The format for the constraints used for a matrix or in linear programming can be conveniently represented as a linear inequality such as

bj≦vj≦aj: j=1 . . . n (Eq. 3)

where vⱼ is the metabolic flux vector, bⱼ is the minimum flux value and aⱼ is the maximum flux value. Thus, aⱼ can take on a finite value representing a maximum allowable flux through a given reaction or bⱼ can take on a finite value representing minimum allowable flux through a given reaction. Additionally, if one chooses to leave certain reversible reactions or transport fluxes to operate in a forward and reverse manner the flux may remain unconstrained by setting bⱼ to negative infinity and aⱼ to positive infinity. If reactions proceed only in the forward reaction, bⱼ is set to zero while aⱼ is set to positive infinity. As an example, to simulate the event of a genetic deletion or non-expression of a particular protein, the flux through all of the corresponding metabolic reactions related to the gene or protein in question are reduced to zero by setting aⱼ and bⱼ to be zero. Furthermore, if one wishes to simulate the absence of a particular growth substrate one can simply constrain the corresponding transport fluxes that allow the metabolite to enter the cell to be zero by setting aⱼ and bⱼ to be zero. On the other hand, if a substrate is only allowed to enter or exit the cell via transport mechanisms, the corresponding fluxes can be properly constrained to reflect this scenario.

The ability of a reaction to be actively occurring is dependent on a large number of additional factors beyond just the availability of substrates. These factors, which can be represented as variable constraints in the models and methods of the invention include, for example, the presence of cofactors necessary to stabilize the protein/enzyme, the presence or absence of enzymatic inhibition and activation factors, the active formation of the protein/enzyme through translation of the corresponding mRNA transcript, the transcription of the associated gene(s) or the presence of chemical signals and/or proteins that assist in controlling these processes that ultimately determine whether a chemical reaction is capable of being carried out within an organism. Regulation can be represented in an in silico model by providing a variable constraint as set forth below.

As used herein, the term “regulated,” when used in reference to a reaction in a data structure, is intended to mean a reaction that experiences an altered flux due to a change in the value of a constraint or a reaction that has a variable constraint.

As used herein, the term “regulatory reaction” is intended to mean a chemical conversion or interaction that alters the activity of a protein, macromolecule or enzyme. A chemical conversion or interaction can directly alter the activity of a protein, macromolecule or enzyme such as occurs when the protein, macromolecule or enzyme is post-translationally modified or can indirectly alter the activity of a protein, macromolecule or enzyme such as occurs when a chemical conversion or binding event leads to altered expression of the protein, macromolecule or enzyme. Thus, transcriptional or translational regulatory pathways can indirectly alter a protein, macromolecule or enzyme or an associated reaction. Similarly, indirect regulatory reactions can include reactions that occur due to downstream components or participants in a regulatory reaction network. When used in reference to a data structure or in silico model, for example, the term is intended to mean a first reaction that is related to a second reaction by a function that alters the flux through the second reaction by changing the value of a constraint on the second reaction.

As used herein, the term “regulatory data structure” is intended to mean a representation of an event, reaction or network of reactions that activate or inhibit a reaction, the representation being in a format that can be manipulated or analyzed. An event that activates a reaction can be an event that initiates the reaction or an event that increases the rate or level of activity for the reaction. An event that inhibits a reaction can be an event that stops the reaction or an event that decreases the rate or level of activity for the reaction. Reactions that can be represented in a regulatory data structure include, for example, reactions that control expression of a macromolecule that in turn, performs a reaction such as transcription and translation reactions, reactions that lead to post translational modification of a protein or enzyme such as phosphorylation, dephosphorylation, prenylation, methylation, oxidation or covalent modification, reactions that process a protein or enzyme such as removal of a pre- or pro-sequence, reactions that degrade a protein or enzyme or reactions that lead to assembly of a protein or enzyme.

As used herein, the term “regulatory event” is intended to mean a modifier of the flux through a reaction that is independent of the amount of reactants available to the reaction. A modification included in the term can be a change in the presence, absence, or amount of an enzyme that performs a reaction. A modifier included in the term can be a regulatory reaction such as a signal transduction reaction or an environmental condition such as a change in pH, temperature, redox potential or time. It will be understood that when used in reference to a model or data structure of the invention, a regulatory event is intended to be a representation of a modifier of the flux through reaction that is independent of the amount of reactants available to the reaction.

The effects of regulation on one or more reactions that occur in a cell can be predicted using an in silico cell model of the invention. Regulation can be taken into consideration in the context of a particular condition being examined by providing a variable constraint for the reaction in an in silico model. Such constraints constitute condition-dependent constraints. A data structure can represent regulatory reactions as Boolean logic statements (Reg-reaction). The variable takes on a value of 1 when the reaction is available for use in the reaction network and will take on a value of 0 if the reaction is restrained due to some regulatory feature. A series of Boolean statements can then be introduced to mathematically represent the regulatory network as described for example in Covert et al. J. Theor. Biol. 213:73-88 (2001). For example, in the case of a transport reaction (A_in) that imports metabolite A, where metabolite A inhibits reaction R2, a Boolean rule can state that:

Reg-R2=IF NOT(A_in). (Eq. 4)

This statement indicates that reaction R2 can occur if reaction A_in is not occurring (i.e. if metabolite A is not present). Similarly, it is possible to assign the regulation to a variable A which would indicate an amount of A above or below a threshold that leads to the inhibition of reaction R2. Any function that provides values for variables corresponding to each of the reactions in the biochemical reaction network can be used to represent a regulatory reaction or set of regulatory reactions in a regulatory data structure. Such functions can include, for example, fuzzy logic, heuristic rule-based descriptions, differential equations or kinetic equations detailing system dynamics.

A reaction constraint placed on a reaction can be incorporated into an in silico model using the following general equation:

(Reg-Reaction)*bⱼ≦vⱼ≦aⱼ*(Reg-Reaction),∀j=1 . . . n (Eq. 5)

For the example of reaction R2 this equation is written as follows:

(0)*Reg-R2≦R2≦(∞)*Reg-R2. (Eq. 6)

Thus, during the course of a simulation, depending upon the presence or absence of metabolite A in the interior of the cell where reaction R2 occurs, the value for the upper boundary of flux for reaction R2 will change from 0 to infinity, respectively. With the effects of a regulatory event or network taken into consideration by a constraint function and the condition-dependent constraints set to an initial relevant value, the behavior of the reaction network can be simulated for the conditions considered as set forth below.

Although regulation has been exemplified above for the case where a variable constraint is dependent upon the outcome of a reaction in the data structure, a plurality of variable constraints can be included in an in silico model to represent regulation of a plurality of reactions. Furthermore, in the exemplary case set forth above, the regulatory structure includes a general control stating that a reaction is inhibited by a particular environmental condition. Using a general control of this type, it is possible to incorporate molecular mechanisms and additional detail into the regulatory structure that is responsible for determining the active nature of a particular chemical reaction within an organism.

Regulation can also be simulated by a model of the invention and used to predict a physiological function of a cell without knowledge of the precise molecular mechanisms involved in the reaction network being modeled. Thus, the model can be used to predict, in silico, overall regulatory events or causal relationships that are not apparent from in vivo observation of any one reaction in a network or whose in vivo effects on a particular reaction are not known. Such overall regulatory effects can include those that result from overall environmental conditions such as changes in pH, temperature, redox potential, or the passage of time.

Those of skill in the art will recognize that instructions for the software implementing a method and model of the present disclosure can be written in any known computer language, such as Java, C, C++, Visual Basic, FORTRAN or COBOL, and compiled using any compatible compiler; and that the software can run from instructions stored in a memory or computer-readable medium on a computing system.

A computing system can be a single computer executing the instructions or a plurality of computers in a distributed computing network executing parts of the instructions sequentially or in parallel. The single computer or one of the plurality of computers can comprise a single processor (for example, a microprocessor or digital signal processor) executing assigned instructions or a plurality of processors executing different parts of the assigned instructions sequentially or in parallel. The single computer or one of the plurality of the computers can further comprise one or more of a system unit housing, a video display device, a memory, computational entities such as operating systems, drivers, graphical user interfaces, applications programs, and one or more interaction devices, such as a touch pad or screen. Such interaction devices or graphical user interfaces, and the like, can be used to output a result to a user, including a visual output or data output, as desired.

A memory or computer-readable medium for storing the software implementing a method and model of the present disclosure can be any medium that participates in providing instructions to a processor for execution. Such a medium may take many forms, including, but not limited to, non-volatile media, volatile media, and transmission media. Non-volatile media include, for example, optical or magnetic disks. Volatile media include dynamic memory. Transmission media include coaxial cables, copper wire, and fiber optics. Transmission media can also take the form of acoustic or light waves, such as those generated during radio frequency and infrared data communications. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. A carrier wave can also be used but is distinct from a computer readable medium or media. Thus, a computer readable medium or media as used herein specifically excludes a carrier wave.

The memory or computer-readable medium can be contained within a single computer or distributed in a network. A network can be any of a number of network systems known in the art such as a Local Area Network (LAN), or a Wide Area Network (WAN). The LAN or WAN can be a wired network (e.g., Ethernet) or a wireless network (e.g., WLAN). Client-server environments, database servers and networks that can be used to implement certain aspects of the present disclosure are well known in the art. For example, database servers can run on an operating system such as UNIX, running a relational database management system, a World Wide Web application and a World Wide Web server. Other types of memories and computer readable media area also contemplated to function within the scope of the present disclosure.

A database or data structure embodying certain aspects or components of the present disclosure can be represented in a markup language format including, for example, Standard Generalized Markup Language (SGML), Hypertext Markup Language (HTML) or Extensible Markup Language (XML). Markup languages can be used to tag the information stored in a database or data structure of the invention, thereby providing convenient annotation and transfer of data between databases and data structures. In particular, an XML format can be useful for structuring the data representation of reactions, reactants, and their annotations; for exchanging database contents, for example, over a network or the Internet; for updating individual elements using the document object model; or for providing different access to multiple users for different information content of a database or data structure embodying certain aspects of the present disclosure. XML programming methods and editors for writing XML codes are known in the art as described, for example, in Ray, “Learning XML” O'Reilly and Associates, Sebastopol, Calif. (2001).

Those of skill in the art would appreciate that the various illustrative blocks, modules, elements, components, methods, and algorithms described herein may be implemented as electronic hardware, computer software, or combinations of both. Furthermore, these may be partitioned differently than what is described. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans can implement the described functionality in varying ways for each particular application.

A set of constraints can be applied to a reaction network data structure to simulate the flux of mass through the reaction network under a particular set of environmental conditions specified by a constraints set. Because the time constants characterizing metabolic transients and/or metabolic reactions are typically very rapid, on the order of milli-seconds to seconds, compared to the time constants of cell growth on the order of hours to days, the transient mass balances can be simplified to only consider the steady state behavior. Referring now to an example where the reaction network data structure is a stoichiometric matrix, the steady state mass balances can be applied using the following system of linear equations

S·v=0 (Eq. 7)

where S is the stoichiometric matrix as defined above and v is the flux vector. This equation defines the mass, energy, and redox potential constraints placed on the metabolic network as a result of stoichiometry. Together Equations 1 and 5 representing the reaction constraints and mass balances, respectively, effectively define the capabilities and constraints of the metabolic genotype and the organism's metabolic potential. All vectors, v, that satisfy Equation 5 are said to occur in the mathematical nullspace of S. Thus, the null space defines steady-state metabolic flux distributions that do not violate the mass, energy, or redox balance constraints. Typically, the number of fluxes is greater than the number of mass balance constraints, thus a plurality of flux distributions satisfy the mass balance constraints and occupy the null space. The null space, which defines the feasible set of metabolic flux distributions, is further reduced in size by applying the reaction constraints set forth in Equation 1 leading to a defined solution space. A point in this space represents a flux distribution and hence a metabolic phenotype for the network. An optimal solution within the set of all solutions can be determined using mathematical optimization methods when provided with a stated objective and a constraint set. The calculation of any solution constitutes a simulation of the model.

Objectives for activity of a cell can be chosen. While the overall objective of a multi-cellular organism may be growth or reproduction, individual human cell types generally have much more complex objectives, even to the seemingly extreme objective of apoptosis (programmed cell death), which may benefit the organism but certainly not the individual cell. For example, certain cell types may have the objective of maximizing energy production, while others have the objective of maximizing the production of a particular hormone, extracellular matrix component, or a mechanical property such as contractile force. In cases where cell reproduction is slow, such as human skeletal muscle, growth and its effects need not be taken into account. In other cases, biomass composition and growth rate could be incorporated into a “maintenance” type of flux, where rather than optimizing for growth, production of precursors is set at a level consistent with experimental knowledge and a different objective is optimized.

Certain cell types, including cancer cells, can be viewed as having an objective of maximizing cell growth. Growth can be defined in terms of biosynthetic requirements based on literature values of biomass composition or experimentally determined values such as those obtained as described above. Thus, biomass generation can be defined as an exchange reaction that removes intermediate metabolites in the appropriate ratios and represented as an objective function. In addition to draining intermediate metabolites this reaction flux can be formed to utilize energy molecules such as ATP, NADH and NADPH so as to incorporate any maintenance requirement that must be met. This new reaction flux then becomes another constraint/balance equation that the system must satisfy as the objective function. Using a stoichiometric matrix as an example, adding such a constraint is analogous to adding an additional column V_{growth} to the stoichiometric matrix to represent fluxes to describe the production demands placed on the metabolic system. Setting this new flux as the objective function and asking the system to maximize the value of this flux for a given set of constraints on all the other fluxes is then a method to simulate the growth of the organism.

Continuing with the example of the stoichiometric matrix applying a constraint set to a reaction network data structure can be illustrated as follows. The solution to equation 5 can be formulated as an optimization problem, in which the flux distribution that minimizes a particular objective is found. Mathematically, this optimization problem can be stated as:

Minimize Z (Eq. 8)

where z=Σcᵢ·vᵢ (Eq. 9)

where Z is the objective which is represented as a linear combination of metabolic fluxes vᵢ using the weights cᵢ in this linear combination. The optimization problem can also be stated as the equivalent maximization problem; i.e. by changing the sign on Z. Any commands for solving the optimazation problem can be used including, for example, linear programming commands.

A computer system of the invention can further include a user interface capable of receiving a representation of one or more reactions. A user interface of the invention can also be capable of sending at least one command for modifying the data structure, the constraint set or the commands for applying the constraint set to the data representation, or a combination thereof. The interface can be a graphic user interface having graphical means for making selections such as menus or dialog boxes. The interface can be arranged with layered screens accessible by making selections from a main screen. The user interface can provide access to other databases useful in the invention such as a metabolic reaction database or links to other databases having information relevant to the reactions or reactants in the reaction network data structure or to a cell's physiology. Also, the user interface can display a graphical representation of a reaction network or the results of a simulation using a model of the invention.

Once an initial reaction network data structure and set of constraints has been created, this model can be tested by preliminary simulation. During preliminary simulation, gaps in the network or “dead-ends” in which a metabolite can be produced but not consumed or where a metabolite can be consumed but not produced can be identified. Based on the results of preliminary simulations, areas of the metabolic reconstruction that require an additional reaction can be identified. The determination of these gaps can be readily calculated through appropriate queries of the reaction network data structure and need not require the use of simulation strategies, however, simulation would be an alternative approach to locating such gaps.

In the preliminary simulation testing and model content refinement stage the existing model is subjected to a series of functional tests to determine if it can perform basic requirements such as the ability to produce the required biomass constituents and generate predictions concerning the basic physiological characteristics of the particular cell type being modeled. The more preliminary testing that is conducted, the higher the quality of the model that will be generated. Typically, the majority of the simulations used in this stage of development will be single optimizations. A single optimization can be used to calculate a single flux distribution demonstrating how metabolic resources are routed determined from the solution to one optimization problem. An optimization problem can be solved using linear programming as disclosed herein. The result can be viewed as a display of a flux distribution on a reaction map. Temporary reactions can be added to the network to determine if they should be included into the model based on modeling/simulation requirements.

Once a model of the invention is sufficiently complete with respect to the content of the reaction network data structure according to the criteria set forth above, the model can be used to simulate activity of one or more reactions in a reaction network. The results of a simulation can be displayed in a variety of formats including, for example, a table, graph, reaction network, flux distribution map or a phenotypic phase plane graph.

As used herein, the term “physiological function,” when used in reference to a cell, is intended to mean an activity of the cell as a whole. An activity included in the term can be the magnitude or rate of a change from an initial state of a cell to a final state of the cell. An activity included in the term can be, for example, growth, energy production, redox equivalent production, biomass production, development, or consumption of carbon nitrogen, sulfur, phosphate, hydrogen or oxygen. An activity can also be an output of a particular reaction that is determined or predicted in the context of substantially all of the reactions that affect the particular reaction in a cell or that occur in a cell. Examples of a particular reaction included in the term are production of biomass precursors, production of a protein, production of an amino acid, production of a purine, production of a pyrimidine, production of a lipid, production of a fatty acid, production of a cofactor or transport of a metabolite, and the like. A physiological function can include an emergent property which emerges from the whole but not from the sum of parts where the parts are observed in isolation (see for example, Palsson, Nat. Biotech 18:1147-1150 (2000)).

A physiological function of reactions can be determined using phase plane analysis of flux distributions. Phase planes are representations of the feasible set which can be presented in two or three dimensions. As an example, two parameters that describe the growth conditions such as substrate and oxygen uptake rates can be defined as two axes of a two-dimensional space. The optimal flux distribution can be calculated from a reaction network data structure and a set of constraints as set forth above for all points in this plane by repeatedly solving the linear programming problem while adjusting the exchange fluxes defining the two-dimensional space. A finite number of qualitatively different metabolic pathway utilization patterns can be identified in such a plane, and lines can be drawn to demarcate these regions. The demarcations defining the regions can be determined using shadow prices of linear optimization as described, for example in Chvatal, Linear Programming New York, W.H. Freeman and Co. (1983). The regions are referred to as regions of constant shadow price structure. The shadow prices define the intrinsic value of each reactant toward the objective function as a number that is either negative, zero, or positive and are graphed according to the uptake rates represented by the x and y axes. When the shadow prices become zero as the value of the uptake rates are changed there is a qualitative shift in the optimal reaction network.

One demarcation line in the phenotype phase plane is defined as the line of optimality (LO). This line represents the optimal relation between respective metabolic fluxes. The LO can be identified by varying the x-axis flux and calculating the optimal y-axis flux with the objective function defined as the growth flux. From the phenotype phase plane analysis the conditions under which a desired activity is optimal can be determined. The maximal uptake rates lead to the definition of a finite area of the plot that is the predicted outcome of a reaction network within the environmental conditions represented by the constraint set. Similar analyses can be performed in multiple dimensions where each dimension on the plot corresponds to a different uptake rate. These and other methods for using phase plane analysis, such as those described in Edwards et al., Biotech Bioeng. 77:27-36 (2002), can be used to analyze the results of a simulation using an in silico model of the invention.

A physiological function of a cell can also be determined using a reaction map to display a flux distribution. A reaction map of a cell can be used to view reaction networks at a variety of levels. In the case of a cellular metabolic reaction network, a reaction map can contain the entire reaction complement representing a global perspective. Alternatively, a reaction map can focus on a particular region of metabolism such as a region corresponding to a reaction subsystem described above or even on an individual pathway or reaction.

The methods of the invention can be used to determine the activity of a plurality of cell reactions including, for example, biosynthesis of an amino acid, degradation of an amino acid, biosynthesis of a purine, biosynthesis of a pyrimidine, biosynthesis of a lipid, metabolism of a fatty acid, biosynthesis of a cofactor, transport of a metabolite, metabolism of an alternative carbon source, or other reactions as disclosed herein.

The methods of the invention can be used to determine a phenotype of a cell mutant. The activity of one or more reactions can be determined using the methods described herein, wherein the reaction network data structure lacks one or more gene-associated reactions that occur in a cell or organism. Alternatively, the methods can be used to determine the activity of one or more reactions when a reaction that does not naturally occur in the model of a cell or organism, for example, is added to the reaction network data structure. Deletion of a gene can also be represented in a model of the invention by constraining the flux through the reaction to zero, thereby allowing the reaction to remain within the data structure. Thus, simulations can be made to predict the effects of adding or removing genes to or from a cell. The methods can be particularly useful for determining the effects of adding or deleting a gene that encodes for a gene product that performs a reaction in a peripheral metabolic pathway.

A target for an agent that affects a function of a cell can be predicted using the methods of the invention, for example a target pathway for determining a selectable marker for a cell line, as disclosed herein. Such predictions can be made by removing a reaction to simulate total inhibition or prevention by a drug or agent. Alternatively, partial inhibition or reduction in the activity a particular reaction can be predicted by performing the methods with altered constraints. For example, reduced activity can be introduced into a model of the invention by altering the aⱼ or bⱼ values for the metabolic flux vector of a target reaction to reflect a finite maximum or minimum flux value corresponding to the level of inhibition. Similarly, the effects of activating a reaction, by initiating or increasing the activity of the reaction, can be predicted by performing the methods with a reaction network data structure lacking a particular reaction or by altering the aⱼ or bⱼ values for the metabolic flux vector of a target reaction to reflect a maximum or minimum flux value corresponding to the level of activation. The methods can be particularly useful for identifying a target in a peripheral metabolic pathway.

The methods of the invention can be used to determine the effects of one or more environmental components or conditions on an activity of, for example, a physiological function of a cell such as a media component or nutrient, as disclosed herein. As set forth above, an exchange reaction can be added to a reaction network data structure corresponding to uptake of an environmental component, release of a component to the environment, or other environmental demand. The effect of the environmental component or condition can be further investigated by running simulations with adjusted aⱼ or bⱼ values for the metabolic flux vector of the exchange reaction target reaction to reflect a finite maximum or minimum flux value corresponding to the effect of the environmental component or condition. The environmental component can be, for example an alternative carbon source or a metabolite that when added to the environment of a cell such as the medium in which the cell is grown can be taken up and metabolized. The environmental component can also be a combination of components present for example in a minimal medium composition. Thus, the methods can be used to determine an optimal or minimal medium composition that is capable of supporting a particular activity of a cell.

It is understood that modifications which do not substantially affect the activity of the various embodiments of this invention are also provided within the definition of the invention provided herein. Accordingly, the following examples are intended to illustrate but not limit the present invention.

### Example I

### CHO Metabolic Model

Metabolic Network Reconstruction for CHO Cell Line in SimPheny™. The metabolic model of CHO cell line was reconstructed in SimPheny™ using a whole transcripotome library, on-line databases and published literature on CHO cell line metabolism. Major pathways in central metabolism were included in the metabolic network reconstruction of the CHO cell, including glycolysis, the citric acid (TCA) cycle, pentose phosphate pathway, nonessential amino acid biosynthesis, nonessential fatty acid synthesis and fatty acid β-oxidation (Hayduk et al., Electrophoresis 25:2545-2556 (2004); Hayduk and Lee, Biotechnol. Bioeng. 90:354-364 (2005); Lee et al., Biotechnol. Prog. 19:1734-1741 (2003); Van Dyk et al., Proteomics 3:147-156 (2003); Hayter et al., Appl. Microbiol. Biotechnol. 34:559-564 (1991)). Transport reactions for essential amino acids (i.e. histidine, isoleucine, leucine, lysine, methionine, phenylalanine, threonine, tryptophan, and valine), essential fatty acids (i.e. a-linolenic acid, C18:2, and linoleic acid, C18:3), and other nutrient uptake were included and verified using published CHO medium composition (Kaufmann et al., Biotechnol. Bioeng. 63:573-582 (1999); Hayter et al., Biotechnol. Bioeng. 42:1077-1085 (1993)). The stoichiometry of the electron transport system was specified with a P/O ratio of 2.5 for NADH (measure of oxidative phosphorylation) based on the value determined for mammalian cells (Seewoster and Lehmann, Appl. Microbiol. Biotechnol. 44:344-250 91995)). To ensure that all the biosynthetic components can be synthesized in the network, reactions for biosynthesis of carbohydrates, RNA, DNA, phospholipids, cholesterol, and sphingolipids were added to the reconstructed CHO metabolic network even in the absence of direct genetic or biochemical evidence in CHO cells. Reaction reversibility and intracellular localization were verified using published literature and online databases (refs. Narkewicz et al., Biochem. J. 313 (Pt 3) 991-996 (1996); Lao and Toth, Biotechnol. Prog. 13:688-691 (1997)). Beyond central metabolic pathways, our CHO metabolic model also contains pathways for protein biosynthesis (including specific monoclonal antibodies) and glycosylation. Additionally, prior publications of predictive cell models assumed that essential amino acids are not degraded, however degradation of essential amino acids does occur in CHO cells. Thus, degradation pathways of essential amino acids were included in the herein described CHO cell model. The complete metabolic network includes a total of 550 intracellular reactions and 524 metabolites distributed in intracellular compartments including cytosol, mitochondria, endoplasmic reticulum, peroxisome, as well as the extra-cellular space. All the metabolic reactions in this reconstructed network are elementally and charge-balanced and none of the metabolic pathways is lumped (i.e. several consecutive pathway reactions are merged into one) or simplified.

### CHO Metabolic Model Update Using the Whole Transcriptome Data

To update and expand the CHO model, a whole transcriptome library was developed by growing CHO cell lines in batch cultivation and collecting samples in different stages of cell growth. For this purpose, multiple samples were taken throughout the cell culture including from exponential growth and stationary phase and mRNAs were isolated from each sample. Isolated mRNAs were combined into a transcriptome library and the library construction was normalized from the total RNA and sequenced using an Illumina sequencer. The reads were assembled using the Oases assembly algorithm (http://www.ebi.ac.uk/˜zerbino/oases/). The sequenced and assembled contigs were then used to aid in model update and expansion.

Novel enzymatic reactions and pathways were identified through sequence homology to human proteins in the Human Metabolic Reconstruction (US Patent Application Publication 2008/0133196). To accomplish this, the entire exome was subjected to a six frame translation. Putative peptide sequences between stop sites were each subjected to a blastp search for filtering purposes.

The data was filtered against a combined human/mouse/rat RefSeq protein database. All polypeptides from the 6 frame translation of the CHO exome that did not have a significant hit in the human/mouse/rat RefSeq protein database (with at least one match with an E-value<0.1), or that were short (<15 amino acids) were removed. FASTA files were generated of the remaining polypeptides from the translated CHO contigs. These FASTA files were subsequently loaded into the Genomatica BLAST server, and the corresponding list of translated CHO contig IDs were loaded into SimPheny. Blast databases were constructed from the FASTA files. Protein sequence files and their respective BLAST databases for the human and hepatocyte model proteins were also built from RefSeq build 37.1 (download on Jun. 7, 2010). The SimPheny Auto Model program was subsequently used to perform a bidirectional protein BLAST (blastp) of the translated CHO exome against the protein lists from the GT life sciences Human and Hepatocyte models (based off of RefSeq Build 36.2).

The auto model based off of the human hepatocyte model returned 268 reactions, covering 48% of the gene associated reactions in the human hepatocyte model. The auto model based off of the entire human model included 1265 contigs that show homology to RefSeq IDs from the human model (which contains 1809) and allowed the inclusion of 675 reactions (out of 2300 human model reactions). The included reactions were also subjected to manual curation.

Another method was also used, in which a nucleotide BLAST (blastn) was conducted between the CHO exome nucleotide sequences and all RefSeq mRNAs associated with the UCSD human model Entrez Gene numbers. This Human model is different in that the Locus IDs are Entrez Gene IDs (while the GT Human and Hepatocyte models are based on RefSeq). The top 5 CHO contigs with an E-value less than 1×10−10 for each human RefSeq ID were retained to aid in pathway extension. Using this approach, there were 1856 unique RefSeq IDs (out of 2430) that mapped to at least 1 contig with an E-value >1×10−10. These RefSeq IDs mapped back to 1103 unique genes (out of 1493 genes in HR1). The CHO model including the transcriptome data has 800 intracellular, 86 exchange reactions, and 789 metabolites (as described in Tables 1-4). The CHO model described herein, which includes the transcriptome data, is predictive of metabolism and physiological function in CHO cells.

### CHO Metabolic Model Analysis

Precursor Metabolite, Energy, and Biomass Synthesis in the Reconstructed Metabolic Model of CHO Cell Line. To assess the network's ability to synthesize biomass components, precursor metabolite formation and energy (ATP) production are simulated using glucose as a sole carbon source. The reconstructed network can correctly generate all precursor metabolites at values equal to or below the maximum theoretical values from glucose, similar to previously reconstructed models for microbial cells such as E. coli and S. cerevisiae (Waterston et al., Nature 420:520-562 (2002); Lu et al., Process Biochemistry 40:1917-1921 (2005)). In addition, using a P/O ratio of 2.5 (Baik et al., Biotechnol. Bioeng. 93:361-371 (2006); Seewoster et al., Appl. Microbiol. Biotechnol. 44:344-350 (1995)), the metabolic model can simulate ATP formation at a maximum yield of 32.75 mol ATP/mol glucose, consistent with a draft network reconstruction of human metabolism in SimPheny™ and previously published values for mammalian cells (Van Dyk et al., Proteomics 3:147-156 (2003); Seewoster et al., supra).

In the absence of comprehensive thermodynamic or kinetic constraints, groups of metabolic reactions in the reconstructed network can be coupled to create cycles that erroneously generate energy and redox potential without carbon expenditure. The CHO cell reconstructed metabolic model can test and verify that no spurious or invalid network cycles that can generate free energy in the form of ATP, NADH, NADPH and FADH₂.

The metabolic network can also be tested for its ability to synthesize all the biosynthetic components. For example, the correct synthesis of all non-essential amino acids and fatty acids from glucose can be tested.

It is contemplated that the conditionally essential amino acids cysteine and tyrosine are synthesized only when essential methionine and phenylalanine are supplied to the network. It is also contemplated that the conditionally essential fatty acids are synthesized when essential α-linolenic and linoleic fatty acid are supplied to the network. In addition, the network can also be tested to verify that the essential amino acid (EAA) and essential fatty acid (EFA) biosynthetic pathways are not present in the model and that EAAs and EFAs are available for protein, lipid, and biomass biosynthesis only via uptake from extra-cellular space (i.e. the media).

The metabolic model requirements for cofactors and vitamins can be tested. It is contemplated that the nutritional requirements in CHO cells will agree with the metabolic model requirements. For example, fatty acyl-CoA formation in phospholipid synthesis requires Coenzyme A that is synthesized from pantothenate (vitamin B5). Pantothenate is an essential vitamin that is also supplied to mammalian cell lines in the media (Kaufmann et al., Biotechnol. Bioeng. 63:573-582 (1999); Hayter et al., Biotechnol. Bioeng. 42:1077-1085 91993); Krambeck and Betenbaugh Biotechnol. Bioeng. 92:711-728 (2005)). In the metabolic network, it is contemplated that lipid synthesis is coupled to pantothenate supplementation and the network will be unable to make biomass in the absence of vitamin B5 intake. Choline is another essential nutrient for mammals that is required for the formation of phosphocholine (Kaufmann et al., Biotechnol. Bioeng. 63:573-582 (1999); Hayter et al., Biotechnol. Bioeng. 42:1077-1085 91993); Hossler et al., Biotechnol. Bioeng. 95:946-960 (2006)). The CHO metabolic network does not contain any of the reactions for choline synthesis and to satisfy phospholipid biosynthetic requirements, the metabolic network must take up choline from the extra-cellular space. In the absence of choline supplementation, it is contemplated that the CHO metabolic network will be unable to make phosphocholine and biomass.

Ethanolamine and putrescine are also precursors supplied in mammalian cell media (Kaufmann et al., Biotechnol. Bioeng. 63:572-582 (1999); Hayter et al., Biotechnol. Bioeng. 42:1077-1085 (1993)). Ethanolamine is an alternative route for the biosynthesis of phosphoethanolamine and it can be included in the CHO model. There is no evidence in the previous literature that putrescine is metabolized in CHO cells. Thus, putrescine exchange can be excluded from the model.

### Validation and Analysis of the CHO Model: Fatty Acid Metabolism in CHO Model.

The metabolic capabilities of the reconstructed CHO model are evaluated using linear optimization and constraint-based modeling approach (see section B.5). To validate the reconstructed CHO metabolic model, the ATP production from one mole of eicosanoate (C20:0), octadecenoate (C18:1) and palmitate (C16:0) are simulated. To demonstrate how each of these fatty acids can be catabolized to produce energy, the influx of all other carbon sources including glucose is constrained to zero and internal demand for cytosolic ATP is maximized. Previously, mammalian cell simulations in SimPheny™ demonstrated that a unit of proton per fatty acid was required to balance fatty acyl CoA formation in the cell. The proton demand is also identified and supplied to the CHO metabolic network. The liable explanation for proton demand is the role of the proton electrochemical gradient across the inner membrane to energize the long-chain fatty acid transport apparatus. This has been observed in E. coli and has been shown to be required for optimal fatty acid transport (Nyberg et al., Biotechnol. Bioeng. 62:324-335 (1999)).

It is contemplated that, the energy (ATP) production is calculated to be 136.5 mol ATP/mol of eicosanoate (C20:0), 120.75 mol ATP/mol of octadecenoate (C18:1) and 108 mol ATP/mol of palmitate (C 16:0). These results are compared with analogous ATP production calculations that are generated using the reconstructed myocyte model in SimPheny™ (Table 10). The calculated ATP values are slightly different between two models. Published experimental data and previous reconstructions of mitochondrial metabolism match results calculated in myocyte model and report that 106 mol of ATP is produced from one mole of palmitate, when the P/O ratio is 2.5 (Seewoster et al., Appl. Microbiol. Biotechnol. 44:344-350 (1995); Nyberg et al., Biotechnol. Bioeng. 62:336-347 (1999)).

TABLE 10
Maximum ATP produced from 1 mol of fatty acid.

| | | | | CHO model |
|---|---|---|---|---|
| | | | | with irreversible |
| | | Myocyte | CHO | NADP-dependent |
| Fatty Acid | Abbreviation | model | model | malic enzyme |
| Eicosanoate | C20:0 | 134 | 136.5 | 134 |
| Octadecenoate | C18:1 | 118.5 | 120.75 | 118.5 |
| Palmitate | C16:0 | 106 | 108 | 106 |

Further evaluation of the CHO metabolic network allows for identification of the metabolic difference, which causes a variation of 2 ATP mols. Mitochondrial and cytosolic NADP dependent malic enzymes are assigned to be irreversible in the myocyte model. In the reconstructed CHO metabolic model, reactions that are catalyzed by the NADP dependent malic enzyme are included to be reversible, based on the previous experimental evidence generated using various types of mammalian cell types and tissues (Altamirano et al., Biotechnol. Prog. 17:1032-1041 (2001); Provost and Bastin, J. Process Control 14:717-728 (2004); Provost et al., Bioprocess Biosyst. Eng. 29:349-366 (2006). In this case, cytosolic NADP-dependent malic enzyme performs in the reverse direction allowing for transfer of reducing equivalents from the cytosol into mitochondria via the shuttle mechanism (Altamirano et al., Biotechnol. Prog. 17:1032-1041 (2001)) which consequently contributes to additional production of ATP. Constraining NADP-dependent malic enzymes to be irreversible in the CHO model can led to no flux distribution through the cytosolic and mitochondrial NADP dependent malic enzymes and generated maximum ATP production results that were equal to the results generated using the myocyte model in SimPheny™ (Table 10).

### Example II

### Model-Based Media Optimization

This example describes the identification and development of model-based media formulations using the CHO metabolic model. The CHO metabolic reconstruction are utilized to design an optimal media formulation. This is done to demonstrate the value of a rational model-driven media optimization strategy for improved productivity in CHO cell culture. Four media modifications are experimentally implemented, including three generated by the model and one based on the empirical observation of nutrient depletion in the cell culture (which is used routinely in the industry for media optimization, and is commonly known as a ‘depletion’ or ‘spent media’ analysis). Using the basic cell culture parameters (e.g. cell viability, growth, and metabolite concentrations measured by Nova and HPLC), three formulations are designed using the model to eliminate byproduct formation and increase growth and protein production. Additionally, a formulation is developed based on the ‘depletion’ analysis and is used to benchmark the advantage of a rational modeling approach over the current industry standards used for media optimization. It is contemplated that, metabolite modifications identified by the model are unique and non-intuitive and have no or minimum overlap with those identified by ‘depletion’ analysis.

For this study, all shake flasks are set up, controlled, and analyzed in the same manner as the base case control in experimental lab. It is contemplated that the results from the model-driven media formulation study will show that the objectives of increasing growth and protein production are successful and that model-based formulations outperformed the industry standard ‘depletion’ analysis. For example, since fed-batch is the preferred mode of cell culture, results for a fed-batch study are shown in FIG. 1 (similar results were also generated in batch cell culture, data not shown). Model-driven media formulations (‘Design 1, 2, and 3’) can show significant improvements in fed-batch over both the control and the depletion analysis (Depletion') results. Peak viable cell density can increase by up to 36% compared with the baseline control values. Byproduct formation of lactate and alanine is lowered in the model-based formulations, while higher product titers, up to a striking 131%, are achieved. Ammonium, another key byproduct, levels are unchanged in the model-driven formulations, whereas the level in the depletion analysis increased significantly (89%, data not shown). Model-driven media formulation (‘Design 2’) can show the greatest increase in titer and also the greatest decrease in byproduct formation.

The depletion analysis, commonly used in mammalian cell culture (i.e., the industry standard), showed the least amount of improvement in terms of increasing maximum viable cell density and final product titers. The product titer in the depletion study (Depletion') can increase compared with the base case formulation, which explains why depletion analysis can gain popularity in cell culture protein production. However, the percent increase is not nearly as high as is seen in the model-designed formulations (i.e., only 11% increase over the baseline (control) product titer was observed, as opposed to 90%, 103%, and 131% in the model-based formulations). In addition, the highest accumulated byproduct concentrations are observed for two out of the three byproducts in the depletion analysis (alanine and ammonium). The entire study is performed in just a few months. It is contemplated that the model-based media formulations can show a clear advantage over existing media optimization strategies for reducing byproducts and increasing protein titers and serve as a good example of the predictive capabilities of a model-driven analysis. In summary, the reconstructed models can show that:
CHO cell line metabolism can be correctly represented in varying growth conditions;
Model-based designs can reduce byproducts and improve cell growth and productivity;
Model-based media designs were unique and non-intuitive (with no or minimum overlap with designs generated by empirical approaches used routinely in the industry).

### Example III

### Model-Based Selection System Design

This example describes the identification and development of selectable markers in CHO cell lines. Using this example, the ability of the model to identify existing selection systems in CHO cell lines can be done. Essential metabolic reactions that are candidate targets for cell line selection are computationally identified using a network deletion analysis to identify the essential reactions in the model when the media components are systematically removed from the simulated conditions (computationally, each deletion analysis is performed by removing one reaction from the network, removing one metabolite from the media, and maximizing the flux for cell biomass and monoclonal antibody production).

Each simulated deletion is performed in two in silico media conditions: (i) the complete CHO cell culture media (as described in the literature and verified analytically in-house), and (ii) media lacking one media components that may be used for selection of the CHO cell line lacking specific gene activities. For example, it is contemplated that this model will identify dihydrofolate reductase and glutamine synthetase as selectable markers in a CHO cell line.

### Example IV

### Cell Culture Simulation

To evaluate the modeling capabilities of the reconstructed network, published experimental data for tissue Plasminogen Activator (t-PA) producing cell line CHO TF 70R (Altamirano et al., Biotechnol. Prog., 17:1032-1041 (2001)) was used to evaluate the modeling capabilities of the reconstructed network under chemostat growth conditions. Using different objective functions, the byproduct secretion rates were calculated and the accuracy of the model was benchmarked by comparing those values to experimental measurements. Model-based simulation results for chemostat condition closely mimicked CHO metabolism in byproduct secretion rates.

### REFERENCE LIST

1 J. S. Edwards and B. O. Palsson, “Robustness analysis of the Escherichia coli metabolic network,” Biotechnol. Prog. 16(6), 927 (2000).
2 M. Garcia-Rios, et al., “Cloning of a polycistronic cDNA from tomato encoding gamma-glutamyl kinase and gamma-glutamyl phosphate reductase,” Proc. Natl. Acad. Sci. U.S. A 94(15), 8249 (1997).
3 E. G. Hanania, et al., “Automated in situ measurement of cell-specific antibody secretion and laser-mediated purification for rapid cloning of highly-secreting producers,” Biotechnol. Bioeng. 91(7), 872 (2005).
4 F. T. Kao and T. T. Puck, “Genetics of somatic mammalian cells. IV. Properties of Chinese hamster cell mutants with respect to the requirement for proline,” Genetics 55(3), 513 (1967).
5 F. T. Kao and T. T. Puck, “Genetics of somatic mammalian cells, VII. Induction and isolation of nutritional mutants in Chinese hamster cells,” Proc. Natl. Acad. Sci. U.S. A 60(4), 1275 (1968).
6 S. L. Naylor, J. K. Townsend, and R. J. Klebe, “Characterization of naturally occurring auxotrophic mammalian cells,” Somatic. Cell Genet. 5(2), 271 (1979).
7 Y. Santiago, et al., “Targeted gene knockout in mammalian cells by using engineered zinc-finger nucleases,” Proc. Natl. Acad. Sci. U.S. A 105(15), 5809 (2008).

Throughout this application various publications have been referenced. The disclosures of these publications in their entireties are hereby incorporated by reference in this application in order to more fully describe the state of the art to which this invention pertains. Although the invention has been described with reference to the examples provided above, it should be understood that various modifications can be made without departing from the spirit of the invention.

TABLE 4

| No | Abbreviation | Compartment | Name |
|---|---|---|---|
| 1 | 10fthf | Cytosol | 10-Formyltetrahydrofolate |
| 2 | 10fthf | Mitochondria | 10-Formyltetrahydrofolate |
| 3 | 12dgr_CHO | Cytosol | 1,2-Diacylglycerol, CHO |
| 4 | 13dpg | Cytosol | 3-Phospho-D-glyceroyl phosphate |
| 5 | 1ag3p_CHO | Cytosol | 1-Acyl-sn-glycerol 3-phosphate, CHO |
| 6 | 1aglycpc_CHO | Cytosol | 1-Acyl-sn-glycero-3-phosphocholine, CHO specific |
| 7 | 1pyr5c | Cytosol | 1-Pyrroline-5-carboxylate |
| 8 | 1pyr5c | Mitochondria | 1-Pyrroline-5-carboxylate |
| 9 | 25aics | Cytosol | (S)-2-[5-Amino-1-(5-phospho-D-ribosyl)imidazole-4-carboxamido]succinate |
| 10 | 2aadp | Mitochondria | L-2-Aminoadipate |
| 11 | 2amuc | Cytosol | 2-Aminomuconate |
| 12 | 2aobut | Mitochondria | L-2-Amino-3-oxobutanoate |
| 13 | 2maacoa | Mitochondria | 2-Methyl-3-acetoacetyl-CoA |
| 14 | 2mb2coa | Mitochondria | trans-2-Methylbut-2-enoyl-CoA |
| 15 | 2mbcoa | Mitochondria | 2-Methylbutanoyl-CoA |
| 16 | 2mp2coa | Mitochondria | 2-Methylprop-2-enoyl-CoA |
| 17 | 2obut | Cytosol | 2-Oxobutanoate |
| 18 | 2obut | Mitochondria | 2-Oxobutanoate |
| 19 | 2oxoadp | Cytosol | 2-Oxoadipate |
| 20 | 2oxoadp | Mitochondria | 2-Oxoadipate |
| 21 | 2pg | Cytosol | D-Glycerate 2-phosphate |
| 22 | 34hpp | Cytosol | 3-(4-Hydroxyphenyl)pyruvate |
| 23 | 34hpp | Mitochondria | 3-(4-Hydroxyphenyl)pyruvate |
| 24 | 3dsphgn | Cytosol | 3-Dehydrosphinganine |
| 25 | 3hanthrn | Cytosol | 3-Hydroxyanthranilate |
| 26 | 3hbycoa | Mitochondria | (S)-3-Hydroxybutyryl-CoA |
| 27 | 3hmbcoa | Mitochondria | (S)-3-Hydroxy-2-methylbutyryl-CoA |
| 28 | 3hmp | Mitochondria | (S)-3-hydroxyisobutyrate |
| 29 | 3mb2coa | Mitochondria | 3-Methylbut-2-enoyl-CoA |
| 30 | 3mgcoa | Mitochondria | 3-Methylglutaconyl-CoA |
| 31 | 3mob | Mitochondria | 3-Methyl-2-oxobutanoate |
| 32 | 3mop | Mitochondria | (S)-3-Methyl-2-oxopentanoate |
| 33 | 3pg | Cytosol | 3-Phospho-D-glycerate |
| 34 | 3php | Cytosol | 3-Phosphohydroxypyruvate |
| 35 | 3sala | Cytosol | 3-Sulfino-L-alanine |
| 36 | 3sala | Mitochondria | 3-Sulfino-L-alanine |
| 37 | 44mctr | Endoplasmic | 4,4-dimethylcholesta-8,14,24-trienol |
| | | Reticulum | |
| 38 | 44mzym | Endoplasmic | 4,4-dimethylzymosterol |
| | | Reticulum | |
| 39 | 4abut | Cytosol | 4-Aminobutanoate |
| 40 | 4abut | Mitochondria | 4-Aminobutanoate |
| 41 | 4abutn | Cytosol | 4-Aminobutanal |
| 42 | 4fumacac | Cytosol | 4-Fumarylacetoacetate |
| 43 | 4izp | Cytosol | 4-Imidazolone-5-propanoate |
| 44 | 4mlacac | Cytosol | 4-Maleylacetoacetate |
| 45 | 4mop | Mitochondria | 4-Methyl-2-oxopentanoate |
| 46 | 4mzym_int1 | Endoplasmic | 4-Methylzymosterol intermediate 1 |
| | | Reticulum | |
| 47 | 4mzym_int2 | Endoplasmic | 4-Methylzymosterol intermediate 2 |
| | | Reticulum | |
| 48 | 4ppan | Cytosol | D-4′-Phosphopantothenate |
| 49 | 4ppcys | Cytosol | N-((R)-4-Phosphopantothenoyl)-L-cysteine |
| 50 | 5aizc | Cytosol | 5-amino-1-(5-phospho-D-ribosyl)imidazole-4-carboxylate |
| 51 | 5aop | Cytosol | 5-Amino-4-oxopentanoate |
| 52 | 5aop | Mitochondria | 5-Amino-4-oxopentanoate |
| 53 | 5dpmev | Peroxisome | (R)-5-Diphosphomevalonate |
| 54 | 5fthf | Cytosol | 5-Formiminotetrahydrofolate |
| 55 | 5mta | Cytosol | 5-Methylthioadenosine |
| 56 | 5mthf | Cytosol | 5-Methyltetrahydrofolate |
| 57 | 5pmev | Peroxisome | (R)-5-Phosphomevalonate |
| 58 | 6pgc | Cytosol | 6-Phospho-D-gluconate |
| 59 | 6pgc | Endoplasmic | 6-Phospho-D-gluconate |
| | | Reticulum | |
| 60 | 6pgl | Cytosol | 6-phospho-D-glucono-1,5-lactone |
| 61 | 6pgl | Endoplasmic | 6-phospho-D-glucono-1,5-lactone |
| | | Reticulum | |
| 62 | 6pthp | Cytosol | 6-Pyruvoyl-5,6,7,8-tetrahydropterin |
| 63 | 7dhchsterol | Endoplasmic | 7-Dehydrocholesterol |
| | | Reticulum | |
| 64 | a3n4m2mf | Golgi Apparatus | Gal b1-4 GlcNAc b1-2 (GlcNAc b1-3 Gal b1-4 GlcNAc b1-4) Man a1-3(Gal b1-4 |
| | | | GlcNAc b1-2 Man a1-6) Man b1-4 GlcNAc b1-4(Fuc a1-6) GlcNAcOH |
| 65 | a4n5m2mf | Golgi Apparatus | Gal b1-4 GlcNAc b1-2(Gal b1-4 GlcNAc b1-4) Man a1-3(Gal b1-4 GlcNAc b1- |
| | | | 2(GlcNAc b1-3 Gal b1-4 GlcNAc b1-6) Man a1-6) Man b1-4 GlcNAc b1-4(Fuc a1- |
| | | | 6) GlcNAcOH |
| 66 | a5n6m2mf | Golgi Apparatus | Galb1-4GlcNAcb1-2(Galb1-4GlcNAcb1-4)Mana1-3(GlcNAcb1-3Galb1-4GlcNAcb1- |
| | | | 2(Galb1-4GlcNAcb1-3Galb1-4GlcNAcb1-6)Mana1-6)Manb1-4GlcNAcb1-4(Fucal- |
| | | | 6)GlcNAcOH |
| 67 | a6n7m2mf | Golgi Apparatus | Galb1-4GlcNAcb1-2(GlcNAcb1-3Galb1-4GlcNAcb1-4)Mana1-3(Galb1-4GlcNAcb1- |
| | | | 3Galb1-4GlcNAcb1-2(Galb1-4GlcNAcb1-3Galb1-4GlcNAcb1-6)Mana1-6)Manb1- |
| | | | 4GlcNAcb1-4(Fuca1-6)GlcNAcOH |
| 68 | aacoa | Cytosol | Acetoacetyl-CoA |
| 69 | aacoa | Mitochondria | Acetoacetyl-CoA |
| 70 | ac | Cytosol | Acetate |
| 71 | acac | Cytosol | Acetoacetate |
| 72 | acac | Mitochondria | Acetoacetate |
| 73 | accoa | Cytosol | Acetyl-CoA |
| 74 | accoa | Mitochondria | Acetyl-CoA |
| 75 | acgam | Cytosol | N-Acetyl-D-glucosamine |
| 76 | acgam1p | Cytosol | N-Acetyl-D-glucosamine 1-phosphate |
| 77 | acgam6p | Cytosol | N-Acetyl-D-glucosamine 6-phosphate |
| 78 | acmana | Cytosol | N-Acetyl-D-mannosamine |
| 79 | acmanap | Cytosol | N-Acetyl-D-mannosamine 6-phosphate |
| 80 | acmucsal | Cytosol | 2-Amino-3-carboxymuconate semialdehyde |
| 81 | acnam | Cytosol | N-Acetylneuraminate |
| 82 | acnr9p | Cytosol | N-Acetylneuraminate 9-phosphate |
| 83 | acrn | Cytosol | O-Acetylcarnitine |
| 84 | acrn | Mitochondria | O-Acetylcarnitine |
| 85 | ade | Cytosol | Adenine |
| 86 | ade | Extra-organism | Adenine |
| 87 | adn | Cytosol | Adenosine |
| 88 | adp | Cytosol | ADP |
| 89 | adp | Mitochondria | ADP |
| 90 | adp | Peroxisome | ADP |
| 91 | agm | Mitochondria | Agmatine |
| 92 | ahcys | Cytosol | S-Adenosyl-L-homocysteine |
| 93 | ahdt | Cytosol | 2-Amino-4-hydroxy-6-(erythro-1,2,3-trihydroxypropyl)dihydropteridine triphosphate |
| 94 | aicar | Cytosol | 5-Amino-1-(5-Phospho-D-ribosyl)imidazole-4-carboxamide |
| 95 | air | Cytosol | 5-amino-1-(5-phospho-D-ribosyl)imidazole |
| 96 | akg | Cytosol | 2-Oxoglutarate |
| 97 | akg | Mitochondria | 2-Oxoglutarate |
| 98 | ala-L | Cytosol | L-Alanine |
| 99 | ala-L | Extra-organism | L-Alanine |
| 100 | amet | Cytosol | S-Adenosyl-L-methionine |
| 101 | ametam | Cytosol | S-Adenosylmethioninamine |
| 102 | amp | Cytosol | AMP |
| 103 | amp | Mitochondria | AMP |
| 104 | amp | Peroxisome | AMP |
| 105 | ampsal | Mitochondria | L-2-Aminoadipate 6-semialdehyde |
| 106 | amucsal | Cytosol | 2-Aminomuconate semialdehyde |
| 107 | arachda | Cytosol | Arachidonic acid (C20:4) |
| 108 | arachda | Extra-organism | Arachidonic acid (C20:4) |
| 109 | arachdcoa | Cytosol | arachidonoyl-CoA (C20:4CoA, n-6) |
| 110 | arachdcoa | Mitochondria | arachidonoyl-CoA (C20:4CoA, n-6) |
| 111 | arachdcrn | Cytosol | C20:4 carnitine |
| 112 | arachdcrn | Mitochondria | C20:4 carnitine |
| 113 | arg-L | Cytosol | L-Arginine |
| 114 | arg-L | Extra-organism | L-Arginine |
| 115 | arg-L | Mitochondria | L-Arginine |
| 116 | argsuc | Cytosol | N(omega)-(L-Arginino)succinate |
| 117 | asn-L | Cytosol | L-Asparagine |
| 118 | asn-L | Extra-organism | L-Asparagine |
| 119 | asp-L | Cytosol | L-Aspartate |
| 120 | asp-L | Extra-organism | L-Aspartate |
| 121 | asp-L | Mitochondria | L-Aspartate |
| 122 | atp | Cytosol | ATP |
| 123 | atp | Mitochondria | ATP |
| 124 | atp | Peroxisome | ATP |
| 125 | b2coa | Mitochondria | trans-But-2-enoyl-CoA |
| 126 | btcoa | Mitochondria | Butanoyl-CoA (C4:0CoA) |
| 127 | but | Cytosol | Butyrate |
| 128 | camp | Cytosol | cAMP |
| 129 | cbasp | Cytosol | N-Carbamoyl-L-aspartate |
| 130 | cbp | Cytosol | Carbamoyl phosphate |
| 131 | cbp | Mitochondria | Carbamoyl phosphate |
| 132 | cdp | Cytosol | CDP |
| 133 | cdp | Mitochondria | CDP |
| 134 | cdpchol | Cytosol | CDPcholine |
| 135 | cdpdag_CHO | Cytosol | CDPdiacylglycerol, CHO specific |
| 136 | cdpdag_CHO | Mitochondria | CDPdiacylglycerol, CHO specific |
| 137 | cdpea | Cytosol | CDPethanolamine |
| 138 | cer_CHO | Cytosol | ceramide, CHO specific |
| 139 | cgly | Cytosol | Cys-Gly |
| 140 | cgmp | Cytosol | 3′,5′-Cyclic GMP |
| 141 | chito2pdol | Cytosol | N,N′-Diacetylchitobiosyldiphosphodolichol, mammals |
| 142 | chol | Cytosol | Choline |
| 143 | chol | Extra-organism | Choline |
| 144 | cholcoa | Peroxisome | Choloyl-CoA |
| 145 | cholcoads | Peroxisome | 3alpha,7alpha,12alpha-Trihydroxy-5beta-cholest-24-enoyl-CoA |
| 146 | cholcoaone | Peroxisome | 3alpha,7alpha,12alpha-Trihydroxy-5beta-24-oxocholestanoyl-CoA |
| 147 | cholcoar | Peroxisome | 3alpha,7alpha,12alpha-Trihydroxy-5beta-cholestanoyl-CoA |
| 148 | cholcoas | Peroxisome | 3alpha,7alpha,12alpha-Trihydroxy-5beta-cholestanoyl-CoA(S) |
| 149 | cholp | Cytosol | Choline phosphate |
| 150 | cholsd | Endoplasmic | 5alpha-Cholesta-7,24-dien-3beta-ol |
| | | Reticulum | |
| 151 | cholse_CHO | Cytosol | Cholesterol ester, CHO specific |
| 152 | chsterol | Cytosol | Cholesterol |
| 153 | chsterol | Endoplasmic | Cholesterol |
| | | Reticulum | |
| 154 | cit | Cytosol | Citrate |
| 155 | cit | Extra-organism | Citrate |
| 156 | cit | Mitochondria | Citrate |
| 157 | citr-L | Cytosol | L-Citrulline |
| 158 | citr-L | Mitochondria | L-Citrulline |
| 159 | clpn_CHO | Cytosol | cardiolipin, CHO specific |
| 160 | clpn_CHO | Mitochondria | cardiolipin, CHO specific |
| 161 | clpndcoa | Cytosol | clupanodonyl CoA (C22:5CoA) |
| 162 | clpndcoa | Mitochondria | clupanodonyl CoA (C22:5CoA) |
| 163 | clpndcrn | Cytosol | docosapentaenoyl carnitine (C22:5) |
| 164 | clpndcrn | Mitochondria | docosapentaenoyl carnitine (C22:5) |
| 165 | cmp | Cytosol | CMP |
| 166 | cmp | Golgi Apparatus | CMP |
| 167 | cmp | Mitochondria | CMP |
| 168 | cmpacna | Cytosol | CMP-N-acetylneuraminate |
| 169 | cmpacna | Golgi Apparatus | CMP-N-acetylneuraminate |
| 170 | co2 | Cytosol | CO2 |
| 171 | co2 | Endoplasmic | CO2 |
| | | Reticulum | |
| 172 | co2 | Extra-organism | CO2 |
| 173 | co2 | Mitochondria | CO2 |
| 174 | co2 | Peroxisome | CO2 |
| 175 | coa | Cytosol | Coenzyme A |
| 176 | coa | Mitochondria | Coenzyme A |
| 177 | coa | Peroxisome | Coenzyme A |
| 178 | cpppg3 | Cytosol | Coproporphyrinogen III |
| 179 | crn | Cytosol | L-Carnitine |
| 180 | crn | Mitochondria | L-Carnitine |
| 181 | ctp | Cytosol | CTP |
| 182 | ctp | Mitochondria | CTP |
| 183 | cvncoa | Cytosol | cervonyl CoA (C22:6CoA) |
| 184 | cvncoa | Mitochondria | cervonyl CoA (C22:6CoA) |
| 185 | cvncrn | Cytosol | cervonyl carnitine (C22:6Crn) |
| 186 | cvncrn | Mitochondria | cervonyl carnitine (C22:6Crn) |
| 187 | cys-L | Cytosol | L-Cysteine |
| 188 | cys-L | Extra-organism | L-Cysteine |
| 189 | cysth-L | Cytosol | L-Cystathionine |
| 190 | cytd | Cytosol | Cytidine |
| 191 | dadp | Cytosol | dADP |
| 192 | datp | Cytosol | dATP |
| 193 | dca | Cytosol | Decanoate |
| 194 | dcamp | Cytosol | N6-(1,2-Dicarboxyethyl)-AMP |
| 195 | dccoa | Mitochondria | Decanoyl-CoA (C10:0CoA) |
| 196 | dcdp | Cytosol | dCDP |
| 197 | dcer_CHO | Cytosol | dihydroceramide, CHO specific |
| 198 | dcsa | Cytosol | docosanoate (n-C22:0) |
| 199 | dcsacoa | Cytosol | docosanoyl-CoA (C22:0CoA) |
| 200 | dcshea | Cytosol | docosahexaenoate (C22:6) |
| 201 | dcshea | Extra-organism | docosahexaenoate (C22:6) |
| 202 | dcshea3 | Cytosol | docosahexaenoate (C22:6, n-3) |
| 203 | dcspea | Cytosol | docosapentaenoic acid (C22:5) |
| 204 | dcspea | Extra-organism | docosapentaenoic acid (C22:5) |
| 205 | dcspea3 | Cytosol | docosapentaenoate (C22:5, n-3) |
| 206 | dcspea6 | Cytosol | docosapentaenoate (C22:5, n-6) |
| 207 | dctp | Cytosol | dCTP |
| 208 | ddca | Cytosol | dodecanoate (C12:0) |
| 209 | ddcoa | Cytosol | Dodecanoyl-CoA (n-C12:0CoA) |
| 210 | ddcoa | Mitochondria | Dodecanoyl-CoA (n-C12:0CoA) |
| 211 | ddsmsterol | Endoplasmic | 7-Dehydrodesmosterol |
| | | Reticulum | |
| 212 | dedol | Cytosol | Dehydrodolichol, mammals |
| 213 | dedoldp | Cytosol | Dehydrodolichol diphosphate, mammals |
| 214 | dedolp | Cytosol | Deydodolichol phosphate, mammals |
| 215 | dgdp | Cytosol | dGDP |
| 216 | dgtp | Cytosol | dGTP |
| 217 | dhap | Cytosol | Dihydroxyacetone phosphate |
| 218 | dhbpt | Cytosol | 6,7-Dihydrobiopterin |
| 219 | dhf | Cytosol | 7,8-Dihydrofolate |
| 220 | dhor-S | Cytosol | (S)-Dihydroorotate |
| 221 | dmpp | Cytosol | Dimethylallyl diphosphate |
| 222 | dmpp | Peroxisome | Dimethylallyl diphosphate |
| 223 | doldp2 | Endoplasmic | Dolichol diphosphate, mammals |
| | | Reticulum | |
| 224 | dolglcp2 | Cytosol | Dolichyl beta-D-glucosyl phosphate, mammals |
| 225 | dolglcp2 | Endoplasmic | Dolichyl beta-D-glucosyl phosphate, mammals |
| | | Reticulum | |
| 226 | dolichol2 | Cytosol | Dolichol, mammals |
| 227 | dolichol2 | Endoplasmic | Dolichol, mammals |
| | | Reticulum | |
| 228 | dolmanp2 | Cytosol | Dolichyl phosphate D-mannose, mammals |
| 229 | dolmanp2 | Endoplasmic | Dolichyl phosphate D-mannose, mammals |
| | | Reticulum | |
| 230 | dolp2 | Cytosol | Dolichol phosphate, mammals |
| 231 | dolp2 | Endoplasmic | Dolichol phosphate, mammals |
| | | Reticulum | |
| 232 | dpcoa | Cytosol | Dephospho-CoA |
| 233 | dshcoa3 | Cytosol | docosahexaenoyl-CoA (C22:6CoA, n-3) |
| 234 | dshcoa3 | Mitochondria | docosahexaenoyl-CoA (C22:6CoA, n-3) |
| 235 | dsmsterol | Endoplasmic | Desmosterol |
| | | Reticulum | |
| 236 | dspcoa3 | Cytosol | docosapentaenoyl-CoA (C22:5CoA, n-3) |
| 237 | dspcoa3 | Mitochondria | docosapentaenoyl-CoA (C22:5CoA, n-3) |
| 238 | dspcoa6 | Cytosol | docosapentaenoyl-CoA (C22:5CoA, n-6) |
| 239 | dspcoa6 | Mitochondria | docosapentaenoyl-CoA (C22:5CoA, n-6) |
| 240 | dtdp | Cytosol | dTDP |
| 241 | dtmp | Cytosol | dTMP |
| 242 | dttp | Cytosol | dTTP |
| 243 | dudp | Cytosol | dUDP |
| 244 | dump | Cytosol | dUMP |
| 245 | duri | Cytosol | Deoxyuridine |
| 246 | dutp | Cytosol | dUTP |
| 247 | e4p | Cytosol | D-Erythrose 4-phosphate |
| 248 | ecsa | Cytosol | Eicosanoate (n-C20:0) |
| 249 | ecsa | Extra-organism | Eicosanoate (n-C20:0) |
| 250 | ecsacoa | Cytosol | Eicosanoyl-CoA (n-C20:0CoA) |
| 251 | ecsacoa | Mitochondria | Eicosanoyl-CoA (n-C20:0CoA) |
| 252 | ecsacrn | Cytosol | eicosanoylcarnitine, C20:0crn |
| 253 | ecsacrn | Mitochondria | eicosanoylcarnitine, C20:0crn |
| 254 | ecsdea9 | Cytosol | eicosadienoate (C20:2, n-9) |
| 255 | ecsea9 | Cytosol | eicosenoate (C20:1, n-9) |
| 256 | ecspea | Cytosol | Eicosapentaenoic acid (C20:5) |
| 257 | ecspea | Extra-organism | Eicosapentaenoic acid (C20:5) |
| 258 | ecspea3 | Cytosol | eicosapentaenoate (C20:5, n-3) |
| 259 | ecspecoa | Cytosol | eicosapentaenoyl-CoA (C20:5CoA) |
| 260 | ecspecoa | Mitochondria | eicosapentaenoyl-CoA (C20:5CoA) |
| 261 | ecspecrn | Cytosol | eicosapentaenoyl carnitine (C20:5Crn) |
| 262 | ecspecrn | Mitochondria | eicosapentaenoyl carnitine (C20:5Crn) |
| 263 | ecstea | Cytosol | eicosatrienoate (C20:3) |
| 264 | ecstea | Extra-organism | eicosatrienoate (C20:3) |
| 265 | ecstea6 | Cytosol | eicosatrienoate (C20:3, n-6) |
| 266 | ecstea9 | Cytosol | eicosatrienoate (C20:3, n-9) |
| 267 | ecsttea3 | Cytosol | eicosatetraenoate (C20:4, n-3) |
| 268 | ecsttea6 | Cytosol | eicosatetraenoate (C20:4, n-6) |
| 269 | edcoa | Mitochondria | endecanoyl-CoA (C11:0CoA) |
| 270 | esdcoa9 | Cytosol | eicosadienoyl-CoA (C20:2CoA, n-9) |
| 271 | esecoa9 | Cytosol | eicosenoyl-CoA (C20:1CoA, n-9) |
| 272 | esecoa9 | Mitochondria | eicosenoyl-CoA (C20:1CoA, n-9) |
| 273 | espcoa3 | Cytosol | eicosapentaenoyl-CoA (C20:5CoA, n-3) |
| 274 | espcoa3 | Mitochondria | eicosapentaenoyl-CoA (C20:5CoA, n-3) |
| 275 | estcoa | Cytosol | eicosatrienoyl-CoA (C20:3CoA) |
| 276 | estcoa | Mitochondria | eicosatrienoyl-CoA (C20:3CoA) |
| 277 | estcoa6 | Cytosol | eicosatrienoyl-CoA (C20:3CoA, n-6) |
| 278 | estcoa6 | Mitochondria | eicosatrienoyl-CoA (C20:3CoA, n-6) |
| 279 | estcoa9 | Cytosol | eicosatrienoyl-CoA (C20:3CoA, n-9) |
| 280 | estcoa9 | Mitochondria | eicosatrienoyl-CoA (C20:3CoA, n-9) |
| 281 | estcrn | Cytosol | eicosatrienoyl carnitine (C20:3Crn) |
| 282 | estcrn | Mitochondria | eicosatrienoyl carnitine (C20:3Crn) |
| 283 | etha | Cytosol | Ethanolamine |
| 284 | etha | Extra-organism | Ethanolamine |
| 285 | ethap | Cytosol | Ethanolamine phosphate |
| 286 | ettcoa3 | Cytosol | eicosatetraenoyl-CoA (C20:4CoA, n-3) |
| 287 | ettcoa6 | Cytosol | eicosatetraenoyl-CoA (C20:4CoA, n-6) |
| 288 | ettcoa6 | Mitochondria | eicosatetraenoyl-CoA (C20:4CoA, n-6) |
| 289 | f26bp | Cytosol | D-Fructose 2,6-bisphosphate |
| 290 | f6p | Cytosol | D-Fructose 6-phosphate |
| 291 | facoa_avg_CHO | Cytosol | Averaged fatty acyl CoA, CHO specific |
| 292 | fad | Mitochondria | FAD |
| 293 | fad | Peroxisome | FAD |
| 294 | fadh2 | Mitochondria | FADH2 |
| 295 | fadh2 | Peroxisome | FADH2 |
| 296 | fald | Cytosol | Formaldehyde |
| 297 | fald | Peroxisome | Formaldehyde |
| 298 | fdp | Cytosol | D-Fructose 1,6-bisphosphate |
| 299 | fe2 | Cytosol | Fe2+ |
| 300 | fe2 | Extra-organism | Fe2+ |
| 301 | fe2 | Mitochondria | Fe2+ |
| 302 | fgam | Cytosol | N2-Formyl-N1-(5-phospho-D-ribosyl)glycinamide |
| 303 | ficytcc | Mitochondria | Ferricytochrome c |
| 304 | focytcc | Mitochondria | Ferrocytochrome c |
| 305 | fol | Cytosol | Folate |
| 306 | fol | Extra-organism | Folate |
| 307 | for | Cytosol | Formate |
| 308 | for | Endoplasmic | Formate |
| | | Reticulum | |
| 309 | for | Extra-organism | Formate |
| 310 | for | Mitochondria | Formate |
| 311 | forglu | Cytosol | N-Formimidoyl-L-glutamate |
| 312 | fpram | Cytosol | 2-(Formamido)-N1-(5-phospho-D-ribosyl)acetamidine |
| 313 | fprica | Cytosol | 5-Formamido-1-(5-phospho-D-ribosyl)imidazole-4-carboxamide |
| 314 | frdp | Cytosol | Farnesyl diphosphate |
| 315 | frdp | Endoplasmic | Farnesyl diphosphate |
| | | Reticulum | |
| 316 | fum | Cytosol | Fumarate |
| 317 | fum | Mitochondria | Fumarate |
| 318 | g1m8mpdol | Endoplasmic | alpha-D-Glucosyl-(alpha-D-mannosyl)8-beta-D-mannosyl- |
| | | Reticulum | diacetylchitobiosyldiphosphodolichol, mammal |
| 319 | g1p | Cytosol | D-Glucose 1-phosphate |
| 320 | g2m8m | Endoplasmic | (alpha-D-Glucosyl)2-(alpha-D-mannosyl)8-beta-D-mannosyl-diacetylchitobiose |
| | | Reticulum | |
| 321 | g2m8mpdol | Endoplasmic | (alpha-D-Glucosyl)2-(alpha-D-mannosyl)8-beta-D-mannosyl- |
| | | Reticulum | diacetylchitobiosyldiphosphodolichol, mammal |
| 322 | g3m8m | Endoplasmic | (alpha-D-Glucosyl)3-(alpha-D-mannosyl)8-beta-D-mannosyl-diacetylchitobiose |
| | | Reticulum | |
| 323 | g3m8mpdol | Endoplasmic | (alpha-D-Glucosyl)3-(alpha-D-mannosyl)8-beta-D-mannosyl- |
| | | Reticulum | diacetylchitobiosyldiphosphodolichol, mammal |
| 324 | g3p | Cytosol | Glyceraldehyde 3-phosphate |
| 325 | g6p | Cytosol | D-Glucose 6-phosphate |
| 326 | g6p | Endoplasmic | D-Glucose 6-phosphate |
| | | Reticulum | |
| 327 | gam | Cytosol | D-Glucosamine |
| 328 | gam6p | Cytosol | D-Glucosamine 6-phosphate |
| 329 | gar | Cytosol | N1-(5-Phospho-D-ribosyl)glycinamide |
| 330 | gdp | Cytosol | GDP |
| 331 | gdp | Golgi Apparatus | GDP |
| 332 | gdp | Mitochondria | GDP |
| 333 | gdpddm | Cytosol | GDP-4-dehydro-6-deoxy-D-mannose |
| 334 | gdpfuc | Cytosol | GDP-L-fucose |
| 335 | gdpfuc | Golgi Apparatus | GDP-L-fucose |
| 336 | gdpman | Cytosol | GDP-D-mannose |
| 337 | glc-D | Cytosol | D-Glucose |
| 338 | glc-D | Endoplasmic | D-Glucose |
| | | Reticulum | |
| 339 | glc-D | Extra-organism | D-Glucose |
| 340 | gln-L | Cytosol | L-Glutamine |
| 341 | gln-L | Extra-organism | L-Glutamine |
| 342 | gln-L | Mitochondria | L-Glutamine |
| 343 | glu-L | Cytosol | L-Glutamate |
| 344 | glu-L | Extra-organism | L-Glutamate |
| 345 | glu-L | Mitochondria | L-Glutamate |
| 346 | glu5p | Mitochondria | L-Glutamate 5-phosphate |
| 347 | glu5sa | Cytosol | L-Glutamate 5-semialdehyde |
| 348 | glu5sa | Mitochondria | L-Glutamate 5-semialdehyde |
| 349 | glucys | Cytosol | gamma-L-Glutamyl-L-cysteine |
| 350 | glutcoa | Mitochondria | Glutaryl-CoA |
| 351 | gly | Cytosol | Glycine |
| 352 | gly | Extra-organism | Glycine |
| 353 | gly | Mitochondria | Glycine |
| 354 | gly | Peroxisome | Glycine |
| 355 | glyc | Cytosol | Glycerol |
| 356 | glyc3p | Cytosol | sn-Glycerol 3-phosphate |
| 357 | glyc3p | Mitochondria | sn-Glycerol 3-phosphate |
| 358 | glycogen | Cytosol | glycogen |
| 359 | gmp | Cytosol | GMP |
| 360 | gmp | Golgi Apparatus | GMP |
| 361 | grdp | Cytosol | Geranyl diphosphate |
| 362 | gthox | Cytosol | Oxidized glutathione |
| 363 | gthrd | Cytosol | Reduced glutathione |
| 364 | gtp | Cytosol | GTP |
| 365 | gtp | Mitochondria | GTP |
| 366 | h | Cytosol | H+ |
| 367 | h | Endoplasmic | H+ |
| | | Reticulum | |
| 368 | h | Extra-organism | H+ |
| 369 | h | Golgi Apparatus | H+ |
| 370 | h | Mitochondria | H+ |
| 371 | h | Peroxisome | H+ |
| 372 | h2o | Cytosol | H2O |
| 373 | h2o | Endoplasmic | H2O |
| | | Reticulum | |
| 374 | h2o | Extra-organism | H2O |
| 375 | h2o | Golgi Apparatus | H2O |
| 376 | h2o | Mitochondria | H2O |
| 377 | h2o | Peroxisome | H2O |
| 378 | h2o2 | Cytosol | Hydrogen peroxide |
| 379 | h2o2 | Mitochondria | Hydrogen peroxide |
| 380 | h2o2 | Peroxisome | Hydrogen peroxide |
| 381 | hco3 | Cytosol | Bicarbonate |
| 382 | hco3 | Mitochondria | Bicarbonate |
| 383 | hcys-L | Cytosol | L-Homocysteine |
| 384 | hdca | Cytosol | hexadecanoate (n-C16:0) |
| 385 | hdca | Extra-organism | hexadecanoate (n-C16:0) |
| 386 | hdcea | Cytosol | hexadecenoate (n-C16:1) |
| 387 | hdcea | Extra-organism | hexadecenoate (n-C16:1) |
| 388 | hdcea7 | Cytosol | hexadecenoate (C16:1, n-7) |
| 389 | hdcecrn | Cytosol | Hexadecenoyl carnitine |
| 390 | hdcecrn | Mitochondria | Hexadecenoyl carnitine |
| 391 | hdcoa | Cytosol | Hexadecenoyl-CoA (n-C16:1CoA) |
| 392 | hdcoa | Mitochondria | Hexadecenoyl-CoA (n-C16:1CoA) |
| 393 | hdcoa7 | Cytosol | hexadecenoyl-CoA (C16:1CoA, n-7) |
| 394 | hdcoa7 | Mitochondria | hexadecenoyl-CoA (C16:1CoA, n-7) |
| 395 | hgentis | Cytosol | Homogentisate |
| 396 | hibcoa | Mitochondria | (S)-3-Hydroxyisobutyryl-CoA |
| 397 | his-L | Cytosol | L-Histidine |
| 398 | his-L | Extra-organism | L-Histidine |
| 399 | hkyn | Cytosol | 3-Hydroxy-L-kynurenine |
| 400 | hmbil | Cytosol | Hydroxymethylbilane |
| 401 | hmgcoa | Cytosol | Hydroxymethylglutaryl-CoA |
| 402 | hmgcoa | Mitochondria | Hydroxymethylglutaryl-CoA |
| 403 | hpcoa | Mitochondria | heptanoyl-CoA (C7:0CoA) |
| 404 | hpdca | Cytosol | heptadecanoate (C17:0) |
| 405 | hpdcoa | Cytosol | heptadecanoyl CoA (C17:0CoA) |
| 406 | hpdcoa | Mitochondria | heptadecanoyl CoA (C17:0CoA) |
| 407 | hxa | Cytosol | Hexanoate |
| 408 | hxan | Cytosol | Hypoxanthine |
| 409 | hxan | Extra-organism | Hypoxanthine |
| 410 | hxcoa | Mitochondria | Hexanoyl-CoA (C6:0CoA) |
| 411 | ibcoa | Mitochondria | Isobutyryl-CoA |
| 412 | icit | Cytosol | Isocitrate |
| 413 | icit | Mitochondria | Isocitrate |
| 414 | idp | Cytosol | IDP |
| 415 | ile-L | Cytosol | L-Isoleucine |
| 416 | ile-L | Extra-organism | L-Isoleucine |
| 417 | ile-L | Mitochondria | L-Isoleucine |
| 418 | ilnlc | Cytosol | isolinoleic acid (C18:2, n-9) |
| 419 | ilnlcoa | Cytosol | isolinoleoyl-CoA (C18:2CoA, n-9) |
| 420 | imp | Cytosol | IMP |
| 421 | inost | Cytosol | myo-Inositol |
| 422 | inost | Extra-organism | myo-Inositol |
| 423 | ins | Cytosol | Inosine |
| 424 | ins | Extra-organism | Inosine |
| 425 | ipdp | Cytosol | Isopentenyl diphosphate |
| 426 | ipdp | Peroxisome | Isopentenyl diphosphate |
| 427 | itp | Cytosol | ITP |
| 428 | ivcoa | Mitochondria | Isovaleryl-CoA |
| 429 | kynr-L | Cytosol | L-Kynurenine |
| 430 | lac-L | Cytosol | L-Lactate |
| 431 | lac-L | Extra-organism | L-Lactate |
| 432 | lanost | Endoplasmic | Lanosterol |
| | | Reticulum | |
| 433 | lathost | Endoplasmic | Lathosterol |
| | | Reticulum | |
| 434 | leu-L | Cytosol | L-Leucine |
| 435 | leu-L | Extra-organism | L-Leucine |
| 436 | leu-L | Mitochondria | L-Leucine |
| 437 | Lfmkynr | Cytosol | L-Formylkynurenine |
| 438 | lgnccoa | Cytosol | lignocericyl coenzyme A |
| 439 | lgnccoa | Mitochondria | lignocericyl coenzyme A |
| 440 | lgnccrn | Cytosol | lignoceryl carnitine |
| 441 | lgnccrn | Mitochondria | lignoceryl carnitine |
| 442 | lnlecoa | Cytosol | Linolenoyl-CoA (C18:3CoA) |
| 443 | lnlecoa | Mitochondria | Linolenoyl-CoA (C18:3CoA) |
| 444 | lnlecrn | Cytosol | linolenoyl carnitine (C18:3Crn) |
| 445 | lnlecrn | Mitochondria | linolenoyl carnitine (C18:3Crn) |
| 446 | lnlne | Cytosol | Linolenic acid (C18:3) |
| 447 | lnlne | Extra-organism | Linolenic acid (C18:3) |
| 448 | Lsacchrp | Mitochondria | L-Saccharopine |
| 449 | lys-L | Cytosol | L-Lysine |
| 450 | lys-L | Extra-organism | L-Lysine |
| 451 | lys-L | Mitochondria | L-Lysine |
| 452 | m1mpdol | Cytosol | alpha-D-mannosyl-beta-D-mannosyl-diacylchitobiosyldiphosphodolichol, mammals |
| 453 | m2mpdol | Cytosol | (alpha-D-mannosyl)2-beta-D-mannosyl-diacetylchitobiosyldiphosphodolichol, |
| | | | mammals |
| 454 | m3mpdol | Cytosol | (alpha-D-mannosyl)3-beta-D-mannosyl-diacetylchitodiphosphodolichol, mammals |
| 455 | m4m | Golgi Apparatus | (alpha-D-mannosyl)4-beta-D-mannosyl-diacetylchitobiose |
| 456 | m4mpdol | Cytosol | (alpha-D-Mannosyl)4-beta-D-mannosyl-diacetylchitobiosyldiphosphodolichol, |
| | | | mammals |
| 457 | m4mpdol | Endoplasmic | (alpha-D-Mannosyl)4-beta-D-mannosyl-diacetylchitobiosyldiphosphodolichol, |
| | | Reticulum | mammals |
| 458 | m5m | Golgi Apparatus | (alpha-D-mannosyl)5-beta-D-mannosyl-diacetylchitobiose |
| 459 | m5mpdol | Endoplasmic | (alpha-D-Mannosyl)5-beta-D-mannosyl-diacetylchitobiosyldiphosphodolichol, |
| | | Reticulum | mammals |
| 460 | m6m | Golgi Apparatus | (alpha-D-mannosyl)6-beta-D-mannosyl-diacetylchitobiose |
| 461 | m6mpdol | Endoplasmic | (alpha-D-Mannosyl)6-beta-D-mannosyl-diacetylchitobiosyldiphosphodolichol, |
| | | Reticulum | mammals |
| 462 | m7m | Endoplasmic | (alpha-D-mannosyl)7-beta-D-mannosyl-diacetylchitobiose |
| | | Reticulum | |
| 463 | m7m | Golgi Apparatus | (alpha-D-mannosyl)7-beta-D-mannosyl-diacetylchitobiose |
| 464 | m7mpdol | Endoplasmic | (alpha-D-Mannosyl)7-beta-D-mannosyl-diacetylchitobiosyldiphosphodolichol, |
| | | Reticulum | mammals |
| 465 | m8m | Endoplasmic | (alpha-D-mannosyl)8-beta-D-mannosyl-diacetylchitobiose |
| | | Reticulum | |
| 466 | m8m | Golgi Apparatus | (alpha-D-mannosyl)8-beta-D-mannosyl-diacetylchitobiose |
| 467 | m8mpdol | Endoplasmic | (alpha-D-Mannosyl)8-beta-D-mannosyl-diacetylchitobiosyldiphosphodolichol, |
| | | Reticulum | mammals |
| 468 | mal-L | Cytosol | L-Malate |
| 469 | mal-L | Mitochondria | L-Malate |
| 470 | malcoa | Cytosol | Malonyl-CoA |
| 471 | man | Cytosol | D-Mannose |
| 472 | man | Endoplasmic | D-Mannose |
| | | Reticulum | |
| 473 | man | Golgi Apparatus | D-Mannose |
| 474 | man1p | Cytosol | D-Mannose 1-phosphate |
| 475 | man6p | Cytosol | D-Mannose 6-phosphate |
| 476 | mercppyr | Cytosol | Mercaptopyruvate |
| 477 | met-L | Cytosol | L-Methionine |
| 478 | met-L | Extra-organism | L-Methionine |
| 479 | methf | Cytosol | 5,10-Methenyltetrahydrofolate |
| 480 | methf | Mitochondria | 5,10-Methenyltetrahydrofolate |
| 481 | mev-R | Cytosol | (R)-Mevalonate |
| 482 | mev-R | Peroxisome | (R)-Mevalonate |
| 483 | mglyc_CHO | Cytosol | monoacylglycerol, CHO specific |
| 484 | mi1p-D | Cytosol | 1D-myo-Inositol 1-phosphate |
| 485 | mlthf | Cytosol | 5,10-Methylenetetrahydrofolate |
| 486 | mlthf | Mitochondria | 5,10-Methylenetetrahydrofolate |
| 487 | mmal | Cytosol | Methylmalonate |
| 488 | mmal | Mitochondria | Methylmalonate |
| 489 | mmalsa-S | Cytosol | (S)-Methylmalonate semialdehyde |
| 490 | mmalsa-S | Mitochondria | (S)-Methylmalonate semialdehyde |
| 491 | mmcoa-R | Mitochondria | (R)-Methylmalonyl-CoA |
| 492 | mmcoa-S | Mitochondria | (S)-Methylmalonyl-CoA |
| 493 | mpdol | Cytosol | beta-D-Mannosyldiacetylchitobiosyldiphosphodolichol, mammals |
| 494 | N-bi | Cytosol | Gal b1-4 GlcNAc b1-2 Man a1-3(Gal b1-4 GlcNAc b1-2 Man a1-6) Man b1- |
| | | | 4 GlcNAc b1-4(Fuc a1-6) GlcNAcOH |
| 495 | N-bi | Extra-organism | Gal b1-4 GlcNAc b1-2 Man a1-3(Gal b1-4 GlcNAc b1-2 Man a1-6) Man b1- |
| | | | 4 GlcNAc b1-4(Fuc a1-6) GlcNAcOH |
| 496 | N-bi | Golgi Apparatus | Gal b1-4 GlcNAc b1-2 Man a1-3(Gal b1-4 GlcNAc b1-2 Man a1-6) Man b1- |
| | | | 4 GlcNAc b1-4(Fuc a1-6) GlcNAcOH |
| 497 | N-biS1 | Cytosol | Gal b1-4 GlcNAc b1-2 Man a1-3(NeuAc a2-3 Gal b1-4 GlcNAc b1-2 Man a1- |
| | | | 6) Man b1-4 GlcNAc b1-4(Fuc a1-6) GlcNAcOH |
| 498 | N-biS1 | Extra-organism | Gal b1-4 GlcNAc b1-2 Man a1-3(NeuAc a2-3 Gal b1-4 GlcNAc b1-2 Man a1- |
| | | | 6) Man b1-4 GlcNAc b1-4(Fuc a1-6) GlcNAcOH |
| 499 | N-biS1 | Golgi Apparatus | Gal b1-4 GlcNAc b1-2 Man a1-3(NeuAc a2-3 Gal b1-4 GlcNAc b1-2 Man a1- |
| | | | 6) Man b1-4 GlcNAc b1-4(Fuc a1-6) GlcNAcOH |
| 500 | N-tetra/N-triLac1 | Cytosol | Gal b1-4 GlcNAc b1-2(Gal b1-4 GlcNAc b1-4) Man a1-3(Gal b1-4 GlcNAc b1- |
| | | | 2(Gal b1-4 GlcNAc b1-6) Man a1-6) Man b1-4 GlcNAc b1-4(Fuc a1-6) GlcNAcOH |
| 501 | N-tetra/N-triLac1 | Extra-organism | Gal b1-4 GlcNAc b1-2(Gal b1-4 GlcNAc b1-4) Man a1-3(Gal b1-4 GlcNAc b1- |
| | | | 2(Gal b1-4 GlcNAc b1-6) Man a1-6) Man b1-4 GlcNAc b1-4(Fuc a1-6) GlcNAcOH |
| 502 | N-tetra/N-triLac1 | Golgi Apparatus | Gal b1-4 GlcNAc b1-2(Gal b1-4 GlcNAc b1-4) Man a1-3(Gal b1-4 GlcNAc b1- |
| | | | 2(Gal b1-4 GlcNAc b1-6) Man a1-6) Man b1-4 GlcNAc b1-4(Fuc a1-6) GlcNAcOH |
| 503 | N-tetraLac1 | Cytosol | Gal b1-4 GlcNAc b1-2(Gal b1-4 GlcNAc b1-4) Man a1-3(Gal b1-4 GlcNAc b1- |
| | | | 2(Gal b1-4 GlcNAc b1-3 Gal b1-4 GlcNAc b1-6) Man a1-6) Man b1-4 GlcNAc b1- |
| | | | 4(Fuc a1-6) GlcNAcOH |
| 504 | N-tetraLac1 | Extra-organism | Gal b1-4 GlcNAc b1-2(Gal b1-4 GlcNAc b1-4) Man a1-3(Gal b1-4 GlcNAc b1- |
| | | | 2(Gal b1-4 GlcNAc b1-3 Gal b1-4 GlcNAc b1-6) Man a1-6) Man b1-4 GlcNAc b1- |
| | | | 4(Fuc a1-6) GlcNAcOH |
| 505 | N-tetraLac1 | Golgi Apparatus | Gal b1-4 GlcNAc b1-2(Gal b1-4 GlcNAc b1-4) Man a1-3(Gal b1-4 GlcNAc b1- |
| | | | 2(Gal b1-4 GlcNAc b1-3 Gal b1-4 GlcNAc b1-6) Man a1-6) Man b1-4 GlcNAc b1- |
| | | | 4(Fuc a1-6) GlcNAcOH |
| 506 | N-tetraLac1S1 | Cytosol | Gal b1-4 GlcNAc b1-2(Gal b1-4 GlcNAc b1-4) Man a1-3(Gal b1-4 GlcNAc b1- |
| | | | 2(NeuAc a2-3 Gal b1-4 GlcNAc b1-3 Gal b1-4 GlcNAc b1-6) Man a1-6) Man b1- |
| | | | 4 GlcNAc b1-4(Fuc a1-6) GlcNAcOH |
| 507 | N-tetraLac1S1 | Extra-organism | Gal b1-4 GlcNAc b1-2(Gal b1-4 GlcNAc b1-4) Man a1-3(Gal b1-4 GlcNAc b1- |
| | | | 2(NeuAc a2-3 Gal b1-4 GlcNAc b1-3 Gal b1-4 GlcNAc b1-6) Man a1-6) Man b1- |
| | | | 4 GlcNAc b1-4(Fuc a1-6) GlcNAcOH |
| 508 | N-tetraLac1S1 | Golgi Apparatus | Gal b1-4 GlcNAc b1-2(Gal b1-4 GlcNAc b1-4) Man a1-3(Gal b1-4 GlcNAc b1- |
| | | | 2(NeuAc a2-3 Gal b1-4 GlcNAc b1-3 Gal b1-4 GlcNAc b1-6) Man a1-6) Man b1- |
| | | | 4 GlcNAc b1-4(Fuc a1-6) GlcNAcOH |
| 509 | N-tetraLac1S2 | Cytosol | Gal b1-4 GlcNAc b1-2(Gal b1-4 GlcNAc b1-4) Man a1-3(NeuAc a2-3 Gal b1-4 |
| | | | GlcNAc b1-2(NeuAc a2-3 Gal b1-4 GlcNAc b1-3 Gal b1-4 GlcNAc b1-6) Man a1- |
| | | | 6) Man b1-4 GlcNAc b1-4(Fuc a1-6) GlcNAcOH |
| 510 | N-tetraLac1S2 | Extra-organism | Gal b1-4 GlcNAc b1-2(Gal b1-4 GlcNAc b1-4) Man a1-3(NeuAc a2-3 Gal b1-4 |
| | | | GlcNAc b1-2(NeuAc a2-3 Gal b1-4 GlcNAc b1-3 Gal b1-4 GlcNAc b1-6) Man a1- |
| | | | 6) Man b1-4 GlcNAc b1-4(Fuc a1-6) GlcNAcOH |
| 511 | N-tetraLac1S2 | Golgi Apparatus | Gal b1-4 GlcNAc b1-2(Gal b1-4 GlcNAc b1-4) Man a1-3(NeuAc a2-3 Gal b1-4 |
| | | | GlcNAc b1-2(NeuAc a2-3 Gal b1-4 GlcNAc b1-3 Gal b1-4 GlcNAc b1-6) Man a1- |
| | | | 6) Man b1-4 GlcNAc b1-4(Fuc a1-6) GlcNAcOH |
| 512 | N-tetraLac1S3 | Cytosol | Galb1-4GlcNAcb1-2(NeuAca2-3Galb1-4GlcNAcb1-4)Mana1-3(NeuAca2-3Galb1-4 |
| | | | GlcNAc b1-2(NeuAca2-3Galb1-4GlcNAcb1-3Galb1-4GlcNAcb1-6)Mana1-6)Manb1- |
| | | | 4GlcNAcb1-4(Fuc a1-6)GlcNAcOH |
| 513 | N-tetraLac1S3 | Extra-organism | Galb1-4GlcNAcb1-2(NeuAca2-3Galb1-4GlcNAcb1-4)Mana1-3(NeuAca2-3Galb1-4 |
| | | | GlcNAc b1-2(NeuAca2-3Galb1-4GlcNAcb1-3Galb1-4GlcNAcb1-6)Mana1-6)Manb1- |
| | | | 4GlcNAcb1-4(Fuc a1-6)GlcNAcOH |
| 514 | N-tetraLac1S3 | Golgi Apparatus | Galb1-4GlcNAcb1-2(NeuAca2-3Galb1-4GlcNAcb1-4)Mana1-3(NeuAca2-3Galb1-4 |
| | | | GlcNAc b1-2(NeuAca2-3Galb1-4GlcNAcb1-3Galb1-4GlcNAcb1-6)Mana1-6)Manb1- |
| | | | 4GlcNAcb1-4(Fuc a1-6)GlcNAcOH |
| 515 | N-tetraLac1S4 | Cytosol | NeuAca2-3Galb1-4GlcNAcb1-2(NeuAca2-3Galb1-4GlcNAcb1-4)Mana1-3(NeuAca2- |
| | | | 3Galb1-4 GlcNAc b1-2(NeuAca2-3Galb1-4GlcNAcb1-3Galb1-4GlcNAcb1-6)Mana1- |
| | | | 6)Manb1-4GlcNAcb1-4(Fuc a1-6)GlcNAcOH |
| 516 | N-tetraLac1S4 | Extra-organism | NeuAca2-3Galb1-4GlcNAcb1-2(NeuAca2-3Galb1-4GlcNAcb1-4)Mana1-3(NeuAca2- |
| | | | 3Galb1-4 GlcNAc b1-2(NeuAca2-3Galb1-4GlcNAcb1-3Galb1-4GlcNAcb1-6)Mana1- |
| | | | 6)Manb1-4GlcNAcb1-4(Fuc a1-6)GlcNAcOH |
| 517 | N-tetraLac1S4 | Golgi Apparatus | NeuAca2-3Galb1-4GlcNAcb1-2(NeuAca2-3Galb1-4GlcNAcb1-4)Mana1-3(NeuAca2- |
| | | | 3Galb1-4 GlcNAc b1-2(NeuAca2-3Galb1-4GlcNAcb1-3Galb1-4GlcNAcb1-6)Mana1- |
| | | | 6)Manb1-4GlcNAcb1-4(Fuc a1-6)GlcNAcOH |
| 518 | N-tetraLac2 | Cytosol | Galb1-4GlcNAcb1-2(Galb1-4GlcNAcb1-4)Mana1-3(Galb1-4GlcNAcb1-3Galb1- |
| | | | 4GlcNAcb1-2(Galb1-4GlcNAcb1-3Galb1-4GlcNAcb1-6)Mana1-6)Manb1-4GlcNAcb1- |
| | | | 4(Fuca1-6)GlcNAcOH |
| 519 | N-tetraLac2 | Extra-organism | Galb1-4GlcNAcb1-2(Galb1-4GlcNAcb1-4)Mana1-3(Galb1-4GlcNAcb1-3Galb1- |
| | | | 4GlcNAcb1-2(Galb1-4GlcNAcb1-3Galb1-4GlcNAcb1-6)Mana1-6)Manb1-4GlcNAcb1- |
| | | | 4(Fuca1-6)GlcNAcOH |
| 520 | N-tetraLac2 | Golgi Apparatus | Galb1-4GlcNAcb1-2(Galb1-4GlcNAcb1-4)Mana1-3(Galb1-4GlcNAcb1-3Galb1- |
| | | | 4GlcNAcb1-2(Galb1-4GlcNAcb1-3Galb1-4GlcNAcb1-6)Mana1-6)Manb1-4GlcNAcb1- |
| | | | 4(Fuca1-6)GlcNAcOH |
| 521 | N-tetraLac2S1 | Cytosol | Galb1-4GlcNAcb1-2(Galb1-4GlcNAcb1-4)Mana1-3(Galb1-4GlcNAcb1-3Galb1- |
| | | | 4GlcNAcb1-2(NeuAca2-3Galb1-4GlcNAcb1-3Galb1-4GlcNAcb1-6)Mana1-6)Manb1- |
| | | | 4GlcNAcb1-4(Fuca1-6)GlcNAcOH |
| 522 | N-tetraLac2S1 | Extra-organism | Galb1-4GlcNAcb1-2(Galb1-4GlcNAcb1-4)Mana1-3(Galb1-4GlcNAcb1-3Galb1- |
| | | | 4GlcNAcb1-2(NeuAca2-3Galb1-4GlcNAcb1-3Galb1-4GlcNAcb1-6)Mana1-6)Manb1- |
| | | | 4GlcNAcb1-4(Fuca1-6)GlcNAcOH |
| 523 | N-tetraLac2S1 | Golgi Apparatus | Galb1-4GlcNAcb1-2(Galb1-4GlcNAcb1-4)Mana1-3(Galb1-4GlcNAcb1-3Galb1- |
| | | | 4GlcNAcb1-2(NeuAca2-3Galb1-4GlcNAcb1-3Galb1-4GlcNAcb1-6)Mana1-6)Manb1- |
| | | | 4GlcNAcb1-4(Fuca1-6)GlcNAcOH |
| 524 | N-tetraLac2S2 | Cytosol | Galb1-4GlcNAcb1-2(Galb1-4GlcNAcb1-4)Mana1-3(NeuAca2-3Galb1-4GlcNAcb1- |
| | | | 3Galb1-4GlcNAcb1-2(NeuAca2-3Galb1-4GlcNAcb1-3Galb1-4GlcNAcb1-6)Mana1- |
| | | | 6)Manb1-4GlcNAcb1-4(Fuca1-6)GlcNAcOH |
| 525 | N-tetraLac2S2 | Extra-organism | Galb1-4GlcNAcb1-2(Galb1-4GlcNAcb1-4)Mana1-3(NeuAca2-3Galb1-4GlcNAcb1- |
| | | | 3Galb1-4GlcNAcb1-2(NeuAca2-3Galb1-4GlcNAcb1-3Galb1-4GlcNAcb1-6)Mana1- |
| | | | 6)Manb1-4GlcNAcb1-4(Fuca1-6)GlcNAcOH |
| 526 | N-tetraLac2S2 | Golgi Apparatus | Galb1-4GlcNAcb1-2(Galb1-4GlcNAcb1-4)Mana1-3(NeuAca2-3Galb1-4GlcNAcb1- |
| | | | 3Galb1-4GlcNAcb1-2(NeuAca2-3Galb1-4GlcNAcb1-3Galb1-4GlcNAcb1-6)Mana1- |
| | | | 6)Manb1-4GlcNAcb1-4(Fuca1-6)GlcNAcOH |
| 527 | N-tetraLac2S3 | Cytosol | Galb1-4GlcNAcb1-2(NeuAca2-3Galb1-4GlcNAcb1-4)Mana1-3(NeuAca2-3Galb1- |
| | | | 4GlcNAcb1-3Galb1-4GlcNAcb1-2(NeuAca2-3Galb1-4GlcNAcb1-3Galb1-4GlcNAcb1- |
| | | | 6)Mana1-6)Manb1-4GlcNAcb1-4(Fuca1-6)GlcNAcOH |
| 528 | N-tetraLac2S3 | Extra-organism | Galb1-4GlcNAcb1-2(NeuAca2-3Galb1-4GlcNAcb1-4)Mana1-3(NeuAca2-3Galb1- |
| | | | 4GlcNAcb1-3Galb1-4GlcNAcb1-2(NeuAca2-3Galb1-4GlcNAcb1-3Galb1-4GlcNAcb1- |
| | | | 6)Mana1-6)Manb1-4GlcNAcb1-4(Fuca1-6)GlcNAcOH |
| 529 | N-tetraLac2S3 | Golgi Apparatus | Galb1-4GlcNAcb1-2(NeuAca2-3Galb1-4GlcNAcb1-4)Mana1-3(NeuAca2-3Galb1- |
| | | | 4GlcNAcb1-3Galb1-4GlcNAcb1-2(NeuAca2-3Galb1-4GlcNAcb1-3Galb1-4GlcNAcb1- |
| | | | 6)Mana1-6)Manb1-4GlcNAcb1-4(Fuca1-6)GlcNAcOH |
| 530 | N-tetraLac2S4 | Cytosol | NeuAca2-3Galb1-4GlcNAcb1-2(NeuAca2-3Galb1-4GlcNAcb1-4)Mana1-3(NeuAca2- |
| | | | 3Galb1-4GlcNAcb1-3Galb1-4GlcNAcb1-2(NeuAca2-3Galb1-4GlcNAcb1-3Galb1- |
| | | | 4GlcNAcb1-6)Mana1-6)Manb1-4GlcNAcb1-4(Fuca1-6)GlcNAcOH |
| 531 | N-tetraLac2S4 | Extra-organism | NeuAca2-3Galb1-4GlcNAcb1-2(NeuAca2-3Galb1-4GlcNAcb1-4)Mana1-3(NeuAca2- |
| | | | 3Galb1-4GlcNAcb1-3Galb1-4GlcNAcb1-2(NeuAca2-3Galb1-4GlcNAcb1-3Galb1- |
| | | | 4GlcNAcb1-6)Mana1-6)Manb1-4GlcNAcb1-4(Fuca1-6)GlcNAcOH |
| 532 | N-tetraLac2S4 | Golgi Apparatus | NeuAca2-3Galb1-4GlcNAcb1-2(NeuAca2-3Galb1-4GlcNAcb1-4)Mana1-3(NeuAca2- |
| | | | 3Galb1-4GlcNAcb1-3Galb1-4GlcNAcb1-2(NeuAca2-3Galb1-4GlcNAcb1-3Galb1- |
| | | | 4GlcNAcb1-6)Mana1-6)Manb1-4GlcNAcb1-4(Fuca1-6)GlcNAcOH |
| 533 | N-tetraLac3 | Cytosol | Galb1-4GlcNAcb1-2(Galb1-4GlcNAcb1-3Galb1-4GlcNAcb1-4)Mana1-3(Galb1- |
| | | | 4GlcNAcb1-3Galb1-4GlcNAcb1-2(Galb1-4GlcNAcb1-3Galb1-4GlcNAcb1-6)Mana1- |
| | | | 6)Manb1-4GlcNAcb1-4(Fuca1-6)GlcNAcOH |
| 534 | N-tetraLac3 | Extra-organism | Galb1-4GlcNAcb1-2(Galb1-4GlcNAcb1-3Galb1-4GlcNAcb1-4)Mana1-3(Galb1- |
| | | | 4GlcNAcb1-3Galb1-4GlcNAcb1-2(Galb1-4GlcNAcb1-3Galb1-4GlcNAcb1-6)Mana1- |
| | | | 6)Manb1-4GlcNAcb1-4(Fuca1-6)GlcNAcOH |
| 535 | N-tetraLac3 | Golgi Apparatus | Galb1-4GlcNAcb1-2(Galb1-4GlcNAcb1-3Galb1-4GlcNAcb1-4)Mana1-3(Galb1- |
| | | | 4GlcNAcb1-3Galb1-4GlcNAcb1-2(Galb1-4GlcNAcb1-3Galb1-4GlcNAcb1-6)Mana1- |
| | | | 6)Manb1-4GlcNAcb1-4(Fuca1-6)GlcNAcOH |
| 536 | N-tetraLac3S1 | Cytosol | Galb1-4GlcNAcb1-2(Galb1-4GlcNAcb1-3Galb1-4GlcNAcb1-4)Mana1-3(Galb1- |
| | | | 4GlcNAcb1-3Galb1-4GlcNAcb1-2(NeuAca2-3Galb1-4GlcNAcb1-3Galb1-4GlcNAcb1- |
| | | | 6)Mana1-6)Manb1-4GlcNAcb1-4(Fuca1-6)GlcNAcOH |
| 537 | N-tetraLac3S1 | Extra-organism | Galb1-4GlcNAcb1-2(Galb1-4GlcNAcb1-3Galb1-4GlcNAcb1-4)Mana1-3(Galb1- |
| | | | 4GlcNAcb1-3Galb1-4GlcNAcb1-2(NeuAca2-3Galb1-4GlcNAcb1-3Galb1-4GlcNAcb1- |
| | | | 6)Mana1-6)Manb1-4GlcNAcb1-4(Fuca1-6)GlcNAcOH |
| 538 | N-tetraLac3S1 | Golgi Apparatus | Galb1-4GlcNAcb1-2(Galb1-4GlcNAcb1-3Galb1-4GlcNAcb1-4)Mana1-3(Galb1- |
| | | | 4GlcNAcb1-3Galb1-4GlcNAcb1-2(NeuAca2-3Galb1-4GlcNAcb1-3Galb1-4GlcNAcb1- |
| | | | 6)Mana1-6)Manb1-4GlcNAcb1-4(Fuca1-6)GlcNAcOH |
| 539 | N-tetraLac3S2 | Cytosol | Galb1-4GlcNAcb1-2(Galb1-4GlcNAcb1-3Galb1-4GlcNAcb1-4)Mana1-3(NeuAca2- |
| | | | 3Galb1-4GlcNAcb1-3Galb1-4GlcNAcb1-2(NeuAca2-3Galb1-4GlcNAcb1-3Galb1- |
| | | | 4GlcNAcb1-6)Mana1-6)Manb1-4GlcNAcb1-4(Fuca1-6)GlcNAcOH |
| 540 | N-tetraLac3S2 | Extra-organism | Galb1-4GlcNAcb1-2(Galb1-4GlcNAcb1-3Galb1-4GlcNAcb1-4)Mana1-3(NeuAca2- |
| | | | 3Galb1-4GlcNAcb1-3Galb1-4GlcNAcb1-2(NeuAca2-3Galb1-4GlcNAcb1-3Galb1- |
| | | | 4GlcNAcb1-6)Mana1-6)Manb1-4GlcNAcb1-4(Fuca1-6)GlcNAcOH |
| 541 | N-tetraLac3S2 | Golgi Apparatus | Galb1-4GlcNAcb1-2(Galb1-4GlcNAcb1-3Galb1-4GlcNAcb1-4)Mana1-3(NeuAca2- |
| | | | 3Galb1-4GlcNAcb1-3Galb1-4GlcNAcb1-2(NeuAca2-3Galb1-4GlcNAcb1-3Galb1- |
| | | | 4GlcNAcb1-6)Mana1-6)Manb1-4GlcNAcb1-4(Fuca1-6)GlcNAcOH |
| 542 | N-tetraLac3S3 | Cytosol | Galb1-4GlcNAcb1-2(NeuAca2-3Galb1-4GlcNAcb1-3Galb1-4GlcNAcb1-4)Mana1- |
| | | | 3(NeuAca2-3Galb1-4GlcNAcb1-3Galb1-4GlcNAcb1-2(NeuAca2-3Galb1-4GlcNAcb1- |
| | | | 3Galb1-4GlcNAcb1-6)Mana1-6)Manb1-4GlcNAcb1-4(Fuca1-6)GlcNAcOH |
| 543 | N-tetraLac3S3 | Extra-organism | Galb1-4GlcNAcb1-2(NeuAca2-3Galb1-4GlcNAcb1-3Galb1-4GlcNAcb1-4)Mana1- |
| | | | 3(NeuAca2-3Galb1-4GlcNAcb1-3Galb1-4GlcNAcb1-2(NeuAca2-3Galb1-4GlcNAcb1- |
| | | | 3Galb1-4GlcNAcb1-6)Mana1-6)Manb1-4GlcNAcb1-4(Fuca1-6)GlcNAcOH |
| 544 | N-tetraLac3S3 | Golgi Apparatus | Galb1-4GlcNAcb1-2(NeuAca2-3Galb1-4GlcNAcb1-3Galb1-4GlcNAcb1-4)Mana1- |
| | | | 3(NeuAca2-3Galb1-4GlcNAcb1-3Galb1-4GlcNAcb1-2(NeuAca2-3Galb1-4GlcNAcb1- |
| | | | 3Galb1-4GlcNAcb1-6)Mana1-6)Manb1-4GlcNAcb1-4(Fuca1-6)GlcNAcOH |
| 545 | N-tetraS1/N-triLac1S1 | Cytosol | Gal b1-4 GlcNAc b1-2(Gal b1-4 GlcNAc b1-4) Man a1-3(NeuAc a2-3 Gal b1- |
| | | | 4 GlcNAc b1-2(Gal b1-4 GlcNAc b1-6) Man a1-6) Man b1-4 GlcNAc b1-4(Fuc a1- |
| | | | 6) GlcNAcOH |
| 546 | N-tetraS1/N-triLac1S1 | Extra-organism | Gal b1-4 GlcNAc b1-2(Gal b1-4 GlcNAc b1-4) Man a1-3(NeuAc a2-3 Gal b1- |
| | | | 4 GlcNAc b1-2(Gal b1-4 GlcNAc b1-6) Man a1-6) Man b1-4 GlcNAc b1-4(Fuc a1- |
| | | | 6) GlcNAcOH |
| 547 | N-tetraS1/N-triLac1S1 | Golgi Apparatus | Gal b1-4 GlcNAc b1-2(Gal b1-4 GlcNAc b1-4) Man a1-3(NeuAc a2-3 Gal b1- |
| | | | 4 GlcNAc b1-2(Gal b1-4 GlcNAc b1-6) Man a1-6) Man b1-4 GlcNAc b1-4(Fuc a1- |
| | | | 6) GlcNAcOH |
| 548 | N-tetraS2/N-triLac1S2 | Cytosol | Gal b1-4 GlcNAc b1-2(Gal b1-4 GlcNAc b1-4) Man a1-3(NeuAc a2-3 Gal b1- |
| | | | 4 GlcNAc b1-2(NeuAc a2-3 Gal b1-4 GlcNAc b1-6) Man a1-6) Man b1-4 GlcNAc b1- |
| | | | 4(Fuc a1-6) GlcNAcOH |
| 549 | N-tetraS2/N-triLac1S2 | Extra-organism | Gal b1-4 GlcNAc b1-2(Gal b1-4 GlcNAc b1-4) Man a1-3(NeuAc a2-3 Gal b1- |
| | | | 4 GlcNAc b1-2(NeuAc a2-3 Gal b1-4 GlcNAc b1-6) Man a1-6) Man b1-4 GlcNAc b1- |
| | | | 4(Fuc a1-6) GlcNAcOH |
| 550 | N-tetraS2/N-triLac1S2 | Golgi Apparatus | Gal b1-4 GlcNAc b1-2(Gal b1-4 GlcNAc b1-4) Man a1-3(NeuAc a2-3 Gal b1- |
| | | | 4 GlcNAc b1-2(NeuAc a2-3 Gal b1-4 GlcNAc b1-6) Man a1-6) Man b1-4 GlcNAc b1- |
| | | | 4(Fuc a1-6) GlcNAcOH |
| 551 | N-tetraS3 | Cytosol | Gal b1-4 GlcNAc b1-2(NeuAc a2-3 Gal b1-4 GlcNAc b1-4) Man a1-3(NeuAc a2- |
| | | | 3 Gal b1-4 GlcNAc b1-2(NeuAc a2-3 Gal b1-4 GlcNAc b1-6) Man a1-6) Man b1- |
| | | | 4 GlcNAc b1-4(Fuc a1-6) GlcNAcOH |
| 552 | N-tetraS3 | Extra-organism | Gal b1-4 GlcNAc b1-2(NeuAc a2-3 Gal b1-4 GlcNAc b1-4) Man a1-3(NeuAc a2- |
| | | | 3 Gal b1-4 GlcNAc b1-2(NeuAc a2-3 Gal b1-4 GlcNAc b1-6) Man a1-6) Man b1- |
| | | | 4 GlcNAc b1-4(Fuc a1-6) GlcNAcOH |
| 553 | N-tetraS3 | Golgi Apparatus | Gal b1-4 GlcNAc b1-2(NeuAc a2-3 Gal b1-4 GlcNAc b1-4) Man a1-3(NeuAc a2- |
| | | | 3 Gal b1-4 GlcNAc b1-2(NeuAc a2-3 Gal b1-4 GlcNAc b1-6) Man a1-6) Man b1- |
| | | | 4 GlcNAc b1-4(Fuc a1-6) GlcNAcOH |
| 554 | N-tetraS4 | Cytosol | NeuAc a2-3 Gal b1-4 GlcNAc b1-2(NeuAc a2-3 Gal b1-4 GlcNAc b1-4) Man a1- |
| | | | 3(NeuAc a2-3 Gal b1-4 GlcNAc b1-2(NeuAc a2-3 Gal b1-4 GlcNAc b1-6) Man a1- |
| | | | 6) Man b1-4 GlcNAc b1-4(Fuc a1-6) GlcNAcOH |
| 555 | N-tetraS4 | Extra-organism | NeuAc a2-3 Gal b1-4 GlcNAc b1-2(NeuAc a2-3 Gal b1-4 GlcNAc b1-4) Man a1- |
| | | | 3(NeuAc a2-3 Gal b1-4 GlcNAc b1-2(NeuAc a2-3 Gal b1-4 GlcNAc b1-6) Man a1- |
| | | | 6) Man b1-4 GlcNAc b1-4(Fuc a1-6) GlcNAcOH |
| 556 | N-tetraS4 | Golgi Apparatus | NeuAc a2-3 Gal b1-4 GlcNAc b1-2(NeuAc a2-3 Gal b1-4 GlcNAc b1-4) Man a1- |
| | | | 3(NeuAc a2-3 Gal b1-4 GlcNAc b1-2(NeuAc a2-3 Gal b1-4 GlcNAc b1-6) Man a1- |
| | | | 6) Man b1-4 GlcNAc b1-4(Fuc a1-6) GlcNAcOH |
| 557 | N-tri | Cytosol | Gal b1-4 GlcNAc b1-2 (Gal b1-4 GlcNAc b1-4) Man a1-3(Gal b1-4 GlcNAc b1- |
| | | | 2 Man a1-6) Man b1-4 GlcNAc b1-4(Fuc a1-6) GlcNAcOH |
| 558 | N-tri | Extra-organism | Gal b1-4 GlcNAc b1-2 (Gal b1-4 GlcNAc b1-4) Man a1-3(Gal b1-4 GlcNAc b1- |
| | | | 2 Man a1-6) Man b1-4 GlcNAc b1-4(Fuc a1-6) GlcNAcOH |
| 559 | N-tri | Golgi Apparatus | Gal b1-4 GlcNAc b1-2 (Gal b1-4 GlcNAc b1-4) Man a1-3(Gal b1-4 GlcNAc b1- |
| | | | 2 Man a1-6) Man b1-4 GlcNAc b1-4(Fuc a1-6) GlcNAcOH |
| 560 | N-triS1 | Cytosol | Gal b1-4 GlcNAc b1-2 (Gal b1-4 GlcNAc b1-4) Man a1-3(NeuAc a2-3 Gal b1-4 |
| | | | GlcNAc b1-2 Man a1-6) Man b1-4 GlcNAc b1-4(Fuc a1-6) GlcNAcOH |
| 561 | N-triS1 | Extra-organism | Gal b1-4 GlcNAc b1-2 (Gal b1-4 GlcNAc b1-4) Man a1-3(NeuAc a2-3 Gal b1-4 |
| | | | GlcNAc b1-2 Man a1-6) Man b1-4 GlcNAc b1-4(Fuc a1-6) GlcNAcOH |
| 562 | N-triS1 | Golgi Apparatus | Gal b1-4 GlcNAc b1-2 (Gal b1-4 GlcNAc b1-4) Man a1-3(NeuAc a2-3 Gal b1-4 |
| | | | GlcNAc b1-2 Man a1-6) Man b1-4 GlcNAc b1-4(Fuc a1-6) GlcNAcOH |
| 563 | N-triS2 | Cytosol | Gal b1-4 GlcNAc b1-2 (NeuAc a2-3 Gal b1-4 GlcNAc b1-4) Man a1-3(NeuAc a2-3 |
| | | | Gal b1-4 GlcNAc b1-2 Man a1-6) Man b1-4 GlcNAc b1-4(Fuc a1-6) GlcNAcOH |
| 564 | N-triS2 | Extra-organism | Gal b1-4 GlcNAc b1-2 (NeuAc a2-3 Gal b1-4 GlcNAc b1-4) Man a1-3(NeuAc a2-3 |
| | | | Gal b1-4 GlcNAc b1-2 Man a1-6) Man b1-4 GlcNAc b1-4(Fuc a1-6) GlcNAcOH |
| 565 | N-triS2 | Golgi Apparatus | Gal b1-4 GlcNAc b1-2 (NeuAc a2-3 Gal b1-4 GlcNAc b1-4) Man a1-3(NeuAc a2-3 |
| | | | Gal b1-4 GlcNAc b1-2 Man a1-6) Man b1-4 GlcNAc b1-4(Fuc a1-6) GlcNAcOH |
| 566 | n2m2m | Golgi Apparatus | ((N-acetyl-D-glucosaminyl)2-(alpha-D-mannosyl)2-beta-D-mannosyl-diacetylchitobiose |
| 567 | n2m2mf | Golgi Apparatus | GlcNAc b1-2 Man a1-3(GlcNAc b1-2 Man a1-6) Man b1-4 GlcNAc b1-4(Fuc a1- |
| | | | 6) GlcNAcOH |
| 568 | n3m2m | Golgi Apparatus | ((N-acetyl-D-glucosaminyl)3-(alpha-D-mannosyl)2-beta-D-mannosyl-diacetylchitobiose |
| 569 | n3m2mf | Golgi Apparatus | GlcNAc b1-2 (GlcNAc b1-4) Man a1-3(GlcNAc b1-2 Man a1-6) Man b1-4 GlcNAc b1 |
| | | | 4(Fuc a1-6) GlcNAcOH |
| 570 | n4m2m | Golgi Apparatus | ((N-acetyl-D-glucosaminyl)4-(alpha-D-mannosyl)2-beta-D-mannosyl-diacetylchitobiose |
| 571 | n4m2mf | Golgi Apparatus | GlcNAc b1-2(GlcNAc b1-4) Man a1-3(GlcNAc b1-2(GlcNAc b1-6) Man a1- |
| | | | 6) Man b1-4 GlcNAc b1-4(Fuc a1-6) GlcNAcOH |
| 572 | na1 | Cytosol | Sodium |
| 573 | na1 | Extra-organism | Sodium |
| 574 | nad | Cytosol | Nicotinamide adenine dinucleotide |
| 575 | nad | Endoplasmic | Nicotinamide adenine dinucleotide |
| | | Reticulum | |
| 576 | nad | Mitochondria | Nicotinamide adenine dinucleotide |
| 577 | nadh | Cytosol | Nicotinamide adenine dinucleotide - reduced |
| 578 | nadh | Endoplasmic | Nicotinamide adenine dinucleotide - reduced |
| | | Reticulum | |
| 579 | nadh | Mitochondria | Nicotinamide adenine dinucleotide - reduced |
| 580 | nadp | Cytosol | Nicotinamide adenine dinucleotide phosphate |
| 581 | nadp | Endoplasmic | Nicotinamide adenine dinucleotide phosphate |
| | | Reticulum | |
| 582 | nadp | Mitochondria | Nicotinamide adenine dinucleotide phosphate |
| 583 | nadph | Cytosol | Nicotinamide adenine dinucleotide phosphate - reduced |
| 584 | nadph | Endoplasmic | Nicotinamide adenine dinucleotide phosphate - reduced |
| | | Reticulum | |
| 585 | nadph | Mitochondria | Nicotinamide adenine dinucleotide phosphate - reduced |
| 586 | naglc2p | Cytosol | N-Acetyl-D-glucosaminyldiphosphodolichol (mammals) |
| 587 | nh4 | Cytosol | Ammonium |
| 588 | nh4 | Extra-organism | Ammonium |
| 589 | nh4 | Mitochondria | Ammonium |
| 590 | nm2m | Golgi Apparatus | (N-acetyl-D-glucosaminyl-(alpha-D-mannosyl)2-beta-D-mannosyl-diacetylchitobiose |
| 591 | nm4m | Golgi Apparatus | (alpha-D-mannosyl)4-beta-D-mannosyl-diacetylchitobiose |
| 592 | nncoa | Mitochondria | nonanoyl-CoA (C9:0CoA) |
| 593 | nrvnc | Cytosol | nervonic acid |
| 594 | nrvnc | Extra-organism | nervonic acid |
| 595 | nrvnccoa | Cytosol | nervonyl coenzyme A |
| 596 | nrvnccoa | Mitochondria | nervonyl coenzyme A |
| 597 | nrvnccrn | Cytosol | Nervonyl carnitine |
| 598 | nrvnccrn | Mitochondria | Nervonyl carnitine |
| 599 | o2 | Cytosol | O2 |
| 600 | o2 | Endoplasmic | O2 |
| | | Reticulum | |
| 601 | o2 | Extra-organism | O2 |
| 602 | o2 | Mitochondria | O2 |
| 603 | o2 | Peroxisome | O2 |
| 604 | o2− | Cytosol | Superoxide |
| 605 | o2− | Mitochondria | Superoxide |
| 606 | o2− | Peroxisome | Superoxide |
| 607 | oaa | Cytosol | Oxaloacetate |
| 608 | oaa | Mitochondria | Oxaloacetate |
| 609 | occoa | Mitochondria | Octanoyl-CoA (C8:0CoA) |
| 610 | ocdca | Cytosol | octadecanoate (n-C18:0) |
| 611 | ocdca | Extra-organism | octadecanoate (n-C18:0) |
| 612 | ocdcea | Cytosol | octadecenoate (n-C18:1) |
| 613 | ocdcea | Extra-organism | octadecenoate (n-C18:1) |
| 614 | ocdcea9 | Cytosol | octadecenoate (C18:1, n-9) |
| 615 | ocdctra3 | Cytosol | octadecatrienoate (C18:3, n-3) |
| 616 | ocdctra6 | Cytosol | octadecatrienoate (C18:3, n-6) |
| 617 | ocdcya | Cytosol | octadecdienoate (n-C18:2) |
| 618 | ocdcya | Extra-organism | octadecdienoate (n-C18:2) |
| 619 | ocddea6 | Cytosol | octadecadienoate (C18:2, n-6) |
| 620 | ocdycacoa | Cytosol | octadecadienoyl-CoA (n-C18:2CoA) |
| 621 | ocdycacoa | Mitochondria | octadecadienoyl-CoA (n-C18:2CoA) |
| 622 | ocdycacoa6 | Cytosol | octadecadienoyl-CoA (C18:2CoA, n-6) |
| 623 | ocdycacoa6 | Mitochondria | octadecadienoyl-CoA (C18:2CoA, n-6) |
| 624 | ocdycacrn | Cytosol | octadecadienoyl carnitine (C18:2Crn) |
| 625 | ocdycacrn | Mitochondria | octadecadienoyl carnitine (C18:2Crn) |
| 626 | ocsttea6 | Cytosol | ocosatetraenoate (C22:4, n-6) |
| 627 | octa | Cytosol | octanoate |
| 628 | odcoa3 | Cytosol | octadecatrienoyl-CoA (C18:3CoA, n-3) |
| 629 | odcoa3 | Mitochondria | octadecatrienoyl-CoA (C18:3CoA, n-3) |
| 630 | odcoa6 | Cytosol | octadecatrienoyl-CoA (C18:3CoA, n-6) |
| 631 | odcoa6 | Mitochondria | octadecatrienoyl-CoA (C18:3CoA, n-6) |
| 632 | odecoa | Cytosol | Octadecenoyl-CoA (n-C18:1CoA) |
| 633 | odecoa | Mitochondria | Octadecenoyl-CoA (n-C18:1CoA) |
| 634 | odecoa9 | Cytosol | octadecenoyl-CoA (C18:1CoA, n-9) |
| 635 | odecoa9 | Mitochondria | octadecenoyl-CoA (C18:1CoA, n-9) |
| 636 | odecrn | Cytosol | octadecenoyl carnitine |
| 637 | odecrn | Mitochondria | octadecenoyl carnitine |
| 638 | orn-L | Cytosol | L-Ornithine |
| 639 | orn-L | Extra-organism | L-Ornithine |
| 640 | orn-L | Mitochondria | L-Ornithine |
| 641 | orot | Cytosol | Orotate |
| 642 | orot5p | Cytosol | Orotidine 5′-phosphate |
| 643 | osttcoa6 | Cytosol | ocosatetraenoyl-CoA (C22:4CoA, n-6) |
| 644 | osttcoa6 | Mitochondria | ocosatetraenoyl-CoA (C22:4CoA, n-6) |
| 645 | pa_CHO | Cytosol | Phosphatidate, CHO specific |
| 646 | pa_CHO | Mitochondria | Phosphatidate, CHO specific |
| 647 | pan4p | Cytosol | Pantetheine 4′-phosphate |
| 648 | pc_CHO | Cytosol | phosphatidylcholine, CHO specific |
| 649 | pdcoa | Cytosol | pentadecanoyl-CoA (C15:0CoA) |
| 650 | pdcoa | Mitochondria | pentadecanoyl-CoA (C15:0CoA) |
| 651 | pe_CHO | Cytosol | phosphatidylethanolamine, CHO specific |
| 652 | pep | Cytosol | Phosphoenolpyruvate |
| 653 | pep | Mitochondria | Phosphoenolpyruvate |
| 654 | pg_CHO | Mitochondria | phosphatidylglycerol, CHO specific |
| 655 | pgp_CHO | Mitochondria | Phosphatidylglycerophosphate, CHO specific |
| 656 | phe-L | Cytosol | L-Phenylalanine |
| 657 | phe-L | Extra-organism | L-Phenylalanine |
| 658 | pheme | Cytosol | Protoheme |
| 659 | pheme | Extra-organism | Protoheme |
| 660 | pheme | Mitochondria | Protoheme |
| 661 | phpyr | Cytosol | Phenylpyruvate |
| 662 | pi | Cytosol | Phosphate |
| 663 | pi | Endoplasmic | Phosphate |
| | | Reticulum | |
| 664 | pi | Extra-organism | Phosphate |
| 665 | pi | Golgi Apparatus | Phosphate |
| 666 | pi | Mitochondria | Phosphate |
| 667 | pi | Peroxisome | Phosphate |
| 668 | pino_CHO | Cytosol | phosphatidyl-1D-myo-inositol, CHO specific |
| 669 | pmtcoa | Cytosol | Palmitoyl-CoA (n-C16:0CoA) |
| 670 | pmtcoa | Mitochondria | Palmitoyl-CoA (n-C16:0CoA) |
| 671 | pmtcrn | Cytosol | L-Palmitoylcarnitine (C16:0Crn) |
| 672 | pmtcrn | Mitochondria | L-Palmitoylcarnitine (C16:0Crn) |
| 673 | pnto-R | Cytosol | (R)-Pantothenate |
| 674 | pnto-R | Extra-organism | (R)-Pantothenate |
| 675 | ppa | Cytosol | Propionate |
| 676 | ppbng | Cytosol | Porphobilinogen |
| 677 | ppcoa | Cytosol | Propanoyl-CoA (C3:0CoA) |
| 678 | ppcoa | Mitochondria | Propanoyl-CoA (C3:0CoA) |
| 679 | ppcoa | Peroxisome | Propanoyl-CoA (C3:0CoA) |
| 680 | ppi | Cytosol | Diphosphate |
| 681 | ppi | Endoplasmic | Diphosphate |
| | | Reticulum | |
| 682 | ppi | Mitochondria | Diphosphate |
| 683 | ppi | Peroxisome | Diphosphate |
| 684 | ppp9 | Cytosol | Protoporphyrin |
| 685 | ppp9 | Mitochondria | Protoporphyrin |
| 686 | pppg9 | Cytosol | Protoporphyrinogen IX |
| 687 | pppi | Cytosol | Inorganic triphosphate |
| 688 | pram | Cytosol | 5-Phospho-beta-D-ribosylamine |
| 689 | pro-L | Cytosol | L-Proline |
| 690 | pro-L | Extra-organism | L-Proline |
| 691 | pro-L | Mitochondria | L-Proline |
| 692 | prpp | Cytosol | 5-Phospho-alpha-D-ribose 1-diphosphate |
| 693 | ps_CHO | Cytosol | Phosphatidylserine, CHO specific |
| 694 | pser-L | Cytosol | O-Phospho-L-serine |
| 695 | ptcoa | Mitochondria | Pentanoyl-CoA (C5:0CoA) |
| 696 | ptdca | Cytosol | pentadecanoate (C15:0) |
| 697 | ptrc | Cytosol | Putrescine |
| 698 | ptrc | Extra-organism | Putrescine |
| 699 | ptrc | Mitochondria | Putrescine |
| 700 | pyr | Cytosol | Pyruvate |
| 701 | pyr | Extra-organism | Pyruvate |
| 702 | pyr | Mitochondria | Pyruvate |
| 703 | q10h2 | Mitochondria | Ubiquinol-10 |
| 704 | r1p | Cytosol | alpha-D-Ribose 1-phosphate |
| 705 | r5p | Cytosol | alpha-D-Ribose 5-phosphate |
| 706 | ru5p-D | Cytosol | D-Ribulose 5-phosphate |
| 707 | s7p | Cytosol | Sedoheptulose 7-phosphate |
| 708 | sarcs | Cytosol | Sarcosine |
| 709 | sarcs | Peroxisome | Sarcosine |
| 710 | ser-L | Cytosol | L-Serine |
| 711 | ser-L | Extra-organism | L-Serine |
| 712 | ser-L | Mitochondria | L-Serine |
| 713 | so3 | Cytosol | Sulfite |
| 714 | so3 | Extra-organism | Sulfite |
| 715 | sphgmy_CHO | Cytosol | Sphingomyeline, CHO specific |
| 716 | sphgn | Cytosol | Sphinganine |
| 717 | spmd | Cytosol | Spermidine |
| 718 | spmd | Extra-organism | Spermidine |
| 719 | sprm | Cytosol | Spermine |
| 720 | spyr | Cytosol | 3-Sulfinylpyruvate |
| 721 | spyr | Mitochondria | 3-Sulfinylpyruvate |
| 722 | sql | Endoplasmic | Squalene |
| | | Reticulum | |
| 723 | Ssq23epx | Endoplasmic | (S)-Squalene-2,3-epoxide |
| | | Reticulum | |
| 724 | strcoa | Cytosol | Stearyl-CoA (n-C18:0CoA) |
| 725 | strcoa | Mitochondria | Stearyl-CoA (n-C18:0CoA) |
| 726 | strcrn | Cytosol | Stearoylcarnitine (C18:0Crn) |
| 727 | strcrn | Mitochondria | Stearoylcarnitine (C18:0Crn) |
| 728 | strdnccoa | Cytosol | stearidonyl coenzyme A (C18:4CoA) |
| 729 | succ | Mitochondria | Succinate |
| 730 | succoa | Mitochondria | Succinyl-CoA |
| 731 | sucsal | Mitochondria | Succinic semialdehyde |
| 732 | tcggrpp | Cytosol | trans,trans,cis-Geranylgeranyl pyrophosphate |
| 733 | tdcoa | Cytosol | Tetradecanoyl-CoA (n-C14:0CoA) |
| 734 | tdcoa | Mitochondria | Tetradecanoyl-CoA (n-C14:0CoA) |
| 735 | tdcrn | Cytosol | tetradecanoylcarnitine (C14:0Crn) |
| 736 | tdcrn | Mitochondria | tetradecanoylcarnitine (C14:0Crn) |
| 737 | tdecoa7 | Cytosol | tetradecenoyl-CoA (C14:1CoA, n-7) |
| 738 | tdecoa7 | Mitochondria | tetradecenoyl-CoA (C14:1CoA, n-7) |
| 739 | thbpt | Cytosol | Tetrahydrobiopterin |
| 740 | thcholstoic | Peroxisome | 3alpha,7alpha,12alpha-Trihydroxy-5beta-cholestanoate |
| 741 | thf | Cytosol | 5,6,7,8-Tetrahydrofolate |
| 742 | thf | Mitochondria | 5,6,7,8-Tetrahydrofolate |
| 743 | thr-L | Cytosol | L-Threonine |
| 744 | thr-L | Extra-organism | L-Threonine |
| 745 | thr-L | Mitochondria | L-Threonine |
| 746 | thymd | Cytosol | Thymidine |
| 747 | thymd | Extra-organism | Thymidine |
| 748 | trdcoa | Mitochondria | tridecanoyl-CoA (C13:0CoA) |
| 749 | trdox | Cytosol | Oxidized thioredoxin |
| 750 | trdrd | Cytosol | Reduced thioredoxin |
| 751 | triglyc_CHO | Cytosol | Triglyceride, CHO specific |
| 752 | trp-L | Cytosol | L-Tryptophan |
| 753 | trp-L | Extra-organism | L-Tryptophan |
| 754 | tsul | Cytosol | Thiosulfate |
| 755 | ttc | Cytosol | tetracosanoate (n-C24:0) |
| 756 | ttc | Extra-organism | tetracosanoate (n-C24:0) |
| 757 | ttdca | Cytosol | tetradecanoate (C14:0) |
| 758 | ttdca | Extra-organism | tetradecanoate (C14:0) |
| 759 | ttdcea7 | Cytosol | tetradecenoate (C14:1, n-7) |
| 760 | tyr-L | Cytosol | L-Tyrosine |
| 761 | tyr-L | Extra-organism | L-Tyrosine |
| 762 | tyr-L | Mitochondria | L-Tyrosine |
| 763 | uacgam | Cytosol | UDP-N-acetyl-D-glucosamine |
| 764 | uacgam | Golgi Apparatus | UDP-N-acetyl-D-glucosamine |
| 765 | ubq10 | Mitochondria | Ubiquinone-10 |
| 766 | udp | Cytosol | UDP |
| 767 | udp | Golgi Apparatus | UDP |
| 768 | udpg | Cytosol | UDPglucose |
| 769 | udpgal | Cytosol | UDPgalactose |
| 770 | udpgal | Golgi Apparatus | UDPgalactose |
| 771 | ump | Cytosol | UMP |
| 772 | ump | Golgi Apparatus | UMP |
| 773 | uppg3 | Cytosol | Uroporphyrinogen III |
| 774 | urcan | Cytosol | Urocanate |
| 775 | urea | Cytosol | Urea |
| 776 | urea | Extra-organism | Urea |
| 777 | urea | Mitochondria | Urea |
| 778 | uri | Cytosol | Uridine |
| 779 | utp | Cytosol | UTP |
| 780 | val-L | Cytosol | L-Valine |
| 781 | val-L | Extra-organism | L-Valine |
| 782 | val-L | Mitochondria | L-Valine |
| 783 | xmp | Cytosol | Xanthosine 5′-phosphate |
| 784 | xol7a | Endoplasmic | 7 alpha-Hydroxycholesterol |
| | | Reticulum | |
| 785 | xol7aone | Endoplasmic | 7alpha-Hydroxycholest-4-en-3-one |
| | | Reticulum | |
| 786 | xu5p-D | Cytosol | D-Xylulose 5-phosphate |
| 787 | zym_int2 | Endoplasmic | zymosterone |
| | | Reticulum | |
| 788 | zymst | Endoplasmic | Zymosterol |
| | | Reticulum | |
| 789 | zymstnl | Endoplasmic | Zymostenol |
| | | Reticulum | |

TABLE 8

| | Gene | | Reaction |
|---|---|---|---|
| No. | Description | Reaction | name |
| 1281 | Gal b1-4 GlcNAc b1-2 Man a1-3(Gal b1-4 GlcNAc b1-2 Man a1-6) Man b1- | [e]: N-bi <==> | EX_N-bi(e) |
| | 4 GlcNAc b1-4(Fuc a1-6) GlcNAcOH exchange | | |
| 1282 | Gal b1-4 GlcNAc b1-2 Man a1-3(NeuAc a2-3 Gal b1-4 GlcNAc b1-2 Man a1- | [e]: N-biS1 <==> | EX_N-biS1(e) |
| | 6) Man b1-4 GlcNAc b1-4(Fuc a1-6) GlcNAcOH exchange | | |
| 1283 | Gal b1-4 GlcNAc b1-2(Gal b1-4 GlcNAc b1-4) Man a1-3(Gal b1-4 GlcNAc b1- | [e]: N-tetra/N-triLac1 <==> | EX_N-tetra/N-triLac1(e) |
| | 2(Gal b1-4 GlcNAc b1-6) Man a1-6) Man b1-4 GlcNAc b1-4(Fuc a1- | | |
| | 6) GlcNAcOH exchange | | |
| 1284 | Gal b1-4 GlcNAc b1-2(Gal b1-4 GlcNAc b1-4) Man a1-3(Gal b1-4 GlcNAc b1- | [e]: N-tetraLac1 <==> | EX_N-tetraLac1(e) |
| | 2(Gal b1-4 GlcNAc b1-3 Gal b1-4 GlcNAc b1-6) Man a1-6) Man b1- | | |
| | 4 GlcNAc b1-4(Fuc a1-6) GlcNAcOH exchange | | |
| 1285 | Gal b1-4 GlcNAc b1-2(Gal b1-4 GlcNAc b1-4) Man a1-3(Gal b1-4 GlcNAc b1- | [e]: N-tetraLac1S1 <==> | EX_N-tetraLac1S1(e) |
| | 2(NeuAc a2-3 Gal b1-4 GlcNAc b1-3 Gal b1-4 GlcNAc b1-6) Man a1-6) Man b1- | | |
| | 4 GlcNAc b1-4(Fuc a1-6) GlcNAcOH exchange | | |
| 1286 | Gal b1-4 GlcNAc b1-2(Gal b1-4 GlcNAc b1-4) Man a1-3(NeuAc a2-3 Gal b1-4 | [e]: N-tetraLac1S2 <==> | EX_N-tetraLac1S2(e) |
| | GlcNAc b1-2(NeuAc a2-3 Gal b1-4 GlcNAc b1-3 Gal b1-4 GlcNAc b1- | | |
| | 6) Man a1-6) Man b1-4 GlcNAc b1-4(Fuc a1-6) GlcNAcOH exchange | | |
| 1287 | Galb1-4GlcNAcb1-2(NeuAca2-3Galb1-4GlcNAcb1-4)Mana1-3(NeuAca2-3Galb1- | [e]: N-tetraLac1S3 <==> | EX_N-tetraLac1S3(e) |
| | 4 GlcNAc b1-2(NeuAca2-3Galb1-4GlcNAcb1-3Galb1-4GlcNAcb1-6)Mana1- | | |
| | 6)Manb1-4GlcNAcb1-4(Fuc a1-6)GlcNAcOH exchange | | |
| 1288 | NeuAca2-3Galb1-4GlcNAcb1-2(NeuAca2-3Galb1-4GlcNAcb1-4)Mana1- | [e]: N-tetraLac1S4 <==> | EX_N-tetraLac1S4(e) |
| | 3(NeuAca2-3Galb1-4 GlcNAc b1-2(NeuAca2-3Galb1-4GlcNAcb1-3Galb1- | | |
| | 4GlcNAcb1-6)Mana1-6)Manb1-4GlcNAcb1-4(Fuc a1-6)GlcNAcOH exchange | | |
| 1289 | Galb1-4GlcNAcb1-2(Galb1-4GlcNAcb1-4)Mana1-3(Galb1-4GlcNAcb1-3Galb1- | [e]: N-tetraLac2 <==> | EX_N-tetraLac2(e) |
| | 4GlcNAcb1-2(Galb1-4GlcNAcb1-3Galb1-4GlcNAcb1-6)Mana1-6)Manb1- | | |
| | 4GlcNAcb1-4(Fuca1-6)GlcNAcOH exchange | | |
| 1290 | Galb1-4GlcNAcb1-2(Galb1-4GlcNAcb1-4)Mana1-3(Galb1-4GlcNAcb1-3Galb1- | [e]: N-tetraLac2S1 <==> | EX_N-tetraLac2S1(e) |
| | 4GlcNAcb1-2(NeuAca2-3Galb1-4GlcNAcb1-3Galb1-4GlcNAcb1-6)Mana1- | | |
| | 6)Manb1-4GlcNAcb1-4(Fuca1-6)GlcNAcOH exchange | | |
| 1291 | Galb1-4GlcNAcb1-2(Galb1-4GlcNAcb1-4)Mana1-3(NeuAca2-3Galb1- | [e]: N-tetraLac2S2 <==> | EX_N-tetraLac2S2(e) |
| | 4GlcNAcb1-3Galb1-4GlcNAcb1-2(NeuAca2-3Galb1-4GlcNAcb1-3Galb1- | | |
| | 4GlcNAcb1-6)Mana1-6)Manb1-4GlcNAcb1-4(Fuca1-6)GlcNAcOH exchange | | |
| 1292 | Galb1-4GlcNAcb1-2(NeuAca2-3Galb1-4GlcNAcb1-4)Mana1-3(NeuAca2-3Galb1- | [e]: N-tetraLac2S3 <==> | EX_N-tetraLac2S3(e) |
| | 4GlcNAcb1-3Galb1-4GlcNAcb1-2(NeuAca2-3Galb1-4GlcNAcb1-3Galb1- | | |
| | 4GlcNAcb1-6)Mana1-6)Manb1-4GlcNAcb1-4(Fuca1-6)GlcNAcOH exchange | | |
| 1293 | NeuAca2-3Galb1-4GlcNAcb1-2(NeuAca2-3Galb1-4GlcNAcb1-4)Mana1- | [e]: N-tetraLac2S4 <==> | EX_N-tetraLac2S4(e) |
| | 3(NeuAca2-3Galb1-4GlcNAcb1-3Galb1-4GlcNAcb1-2(NeuAca2-3Galb1- | | |
| | 4GlcNAcb1-3Galb1-4GlcNAcb1-6)Mana1-6)Manb1-4GlcNAcb1-4(Fuca1- | | |
| | 6)GlcNAcOH exchange | | |
| 1294 | Galb1-4GlcNAcb1-2(Galb1-4GlcNAcb1-3Galb1-4GlcNAcb1-4)Mana1-3(Galb1- | [e]: N-tetraLac3 <==> | EX_N-tetraLac3(e) |
| | 4GlcNAcb1-3Galb1-4GlcNAcb1-2(Galb1-4GlcNAcb1-3Galb1-4GlcNAcb1- | | |
| | 6)Mana1-6)Manb1-4GlcNAcb1-4(Fuca1-6)GlcNAcOH exchange | | |
| 1295 | Galb1-4GlcNAcb1-2(Galb1-4GlcNAcb1-3Galb1-4GlcNAcb1-4)Mana1-3(Galb1- | [e]: N-tetraLac3S1 <==> | EX_N-tetraLac3S1(e) |
| | 4GlcNAcb1-3Galb1-4GlcNAcb1-2(NeuAca2-3Galb1-4GlcNAcb1-3Galb1- | | |
| | 4GlcNAcb1-6)Mana1-6)Manb1-4GlcNAcb1-4(Fuca1-6)GlcNAcOH exchange | | |
| 1296 | Galb1-4GlcNAcb1-2(Galb1-4GlcNAcb1-3Galb1-4GlcNAcb1-4)Mana1- | [e]: N-tetraLac3S2 <==> | EX_N-tetraLac3S2(e) |
| | 3(NeuAca2-3Galb1-4GlcNAcb1-3Galb1-4GlcNAcb1-2(NeuAca2-3Galb1- | | |
| | 4GlcNAcb1-3Galb1-4GlcNAcb1-6)Mana1-6)Manb1-4GlcNAcb1-4(Fuca1- | | |
| | 6)GlcNAcOH exchange | | |
| 1297 | Galb1-4GlcNAcb1-2(NeuAca2-3Galb1-4GlcNAcb1-3Galb1-4GlcNAcb1- | [e]: N-tetraLac3S3 <==> | EX_N-tetraLac3S3(e) |
| | 4)Mana1-3(NeuAca2-3Galb1-4GlcNAcb1-3Galb1-4GlcNAcb1-2(NeuAca2- | | |
| | 3Galb1-4GlcNAcb1-3Galb1-4GlcNAcb1-6)Mana1-6)Manb1-4GlcNAcb1- | | |
| | 4(Fuca1-6)GlcNAcOH exchange | | |
| 1298 | Gal b1-4 GlcNAc b1-2(Gal b1-4 GlcNAc b1-4) Man a1-3(NeuAc a2-3 Gal b1- | [e]: N-tetraS1/N-triLac1S1 | EX_N-tetraS1/N-triLac1S1(e) |
| | 4 GlcNAc b1-2(Gal b1-4 GlcNAc b1-6) Man a1-6) Man b1-4 GlcNAc b1- | <==> | |
| | 4(Fuc a1-6) GlcNAcOH exchange | | |
| 1299 | Gal b1-4 GlcNAc b1-2(Gal b1-4 GlcNAc b1-4) Man a1-3(NeuAc a2-3 Gal b1- | [e]: N-tetraS2/N-triLac1S2 | EX_N-tetraS2/N-triLac1S2(e) |
| | 4 GlcNAc b1-2(NeuAc a2-3 Gal b1-4 GlcNAc b1-6) Man a1-6) Man b1- | <==> | |
| | 4 GlcNAc b1-4(Fuc a1-6) GlcNAcOH exchange | | |
| 1300 | Gal b1-4 GlcNAc b1-2(NeuAc a2-3 Gal b1-4 GlcNAc b1-4) Man a1-3(NeuAc a2- | [e]: N-tetraS3 <==> | EX_N-tetraS3(e) |
| | 3 Gal b1-4 GlcNAc b1-2(NeuAc a2-3 Gal b1-4 GlcNAc b1-6) Man a1-6) Man b1- | | |
| | 4 GlcNAc b1-4(Fuc a1-6) GlcNAcOH exchange | | |
| 1301 | NeuAc a2-3 Gal b1-4 GlcNAc b1-2(NeuAc a2-3 Gal b1-4 GlcNAc b1-4) Man a1- | [e]: N-tetraS4 <==> | EX_N-tetraS4(e) |
| | 3(NeuAc a2-3 Gal b1-4 GlcNAc b1-2(NeuAc a2-3 Gal b1-4 GlcNAc b1- | | |
| | 6) Man a1-6) Man b1-4 GlcNAc b1-4(Fuc a1-6) GlcNAcOH exchange | | |
| 1302 | Gal b1-4 GlcNAc b1-2 (Gal b1-4 GlcNAc b1-4) Man a1-3(Gal b1-4 GlcNAc b1- | [e]: N-tri <==> | EX_N-tri(e) |
| | 2 Man a1-6) Man b1-4 GlcNAc b1-4(Fuc a1-6) GlcNAcOH exchange | | |
| 1303 | Gal b1-4 GlcNAc b1-2 (Gal b1-4 GlcNAc b1-4) Man a1-3(NeuAc a2-3 Gal b1-4 | [e]: N-triS1 <==> | EX_N-triS1(e) |
| | GlcNAc b1-2 Man a1-6) Man b1-4 GlcNAc b1-4(Fuc a1-6) GlcNAcOH exchange | | |
| 1304 | Gal b1-4 GlcNAc b1-2 (NeuAc a2-3 Gal b1-4 GlcNAc b1-4) Man a1-3(NeuAc a2- | [e]: N-triS2 <==> | EX_N-triS2(e) |
| | 3 Gal b1-4 GlcNAc b1-2 Man a1-6) Man b1-4 GlcNAc b1-4(Fuc a1- | | |
| | 6) GlcNAcOH exchange | | |
| 1305 | Adenine exchange | [e]: ade <==> | EX_ade(e) |
| 1306 | L-Alanine exchange | [e]: ala-L <==> | EX_ala-L(e) |
| 1307 | Arachidonic acid (C20:4) exchange | [e]: arachda <==> | EX_arachda(e) |
| 1308 | L-Arginine exchange | [e]: arg-L <==> | EX_arg-L(e) |
| 1309 | L-Asparagine exchange | [e]: asn-L <==> | EX_asn-L(e) |
| 1310 | L-Aspartate exchange | [e]: asp-L <==> | EX_asp-L(e) |
| 1311 | Choline exchange | [e]: chol <==> | EX_chol(e) |
| 1312 | Citrate exchange | [e]: cit <==> | EX_cit(e) |
| 1313 | CO2 exchange | [e]: co2 <==> | EX_co2(e) |
| 1314 | L-Cysteine exchange | [e]: cys-L <==> | EX_cys-L(e) |
| 1315 | docosahexaenoate (C22:6) exchange | [e]: dcshea <==> | EX_dcshea(e) |
| 1316 | docosapentaenoic acid (C22:5) exchange | [e]: dcspea <==> | EX_dcspea(e) |
| 1317 | Eicosanoate (n-C20:0) exchange | [e]: ecsa <==> | EX_ecsa(e) |
| 1318 | Eicosapentaenoic acid (C20:5) exchange | [e]: ecspea <==> | EX_ecspea(e) |
| 1319 | eicosatrienoate exchange | [e]: ecstea <==> | EX_ecstea(e) |
| 1320 | Ethanolamine exchange | [e]: etha <==> | EX_etha(e) |
| 1321 | Fe2+ exchange | [e]: fe2 <==> | EX_fe2(e) |
| 1322 | Folate exchange | [e]: fol <==> | EX_fol(e) |
| 1323 | Formate exchange | [e]: for <==> | EX_for(e) |
| 1324 | D-Glucose exchange | [e]: glc-D <==> | EX_glc(e) |
| 1325 | L-Glutamine exchange | [e]: gln-L <==> | EX_gln-L(e) |
| 1326 | L-Glutamate exchange | [e]: glu-L <==> | EX_glu-L(e) |
| 1327 | Glycine exchange | [e]: gly <==> | EX_gly(e) |
| 1328 | H+ exchange | [e]: h <==> | EX_h(e) |
| 1329 | H2O exchange | [e]: h2o <==> | EX_h2o(e) |
| 1330 | Fatty acid (Palmitate, n-C16:0) exchange | [e]: hdca <==> | EX_hdca(e) |
| 1331 | hexadecenoate (n-C16:1) exchange | [e]: hdcea <==> | EX_hdcea(e) |
| 1332 | L-Histidine exchange | [e]: his-L <==> | EX_his-L(e) |
| 1333 | Hypoxanthine exchange | [e]: hxan <==> | EX_hxan(e) |
| 1334 | L-Isoleucine exchange | [e]: ile-L <==> | EX_ile-L(e) |
| 1335 | myo-Inositol exchange | [e]: inost <==> | EX_inost(e) |
| 1336 | Inosine exchange | [e]: ins <==> | EX_ins(e) |
| 1337 | L-Lactate exchange | [e]: lac-L <==> | EX_lac-L(e) |
| 1338 | L-Leucine exchange | [e]: leu-L <==> | EX_leu-L(e) |
| 1339 | Linolenic acid (C18:3) exchange | [e]: lnlne <==> | EX_lnlne(e) |
| 1340 | L-Lysine exchange | [e]: lys-L <==> | EX_lys-L(e) |
| 1341 | L-Methionine exchange | [e]: met-L <==> | EX_met-L(e) |
| 1342 | Sodium exchange | [e]: na1 <==> | EX_na1(e) |
| 1343 | Ammonium exchange | [e]: nh4 <==> | EX_nh4(e) |
| 1344 | nervonic acid exchange | [e]: nrvnc <==> | EX_nrvnc(e) |
| 1345 | O2 exchange | [e]: o2 <==> | EX_o2(e) |
| 1346 | Octadecanoate (stearate) exchange | [e]: ocdca <==> | EX_ocdca(e) |
| 1347 | octadecenoate (n-C18:1) exchange | [e]: ocdcea <==> | EX_ocdcea(e) |
| 1348 | octadecynoate (n-C18:2) exchange | [e]: ocdcya <==> | EX_ocdcya(e) |
| 1349 | L-Phenylalanine exchange | [e]: phe-L <==> | EX_phe-L(e) |
| 1350 | Protoheme exchange | [e]: pheme <==> | EX_pheme(e) |
| 1351 | Phosphate exchange | [e]: pi <==> | EX_pi(e) |
| 1352 | (R)-Pantothenate exchange | [e]: pnto-R <==> | EX_pnto-R(e) |
| 1353 | L-Proline exchange | [e]: pro-L <==> | EX_pro-L(e) |
| 1354 | Putrescine exchange | [e]: ptrc <==> | EX_ptrc(e) |
| 1355 | Pyruvate exchange | [e]: pyr <==> | EX_pyr(e) |
| 1356 | Exchange for Serine | [e]: ser-L <==> | EX_ser-L(e) |
| 1357 | Sulfite exchange | [e]: so3 <==> | EX_so3(e) |
| 1358 | Spermidine exchange | [e]: spmd <==> | EX_spmd(e) |
| 1359 | L-Threonine exchange | [e]: thr-L <==> | EX_thr-L(e) |
| 1360 | Thymidine exchange | [e]: thymd <==> | EX_thymd(e) |
| 1361 | L-Tryptophan exchange | [e]: trp-L <==> | EX_trp-L(e) |
| 1362 | tetracosanoate (n-C24:0) exchange | [e]: ttc <==> | EX_ttc(e) |
| 1363 | tetradecanoate (n-C14:0) exchange | [e]: ttdca <==> | EX_ttdca(e) |
| 1364 | L-Tyrosine exchange | [e]: tyr-L <==> | EX_tyr-L(e) |
| 1365 | Urea exchange | [e]: urea <==> | EX_urea(e) |
| 1366 | L-Valine exchange | [e]: val-L <==> | EX_val-L(e) |

TABLE 9

| No. | Metab Abbreviation | Compartment | Metabolite Name |
|---|---|---|---|
| 1 | 10fthf | Cytosol | 10-Formyltetrahydrofolate |
| 2 | 10fthf | Mitochondria | 10-Formyltetrahydrofolate |
| 3 | 10fthf5glu | Cytosol | 10-formyltetrahydrofolate-[Glu](5) |
| 4 | 10fthf5glu | Mitochondria | 10-formyltetrahydrofolate-[Glu](5) |
| 5 | 10fthf6glu | Cytosol | 10-formyltetrahydrofolate-[Glu](6) |
| 6 | 10fthf6glu | Mitochondria | 10-formyltetrahydrofolate-[Glu](6) |
| 7 | 10fthf7glu | Cytosol | 10-formyltetrahydrofolate-[Glu](7) |
| 8 | 10fthf7glu | Mitochondria | 10-formyltetrahydrofolate-[Glu](7) |
| 9 | 12dgr_CHO | Cytosol | 1,2-Diacylglycerol, CHO |
| 10 | 12ppd-R | Cytosol | (R)-Propane-1,2-diol |
| 11 | 12ppd-S | Cytosol | (S)-Propane-1,2-diol |
| 12 | 13dpg | Cytosol | 3-Phospho-D-glyceroyl phosphate |
| 13 | 17ahprgnlone | Cytosol | 17alpha-Hydroxypregnenolone |
| 14 | 17ahprgstrn | Cytosol | 17alpha-Hydroxyprogesterone |
| 15 | 1ag3p_CHO | Cytosol | 1-Acyl-sn-glycerol 3-phosphate, CHO |
| 16 | 1aglycpc_CHO | Cytosol | 1-Acyl-sn-glycero-3-phosphocholine, CHO specific |
| 17 | 1pyr5c | Cytosol | 1-Pyrroline-5-carboxylate |
| 18 | 1pyr5c | Mitochondria | 1-Pyrroline-5-carboxylate |
| 19 | 23dpg | Cytosol | 3-Phospho-D-glycerol phosphate |
| 20 | 25aics | Cytosol | (S)-2-[5-Amino-1-(5-phospho-D-ribosyl)imidazole-4- |
| | | | carboxamido]succinate |
| 21 | 2aacl | Cytosol | 2-Aminoacrylate |
| 22 | 2aadp | Mitochondria | L-2-Aminoadipate |
| 23 | 2aeppn | Cytosol | (2-Aminoethyl)phosphonate |
| 24 | 2amuc | Cytosol | 2-Aminomuconate |
| 25 | 2aobut | Mitochondria | L-2-Amino-3-oxobutanoate |
| 26 | 2dp6mep | Mitochondria | 2-Decaprenyl-6-methoxyphenol |
| 27 | 2dp6mobq | Mitochondria | 2-Decaprenyl-6-methoxy-1,4-benzoquinone |
| 28 | 2dp6mobq_me | Mitochondria | 2-Decaprenyl-3-methyl-6-methoxy-1,4-benzoquinone |
| 29 | 2dpmhobq | Mitochondria | 2-Decaprenyl-3-methyl-5-hydroxy-6-methoxy-1,4- |
| | | | benzoquinone |
| 30 | 2dr1p | Cytosol | 2-Deoxy-D-ribose 1-phosphate |
| 31 | 2hbut | Cytosol | 2-Hydroxybutyrate |
| 32 | 2maacoa | Mitochondria | 2-Methyl-3-acetoacetyl-CoA |
| 33 | 2mb2coa | Mitochondria | trans-2-Methylbut-2-enoyl-CoA |
| 34 | 2mbcoa | Mitochondria | 2-Methylbutanoyl-CoA |
| 35 | 2mop | Mitochondria | 2-Methyl-3-oxopropanoate |
| 36 | 2mp2coa | Mitochondria | 2-Methylprop-2-enoyl-CoA |
| 37 | 2obut | Cytosol | 2-Oxobutanoate |
| 38 | 2obut | Mitochondria | 2-Oxobutanoate |
| 39 | 2oxoadp | Cytosol | 2-Oxoadipate |
| 40 | 2oxoadp | Mitochondria | 2-Oxoadipate |
| 41 | 2pg | Cytosol | D-Glycerate 2-phosphate |
| 42 | 34hpp | Cytosol | 3-(4-Hydroxyphenyl)pyruvate |
| 43 | 34hpp | Mitochondria | 3-(4-Hydroxyphenyl)pyruvate |
| 44 | 3dpdhb | Mitochondria | 3-Decaprenyl-4,5-dihdydroxybenzoate |
| 45 | 3dpdhb_me | Mitochondria | 3-Decaprenyl-4-hydroxy-5-methoxybenzoate |
| 46 | 3dsphgn | Cytosol | 3-Dehydrosphinganine |
| 47 | 3h26dm5coa | Mitochondria | 3-Hydroxy-2,6-dimethyl-5-methylene-heptanoyl- |
| | | | CoA |
| 48 | 3h26dm5coa | Peroxisome | 3-Hydroxy-2,6-dimethyl-5-methylene-heptanoyl- |
| | | | CoA |
| 49 | 3hanthrn | Cytosol | 3-Hydroxyanthranilate |
| 50 | 3hbycoa | Mitochondria | (S)-3-Hydroxybutyryl-CoA |
| 51 | 3hbycoa | Peroxisome | (S)-3-Hydroxybutyryl-CoA |
| 52 | 3hmbcoa | Mitochondria | (S)-3-Hydroxy-2-methylbutyryl-CoA |
| 53 | 3hmp | Mitochondria | (S)-3-hydroxyisobutyrate |
| 54 | 3hpcoa | Mitochondria | 3-Hydroxypropionyl-CoA |
| 55 | 3htmelys | Cytosol | 3-Hydroxy-N6,N6,N6-trimethyl-L-lysine |
| 56 | 3htmelys | Mitochondria | 3-Hydroxy-N6,N6,N6-trimethyl-L-lysine |
| 57 | 3mb2coa | Mitochondria | 3-Methylbut-2-enoyl-CoA |
| 58 | 3mgcoa | Mitochondria | 3-Methylglutaconyl-CoA |
| 59 | 3mob | Mitochondria | 3-Methyl-2-oxobutanoate |
| 60 | 3mop | Mitochondria | (S)-3-Methyl-2-oxopentanoate |
| 61 | 3odcoa | Peroxisome | 3-Oxodecanoyl-CoA |
| 62 | 3oddcoa | Peroxisome | 3-Oxododecanoyl-CoA |
| 63 | 3ohdcoa | Peroxisome | 3-Oxohexadecanoyl-CoA |
| 64 | 3ohxccoa | Peroxisome | 3-Oxohexacosanoyl-CoA |
| 65 | 3oodcoa | Peroxisome | 3-Oxooctadecanoyl-CoA |
| 66 | 3otdcoa | Peroxisome | 3-Oxotetradecanoyl-CoA |
| 67 | 3padsel | Cytosol | 3′-Phosphoadenylylselenate |
| 68 | 3pg | Cytosol | 3-Phospho-D-glycerate |
| 69 | 3php | Cytosol | 3-Phosphohydroxypyruvate |
| 70 | 3sala | Cytosol | 3-Sulfino-L-alanine |
| 71 | 3sala | Mitochondria | 3-Sulfino-L-alanine |
| 72 | 44mctr | Endoplasmic Reticulum | 4,4-dimethylcholesta-8,14,24-trienol |
| 73 | 44mzym | Endoplasmic Reticulum | 4,4-dimethylzymosterol |
| 74 | 46dhqnl | Cytosol | 4,6-Dihydroxyquinoline |
| 75 | 48dhqnl | Cytosol | 4,8-Dihydroxyquinoline |
| 76 | 4abut | Cytosol | 4-Aminobutanoate |
| 77 | 4abut | Mitochondria | 4-Aminobutanoate |
| 78 | 4abutn | Cytosol | 4-Aminobutanal |
| 79 | 4fumacac | Cytosol | 4-Fumarylacetoacetate |
| 80 | 4h2oxg | Cytosol | D-4-Hydroxy-2-oxoglutarate |
| 81 | 4h2oxg | Mitochondria | D-4-Hydroxy-2-oxoglutarate |
| 82 | 4izp | Cytosol | 4-Imidazolone-5-propanoate |
| 83 | 4mlacac | Cytosol | 4-Maleylacetoacetate |
| 84 | 4mop | Mitochondria | 4-Methyl-2-oxopentanoate |
| 85 | 4mzym_int1 | Endoplasmic Reticulum | 4-Methylzymosterol intermediate 1 |
| 86 | 4mzym_int2 | Endoplasmic Reticulum | 4-Methylzymosterol intermediate 2 |
| 87 | 4ppan | Cytosol | D-4′-Phosphopantothenate |
| 88 | 4ppcys | Cytosol | N-((R)-4-Phosphopantothenoyl)-L-cysteine |
| 89 | 4tmeabut | Cytosol | 4-Trimethylammoniobutanal |
| 90 | 4tmeabut | Mitochondria | 4-Trimethylammoniobutanal |
| 91 | 56dthm | Cytosol | 5,6-Dihydrothymine |
| 92 | 56dura | Cytosol | 5,6-dihydrouracil |
| 93 | 5aizc | Cytosol | 5-amino-1-(5-phospho-D-ribosyl)imidazole-4- |
| | | | carboxylate |
| 94 | 5aop | Cytosol | 5-Amino-4-oxopentanoate |
| 95 | 5aop | Mitochondria | 5-Amino-4-oxopentanoate |
| 96 | 5dhf | Cytosol | pentaglutamyl folate (DHF) |
| 97 | 5dhf | Mitochondria | pentaglutamyl folate (DHF) |
| 98 | 5dpmev | Peroxisome | (R)-5-Diphosphomevalonate |
| 99 | 5fthf | Cytosol | 5-Formiminotetrahydrofolate |
| 100 | 5hkyrm | Cytosol | 5-Hydroxykynurenamine |
| 101 | 5mdr1p | Cytosol | 5-Methylthio-5-deoxy-D-ribose 1-phosphate |
| 102 | 5mta | Cytosol | 5-Methylthioadenosine |
| 103 | 5mthf | Cytosol | 5-Methyltetrahydrofolate |
| 104 | 5oxpro | Cytosol | 5-Oxoproline |
| 105 | 5pmev | Peroxisome | (R)-5-Phosphomevalonate |
| 106 | 5thf | Cytosol | pentaglutamyl folate (THF) |
| 107 | 5thf | Mitochondria | pentaglutamyl folate (THF) |
| 108 | 6dhf | Cytosol | haxglutamyl folate (DHF) |
| 109 | 6dhf | Mitochondria | haxglutamyl folate (DHF) |
| 110 | 6pgc | Cytosol | 6-Phospho-D-gluconate |
| 111 | 6pgc | Endoplasmic Reticulum | 6-Phospho-D-gluconate |
| 112 | 6pgl | Cytosol | 6-phospho-D-glucono-1,5-lactone |
| 113 | 6pgl | Endoplasmic Reticulum | 6-phospho-D-glucono-1,5-lactone |
| 114 | 6pthp | Cytosol | 6-Pyruvoyl-5,6,7,8-tetrahydropterin |
| 115 | 6thf | Cytosol | hexaglutamyl folate (THF) |
| 116 | 6thf | Mitochondria | hexaglutamyl folate (THF) |
| 117 | 7dhchsterol | Endoplasmic Reticulum | 7-Dehydrocholesterol |
| 118 | 7dhf | Cytosol | heptaglutamyl folate (DHF) |
| 119 | 7dhf | Mitochondria | heptaglutamyl folate (DHF) |
| 120 | 7thf | Cytosol | heptaglutamyl folate (THF) |
| 121 | 7thf | Mitochondria | heptaglutamyl folate (THF) |
| 122 | a3n4m2mf | Golgi Apparatus | Gal b1-4 GlcNAc b1-2 (GlcNAc b1-3 Gal b1- |
| | | | 4 GlcNAc b1-4) Man a1-3(Gal b1-4 GlcNAc b1- |
| | | | 2 Man a1-6) Man b1-4 GlcNAc b1-4(Fuc a1- |
| | | | 6) GlcNAcOH |
| 123 | a4n5m2mf | Golgi Apparatus | Gal b1-4 GlcNAc b1-2(Gal b1-4 GlcNAc b1- |
| | | | 4) Man a1-3(Gal b1-4 GlcNAc b1-2(GlcNAc b1- |
| | | | 3 Gal b1-4 GlcNAc b1-6) Man a1-6) Man b1- |
| | | | 4 GlcNAc b1-4(Fuc a1-6) GlcNAcOH |
| 124 | a5n6m2mf | Golgi Apparatus | Galb1-4GlcNAcb1-2(Galb1-4GlcNAcb1-4)Mana1- |
| | | | 3(GlcNAcb1-3Galb1-4GlcNAcb1-2(Galb1- |
| | | | 4GlcNAcb1-3Galb1-4GlcNAcb1-6)Mana1-6)Manb1- |
| | | | 4GlcNAcb1-4(Fuc a1-6)GlcNAcOH |
| 125 | a6n7m2mf | Golgi Apparatus | Galb1-4GlcNAcb1-2(GlcNAcb1-3Galb1-4GlcNAcb1 |
| | | | 4)Mana1-3(Galb1-4GlcNAcb1-3Galb1-4GlcNAcb1- |
| | | | 2(Galb1-4GlcNAcb1-3Galb1-4GlcNAcb1-6)Mana1- |
| | | | 6)Manb1-4GlcNAcb1-4(Fuca1-6)GlcNAcOH |
| 126 | aacoa | Cytosol | Acetoacetyl-CoA |
| 127 | aacoa | Mitochondria | Acetoacetyl-CoA |
| 128 | aacoa | Peroxisome | Acetoacetyl-CoA |
| 129 | ac | Cytosol | Acetate |
| 130 | acac | Cytosol | Acetoacetate |
| 131 | acac | Mitochondria | Acetoacetate |
| 132 | acac | Peroxisome | Acetoacetate |
| 133 | acACP | Cytosol | Acetyl-ACP |
| 134 | acald | Cytosol | Acetaldehyde |
| 135 | acald | Peroxisome | Acetaldehyde |
| 136 | accoa | Cytosol | Acetyl-CoA |
| 137 | accoa | Mitochondria | Acetyl-CoA |
| 138 | accoa | Peroxisome | Acetyl-CoA |
| 139 | acg5p | Mitochondria | N-Acetyl-L-glutamyl 5-phosphate |
| 140 | acg5sa | Mitochondria | N-Acetyl-L-glutamate 5-semialdehyde |
| 141 | acgal | Lysosome | N-Acetyl-D-galactosamine |
| 142 | acgam | Cytosol | N-Acetyl-D-glucosamine |
| 143 | acgam | Lysosome | N-Acetyl-D-glucosamine |
| 144 | acgam1p | Cytosol | N-Acetyl-D-glucosamine 1-phosphate |
| 145 | acgam6p | Cytosol | N-Acetyl-D-glucosamine 6-phosphate |
| 146 | acmana | Cytosol | N-Acetyl-D-mannosamine |
| 147 | acmanap | Cytosol | N-Acetyl-D-mannosamine 6-phosphate |
| 148 | acmucsal | Cytosol | 2-Amino-3-carboxymuconate semialdehyde |
| 149 | acnam | Cytosol | N-Acetylneuraminate |
| 150 | acnam | Lysosome | N-Acetylneuraminate |
| 151 | acnam | Nucleus | N-Acetylneuraminate |
| 152 | acnr9p | Cytosol | N-Acetylneuraminate 9-phosphate |
| 153 | acorn | Cytosol | N2-Acetyl-L-ornithine |
| 154 | ACP | Cytosol | acyl carrier protein |
| 155 | ACP | Mitochondria | acyl carrier protein |
| 156 | acrn | Cytosol | O-Acetylcarnitine |
| 157 | acrn | Mitochondria | O-Acetylcarnitine |
| 158 | ade | Cytosol | Adenine |
| 159 | ade | Extra-organism | Adenine |
| 160 | adn | Cytosol | Adenosine |
| 161 | adp | Cytosol | ADP |
| 162 | adp | Mitochondria | ADP |
| 163 | adp | Nucleus | ADP |
| 164 | adp | Peroxisome | ADP |
| 165 | adrncoa | Mitochondria | adrenyl-CoA (C22:4CoA) |
| 166 | adrncoa | Peroxisome | adrenyl-CoA (C22:4CoA) |
| 167 | adrnl | Cytosol | Adrenaline |
| 168 | adsel | Cytosol | Adenylylselenate |
| 169 | agm | Mitochondria | Agmatine |
| 170 | ahcys | Cytosol | S-Adenosyl-L-homocysteine |
| 171 | ahcys | Mitochondria | S-Adenosyl-L-homocysteine |
| 172 | ahdt | Cytosol | 2-Amino-4-hydroxy-6-(erythro-1,2,3- |
| | | | trihydroxypropyl)dihydropteridine triphosphate |
| 173 | ahdt | Nucleus | 2-Amino-4-hydroxy-6-(erythro-1,2,3- |
| | | | trihydroxypropyl)dihydropteridine triphosphate |
| 174 | ahpoxbut | Cytosol | 4-(2-Amino-3-hydroxyphenyl)-2,4-dioxobutanoate |
| 175 | aicar | Cytosol | 5-Amino-1-(5-Phospho-D-ribosyl)imidazole-4- |
| | | | carboxamide |
| 176 | air | Cytosol | 5-amino-1-(5-phospho-D-ribosyl)imidazole |
| 177 | akg | Cytosol | 2-Oxoglutarate |
| 178 | akg | Mitochondria | 2-Oxoglutarate |
| 179 | ala-L | Cytosol | L-Alanine |
| 180 | ala-L | Extra-organism | L-Alanine |
| 181 | ala-L | Mitochondria | L-Alanine |
| 182 | alpam | Mitochondria | S-aminomethyldihydrolipoamide |
| 183 | alpro | Mitochondria | S-Aminomethyldihydrolipoylprotein |
| 184 | amet | Cytosol | S-Adenosyl-L-methionine |
| 185 | amet | Mitochondria | S-Adenosyl-L-methionine |
| 186 | ametam | Cytosol | S-Adenosylmethioninamine |
| 187 | amp | Cytosol | AMP |
| 188 | amp | Endoplasmic Reticulum | AMP |
| 189 | amp | Mitochondria | AMP |
| 190 | amp | Peroxisome | AMP |
| 191 | ampsal | Mitochondria | L-2-Aminoadipate 6-semialdehyde |
| 192 | amucsal | Cytosol | 2-Aminomuconate semialdehyde |
| 193 | apoC-Lys | Cytosol | Apocarboxylase (Lys residue) |
| 194 | apoC-Lys | Mitochondria | Apocarboxylase (Lys residue) |
| 195 | apoC-Lys_btn | Cytosol | Holocarboxylase (biotin covalent bound to Lys |
| | | | residue of apoC) |
| 196 | apoC-Lys_btn | Mitochondria | Holocarboxylase (biotin covalent bound to Lys |
| | | | residue of apoC) |
| 197 | aprut | Cytosol | N-Acetylputrescine |
| 198 | aps | Cytosol | Adenosine 5′-phosphosulfate |
| 199 | arachcoa | Mitochondria | arachidyl coenzyme A |
| 200 | arachcoa | Peroxisome | arachidyl coenzyme A |
| 201 | arachda | Cytosol | Arachidonic acid (C20:4) |
| 202 | arachda | Extra-organism | Arachidonic acid (C20:4) |
| 203 | arachdcoa | Cytosol | arachidonoyl-CoA (C20:4CoA, n-6) |
| 204 | arachdcoa | Mitochondria | arachidonoyl-CoA (C20:4CoA, n-6) |
| 205 | arachdcoa | Peroxisome | arachidonoyl-CoA (C20:4CoA, n-6) |
| 206 | arachdcrn | Cytosol | C20:4 carnitine |
| 207 | arachdcrn | Mitochondria | C20:4 carnitine |
| 208 | arg-L | Cytosol | L-Arginine |
| 209 | arg-L | Extra-organism | L-Arginine |
| 210 | arg-L | Mitochondria | L-Arginine |
| 211 | argsuc | Cytosol | N(omega)-(L-Arginino)succinate |
| 212 | ascb | Cytosol | L-Ascorbate |
| 213 | ascb | Extra-organism | L-Ascorbate |
| 214 | asn-L | Cytosol | L-Asparagine |
| 215 | asn-L | Extra-organism | L-Asparagine |
| 216 | asn-L | Mitochondria | L-Asparagine |
| 217 | Asn-X-Ser/Thr | Lysosome | protein-linked asparagine residue (N-glycosylation |
| | | | site) |
| 218 | asp-L | Cytosol | L-Aspartate |
| 219 | asp-L | Extra-organism | L-Aspartate |
| 220 | asp-L | Mitochondria | L-Aspartate |
| 221 | atp | Cytosol | ATP |
| 222 | atp | Endoplasmic Reticulum | ATP |
| 223 | atp | Mitochondria | ATP |
| 224 | atp | Nucleus | ATP |
| 225 | atp | Peroxisome | ATP |
| 226 | b2coa | Mitochondria | trans-But-2-enoyl-CoA |
| 227 | b2coa | Peroxisome | trans-But-2-enoyl-CoA |
| 228 | bcar | Cytosol | beta-Carotene |
| 229 | btamp | Cytosol | Biotinyl-5′-AMP |
| 230 | btamp | Mitochondria | Biotinyl-5′-AMP |
| 231 | btcoa | Mitochondria | Butanoyl-CoA (C4:0CoA) |
| 232 | btn | Cytosol | Biotin |
| 233 | btn | Mitochondria | Biotin |
| 234 | but | Cytosol | Butyrate |
| 235 | but | Mitochondria | Butyrate |
| 236 | bz | Endoplasmic Reticulum | Benzoate |
| 237 | c2m26dcoa | Mitochondria | cis-2-Methyl-5-isopropylhexa-2,5-dienoyl-CoA |
| 238 | c2m26dcoa | Peroxisome | cis-2-Methyl-5-isopropylhexa-2,5-dienoyl-CoA |
| 239 | cala | Cytosol | N-Carbamoyl-beta-alanine |
| 240 | camp | Cytosol | cAMP |
| 241 | cbasp | Cytosol | N-Carbamoyl-L-aspartate |
| 242 | cbp | Cytosol | Carbamoyl phosphate |
| 243 | cbp | Mitochondria | Carbamoyl phosphate |
| 244 | cdp | Cytosol | CDP |
| 245 | cdp | Mitochondria | CDP |
| 246 | cdp | Nucleus | CDP |
| 247 | cdpchol | Cytosol | CDPcholine |
| 248 | cdpdag_CHO | Cytosol | CDPdiacylglycerol, CHO specific |
| 249 | cdpdag_CHO | Mitochondria | CDPdiacylglycerol, CHO specific |
| 250 | cdpea | Cytosol | CDPethanolamine |
| 251 | cer_CHO | Cytosol | ceramide, CHO specific |
| 252 | cgly | Cytosol | Cys-Gly |
| 253 | cgly | Extra-organism | Cys-Gly |
| 254 | cgmp | Cytosol | 3′,5′-Cyclic GMP |
| 255 | chito2pdol | Cytosol | N,N′-Diacetylchitobiosyldiphosphodolichol, |
| | | | mammals |
| 256 | chol | Cytosol | Choline |
| 257 | chol | Extra-organism | Choline |
| 258 | cholcoa | Peroxisome | Choloyl-CoA |
| 259 | cholcoads | Peroxisome | 3alpha,7alpha,12alpha-Trihydroxy-5beta-cholest-24- |
| | | | enoyl-CoA |
| 260 | cholcoaone | Peroxisome | 3alpha,7alpha,12alpha-Trihydroxy-5beta-24- |
| | | | oxocholestanoyl-CoA |
| 261 | cholcoar | Endoplasmic Reticulum | 3alpha,7alpha,12alpha-Trihydroxy-5beta- |
| | | | cholestanoyl-CoA |
| 262 | cholcoar | Peroxisome | 3alpha,7alpha,12alpha-Trihydroxy-5beta- |
| | | | cholestanoyl-CoA |
| 263 | cholcoas | Peroxisome | 3alpha,7alpha,12alpha-Trihydroxy-5beta- |
| | | | cholestanoyl-CoA(S) |
| 264 | cholp | Cytosol | Choline phosphate |
| 265 | cholsd | Endoplasmic Reticulum | 5alpha-Cholesta-7,24-dien-3beta-ol |
| 266 | cholse_CHO | Cytosol | Cholesterol ester, CHO specific |
| 267 | chsterol | Cytosol | Cholesterol |
| 268 | chsterol | Endoplasmic Reticulum | Cholesterol |
| 269 | chsterol | Extra-organism | Cholesterol |
| 270 | chsterol | Golgi Apparatus | Cholesterol |
| 271 | cis-dd2coa | Mitochondria | 3-cis-Dodecenoyl-CoA |
| 272 | cit | Cytosol | Citrate |
| 273 | cit | Extra-organism | Citrate |
| 274 | cit | Mitochondria | Citrate |
| 275 | citr-L | Cytosol | L-Citrulline |
| 276 | citr-L | Mitochondria | L-Citrulline |
| 277 | clpn_CHO | Cytosol | cardiolipin, CHO specific |
| 278 | clpn_CHO | Mitochondria | cardiolipin, CHO specific |
| 279 | clpndcoa | Cytosol | clupanodonyl CoA (C22:5CoA) |
| 280 | clpndcoa | Mitochondria | clupanodonyl CoA (C22:5CoA) |
| 281 | clpndcoa | Peroxisome | clupanodonyl CoA (C22:5CoA) |
| 282 | clpndcrn | Cytosol | docosapentaenoyl carnitine (C22:5) |
| 283 | clpndcrn | Mitochondria | docosapentaenoyl carnitine (C22:5) |
| 284 | cmp | Cytosol | CMP |
| 285 | cmp | Golgi Apparatus | CMP |
| 286 | cmp | Mitochondria | CMP |
| 287 | cmp | Nucleus | CMP |
| 288 | cmp2amep | Cytosol | CMP-2-aminoethylphosphonate |
| 289 | cmpacna | Cytosol | CMP-N-acetylneuraminate |
| 290 | cmpacna | Golgi Apparatus | CMP-N-acetylneuraminate |
| 291 | cmpacna | Nucleus | CMP-N-acetylneuraminate |
| 292 | cmpntm2amep | Cytosol | CMP-N-trimethyl-2-aminoethylphosphonate |
| 293 | co2 | Cytosol | CO2 |
| 294 | co2 | Endoplasmic Reticulum | CO2 |
| 295 | co2 | Extra-organism | CO2 |
| 296 | co2 | Golgi Apparatus | CO2 |
| 297 | co2 | Mitochondria | CO2 |
| 298 | co2 | Peroxisome | CO2 |
| 299 | coa | Cytosol | Coenzyme A |
| 300 | coa | Endoplasmic Reticulum | Coenzyme A |
| 301 | coa | Mitochondria | Coenzyme A |
| 302 | coa | Peroxisome | Coenzyme A |
| 303 | coke | Endoplasmic Reticulum | cocaine |
| 304 | core6 | Lysosome | Core 6 |
| 305 | cpppg3 | Cytosol | Coproporphyrinogen III |
| 306 | crn | Cytosol | L-Carnitine |
| 307 | crn | Mitochondria | L-Carnitine |
| 308 | cs_a | Lysosome | chondroitin sulfate A (GalNAc4S-GlcA), free chain |
| 309 | cs_a_deg1 | Lysosome | chondroitin sulfate A (GalNAc4S-GlcA), |
| | | | degradation product 1 |
| 310 | cs_a_deg2 | Lysosome | chondroitin sulfate A (GalNAc4S-GlcA), |
| | | | degradation product 2 |
| 311 | cs_a_deg3 | Lysosome | chondroitin sulfate A (GalNAc4S-GlcA), |
| | | | degradation product 3 |
| 312 | cs_a_deg4 | Lysosome | chondroitin sulfate A (GalNAc4S-GlcA), |
| | | | degradation product 4 |
| 313 | cs_a_deg5 | Lysosome | chondroitin sulfate A (GalNAc4S-GlcA), |
| | | | degradation product 5 |
| 314 | cs_b | Lysosome | chondroitin sulfate B/dermatan sulfate (IdoA2S- |
| | | | GalNAc4S), free chain |
| 315 | cs_b_deg1 | Lysosome | chondroitin sulfate B/dermatan sulfate (IdoA2S- |
| | | | GalNAc4S), degradation product 1 |
| 316 | cs_b_deg2 | Lysosome | chondroitin sulfate B/dermatan sulfate (IdoA2S- |
| | | | GalNAc4S), degradation product 2 |
| 317 | cs_c | Lysosome | chondroitin sulfate C (GalNAc6S-GlcA), free chain |
| 318 | cs_c_deg1 | Lysosome | chondroitin sulfate C (GalNAc6S-GlcA), degradation |
| | | | product 1 |
| 319 | cs_c_deg2 | Lysosome | chondroitin sulfate C (GalNAc6S-GlcA), degradation |
| | | | product 2 |
| 320 | cs_c_deg3 | Lysosome | chondroitin sulfate C (GalNAc6S-GlcA), degradation |
| | | | product 3 |
| 321 | cs_c_deg4 | Lysosome | chondroitin sulfate C (GalNAc6S-GlcA), degradation |
| | | | product 4 |
| 322 | cs_c_deg5 | Lysosome | chondroitin sulfate C (GalNAc6S-GlcA), degradation |
| | | | product 5 |
| 323 | cs_d | Lysosome | chondroitin sulfate D (GlcNAc6S-GlcA2S), free |
| | | | chain |
| 324 | cs_d_deg1 | Lysosome | chondroitin sulfate D (GlcNAc6S-GlcA2S), |
| | | | degradation product 1 |
| 325 | cs_d_deg2 | Lysosome | chondroitin sulfate D (GlcNAc6S-GlcA2S), |
| | | | degradation product 2 |
| 326 | cs_d_deg3 | Lysosome | chondroitin sulfate D (GlcNAc6S-GlcA2S), |
| | | | degradation product 3 |
| 327 | cs_d_deg4 | Lysosome | chondroitin sulfate D (GlcNAc6S-GlcA2S), |
| | | | degradation product 4 |
| 328 | cs_d_deg5 | Lysosome | chondroitin sulfate D (GlcNAc6S-GlcA2S), |
| | | | degradation product 5 |
| 329 | cs_d_deg6 | Lysosome | chondroitin sulfate D (GlcNAc6S-GlcA2S), |
| | | | degradation product 6 |
| 330 | cs_e | Lysosome | chondroitin sulfate E (GalNAc4,6diS-GlcA), free |
| | | | chain |
| 331 | cs_e_deg1 | Lysosome | chondroitin sulfate E (GalNAc4,6diS-GlcA), |
| | | | degradation product 1 |
| 332 | cs_e_deg2 | Lysosome | chondroitin sulfate E (GalNAc4,6diS-GlcA), |
| | | | degradation product 2 |
| 333 | cs_e_deg3 | Lysosome | chondroitin sulfate E (GalNAc4,6diS-GlcA), |
| | | | degradation product 3 |
| 334 | cs_e_deg4 | Lysosome | chondroitin sulfate E (GalNAc4,6diS-GlcA), |
| | | | degradation product 4 |
| 335 | cs_e_deg5 | Lysosome | chondroitin sulfate E (GalNAc4,6diS-GlcA), |
| | | | degradation product 5 |
| 336 | cs_e_deg6 | Lysosome | chondroitin sulfate E (GalNAc4,6diS-GlcA), |
| | | | degradation product 6 |
| 337 | cs_e_deg7 | Lysosome | chondroitin sulfate E (GalNAc4,6diS-GlcA), |
| | | | degradation product 7 |
| 338 | ctp | Cytosol | CTP |
| 339 | ctp | Mitochondria | CTP |
| 340 | ctp | Nucleus | CTP |
| 341 | cvncoa | Cytosol | cervonyl CoA (C22:6CoA) |
| 342 | cvncoa | Mitochondria | cervonyl CoA (C22:6CoA) |
| 343 | cvncoa | Peroxisome | cervonyl CoA (C22:6CoA) |
| 344 | cvncrn | Cytosol | cervonyl carnitine (C22:6Crn) |
| 345 | cvncrn | Mitochondria | cervonyl carnitine (C22:6Crn) |
| 346 | cys-L | Cytosol | L-Cysteine |
| 347 | cys-L | Extra-organism | L-Cysteine |
| 348 | cys-L | Mitochondria | L-Cysteine |
| 349 | cysth-L | Cytosol | L-Cystathionine |
| 350 | cytd | Cytosol | Cytidine |
| 351 | dad-2 | Cytosol | Deoxyadenosine |
| 352 | dadp | Cytosol | dADP |
| 353 | dadp | Nucleus | dADP |
| 354 | datp | Cytosol | dATP |
| 355 | datp | Nucleus | dATP |
| 356 | dca | Cytosol | Decanoate |
| 357 | dcamp | Cytosol | N6-(1,2-Dicarboxyethyl)-AMP |
| 358 | dccoa | Cytosol | Decanoyl-CoA (C10:0CoA) |
| 359 | dccoa | Mitochondria | Decanoyl-CoA (C10:0CoA) |
| 360 | dccoa | Peroxisome | Decanoyl-CoA (C10:0CoA) |
| 361 | dcdp | Cytosol | dCDP |
| 362 | dcdp | Nucleus | dCDP |
| 363 | dcer_CHO | Cytosol | dihydroceramide, CHO specific |
| 364 | dcholcoa | Peroxisome | chenodeoxycholoyl coenzyme a |
| 365 | dcmp | Cytosol | dCMP |
| 366 | dcmp | Nucleus | dCMP |
| 367 | dcsa | Cytosol | docosanoate (n-C22:0) |
| 368 | dcsacoa | Cytosol | docosanoyl-CoA (C22:0CoA) |
| 369 | dcshea | Cytosol | docosahexaenoate (C22:6) |
| 370 | dcshea | Extra-organism | docosahexaenoate (C22:6) |
| 371 | dcshea3 | Cytosol | docosahexaenoate (C22:6, n-3) |
| 372 | dcshea3 | Extra-organism | docosahexaenoate (C22:6, n-3) |
| 373 | dcspea | Cytosol | docosapentaenoic acid (C22:5) |
| 374 | dcspea | Extra-organism | docosapentaenoic acid (C22:5) |
| 375 | dcspea3 | Cytosol | docosapentaenoate (C22:5, n-3) |
| 376 | dcspea6 | Cytosol | docosapentaenoate (C22:5, n-6) |
| 377 | dcsptn1coa | Mitochondria | docosa-4,7,10,13,16-pentaenoyl coenzyme A |
| | | | (C22:5CoA) |
| 378 | dcsptn1coa | Peroxisome | docosa-4,7,10,13,16-pentaenoyl coenzyme A |
| | | | (C22:5CoA) |
| 379 | dctp | Cytosol | dCTP |
| 380 | dctp | Nucleus | dCTP |
| 381 | dcyt | Nucleus | Deoxycytidine |
| 382 | ddca | Cytosol | dodecanoate (C12:0) |
| 383 | ddcoa | Cytosol | Dodecanoyl-CoA (n-C12:0CoA) |
| 384 | ddcoa | Mitochondria | Dodecanoyl-CoA (n-C12:0CoA) |
| 385 | ddcoa | Peroxisome | Dodecanoyl-CoA (n-C12:0CoA) |
| 386 | ddsmsterol | Endoplasmic Reticulum | 7-Dehydrodesmosterol |
| 387 | dedol | Cytosol | Dehydrodolichol, mammals |
| 388 | dedoldp | Cytosol | Dehydrodolichol diphosphate, mammals |
| 389 | dedolp | Cytosol | Deydodolichol phosphate, mammals |
| 390 | dgcholcoa | Peroxisome | Chenodeoxyglycocholoyl-CoA |
| 391 | dgdp | Cytosol | dGDP |
| 392 | dgdp | Nucleus | dGDP |
| 393 | dgmp | Cytosol | dGMP |
| 394 | dgmp | Mitochondria | dGMP |
| 395 | dgsn | Cytosol | Deoxyguanosine |
| 396 | dgsn | Mitochondria | Deoxyguanosine |
| 397 | dgtp | Cytosol | dGTP |
| 398 | dgtp | Nucleus | dGTP |
| 399 | dhap | Cytosol | Dihydroxyacetone phosphate |
| 400 | dhap | Peroxisome | Dihydroxyacetone phosphate |
| 401 | dhbpt | Cytosol | 6,7-Dihydrobiopterin |
| 402 | dhcholestanate | Endoplasmic Reticulum | 3alpha,7alpha-Dihydroxy-5beta-cholestanate |
| 403 | dhcholestanate | Peroxisome | 3alpha,7alpha-Dihydroxy-5beta-cholestanate |
| 404 | dhcholestancoa | Endoplasmic Reticulum | 3alpha,7alpha-Dihydroxy-5beta-cholestanoyl-CoA |
| 405 | dhcholestancoa | Peroxisome | 3alpha,7alpha-Dihydroxy-5beta-cholestanoyl-CoA |
| 406 | dhf | Cytosol | 7,8-Dihydrofolate |
| 407 | dhf | Mitochondria | 7,8-Dihydrofolate |
| 408 | dhlam | Mitochondria | Dihydrolipoamide |
| 409 | dhlpro | Mitochondria | Dihydrolipolprotein |
| 410 | dhmdlald | Cytosol | 3,4-Dihydroxymandelaldehyde |
| 411 | dhocholoylcoa | Peroxisome | 3alpha,7alpha,12alpha,26-Tetrahydroxy-5beta- |
| | | | cholestane |
| 412 | dhor-S | Cytosol | (S)-Dihydroorotate |
| 413 | dhpethg | Cytosol | 3,4-Dihydroxyphenylethyleneglycol |
| 414 | didp | Cytosol | dIDP |
| 415 | didp | Nucleus | dIDP |
| 416 | dimp | Cytosol | dIMP |
| 417 | din | Cytosol | Deoxyinosine |
| 418 | ditp | Cytosol | dITP |
| 419 | ditp | Nucleus | dITP |
| 420 | dlnlcgcoa | Mitochondria | dihomo-gamma-linolenyl coenzyme A (C20:3CoA) |
| 421 | dmhptcoa | Mitochondria | 2,6 dimethylheptanoyl-CoA |
| 422 | dmnoncoa | Cytosol | 4,8 dimethylnonanoyl-CoA |
| 423 | dmnoncoa | Mitochondria | 4,8 dimethylnonanoyl-CoA |
| 424 | dmnoncoa | Peroxisome | 4,8 dimethylnonanoyl-CoA |
| 425 | dmpp | Cytosol | Dimethylallyl diphosphate |
| 426 | dmpp | Peroxisome | Dimethylallyl diphosphate |
| 427 | dnad | Cytosol | Deamino-NAD+ |
| 428 | dnad | Mitochondria | Deamino-NAD+ |
| 429 | dnad | Nucleus | Deamino-NAD+ |
| 430 | doldp2 | Endoplasmic Reticulum | Dolichol diphosphate, mammals |
| 431 | dolglcp2 | Cytosol | Dolichyl beta-D-glucosyl phosphate, mammals |
| 432 | dolglcp2 | Endoplasmic Reticulum | Dolichyl beta-D-glucosyl phosphate, mammals |
| 433 | dolglcp_L | Cytosol | Dolichyl beta-D-glucosyl phosphate, human liver |
| | | | homolog |
| 434 | dolglcp_U | Cytosol | Dolichyl beta-D-glucosyl phosphate, human uterine |
| | | | homolog |
| 435 | dolichol2 | Cytosol | Dolichol, mammals |
| 436 | dolichol2 | Endoplasmic Reticulum | Dolichol, mammals |
| 437 | dolmanp2 | Cytosol | Dolichyl phosphate D-mannose, mammals |
| 438 | dolmanp2 | Endoplasmic Reticulum | Dolichyl phosphate D-mannose, mammals |
| 439 | dolp2 | Cytosol | Dolichol phosphate, mammals |
| 440 | dolp2 | Endoplasmic Reticulum | Dolichol phosphate, mammals |
| 441 | dolp_L | Cytosol | Dolichol phosphate, human liver homolog |
| 442 | dolp_U | Cytosol | Dolichol phosphate, human uterine homolog |
| 443 | dopmn | Cytosol | Dopamine |
| 444 | dpcoa | Cytosol | Dephospho-CoA |
| 445 | dpheacd | Cytosol | 3,4-Dihydroxyphenylacetaldehyde |
| 446 | dshcoa3 | Cytosol | docosahexaenoyl-CoA (C22:6CoA, n-3) |
| 447 | dshcoa3 | Mitochondria | docosahexaenoyl-CoA (C22:6CoA, n-3) |
| 448 | dsmsterol | Endoplasmic Reticulum | Desmosterol |
| 449 | dspcoa3 | Cytosol | docosapentaenoyl-CoA (C22:5CoA, n-3) |
| 450 | dspcoa3 | Mitochondria | docosapentaenoyl-CoA (C22:5CoA, n-3) |
| 451 | dspcoa6 | Cytosol | docosapentaenoyl-CoA (C22:5CoA, n-6) |
| 452 | dspcoa6 | Mitochondria | docosapentaenoyl-CoA (C22:5CoA, n-6) |
| 453 | dtdp | Cytosol | dTDP |
| 454 | dtdp | Nucleus | dTDP |
| 455 | dtdpddg | Cytosol | dTDP-4-dehydro-6-deoxy-D-glucose |
| 456 | dtdpglc | Cytosol | dTDPglucose |
| 457 | dtmp | Cytosol | dTMP |
| 458 | dtt_ox | Cytosol | Oxidized dithiothreitol |
| 459 | dtt_rd | Cytosol | Reduced dithiothreitol |
| 460 | dttp | Cytosol | dTTP |
| 461 | dttp | Nucleus | dTTP |
| 462 | dudp | Cytosol | dUDP |
| 463 | dudp | Nucleus | dUDP |
| 464 | dump | Cytosol | dUMP |
| 465 | duri | Cytosol | Deoxyuridine |
| 466 | dutp | Cytosol | dUTP |
| 467 | dutp | Nucleus | dUTP |
| 468 | dxtrn | Cytosol | phosphorylase-limit dextrin (glycogenin-1,6{4[1,4- |
| | | | Glc], 4[1,4-Glc]}) |
| 469 | e4h2oxg | Cytosol | L-erythro-4-Hydroxyglutamate |
| 470 | e4h2oxg | Mitochondria | L-erythro-4-Hydroxyglutamate |
| 471 | e4p | Cytosol | D-Erythrose 4-phosphate |
| 472 | ecgon | Endoplasmic Reticulum | ecgonine |
| 473 | ecsa | Cytosol | Eicosanoate (n-C20:0) |
| 474 | ecsa | Extra-organism | Eicosanoate (n-C20:0) |
| 475 | ecsacoa | Cytosol | Eicosanoyl-CoA (n-C20:0CoA) |
| 476 | ecsacoa | Mitochondria | Eicosanoyl-CoA (n-C20:0CoA) |
| 477 | ecsacrn | Cytosol | eicosanoylcarnitine, C20:0crn |
| 478 | ecsacrn | Mitochondria | eicosanoylcarnitine, C20:0crn |
| 479 | ecsdea9 | Cytosol | eicosadienoate (C20:2, n-9) |
| 480 | ecsea9 | Cytosol | eicosenoate (C20:1, n-9) |
| 481 | ecspea | Cytosol | Eicosapentaenoic acid (C20:5) |
| 482 | ecspea | Extra-organism | Eicosapentaenoic acid (C20:5) |
| 483 | ecspea3 | Cytosol | eicosapentaenoate (C20:5, n-3) |
| 484 | ecspecoa | Cytosol | eicosapentaenoyl-CoA (C20:5CoA) |
| 485 | ecspecoa | Mitochondria | eicosapentaenoyl-CoA (C20:5CoA) |
| 486 | ecspecrn | Cytosol | eicosapentaenoyl carnitine (C20:5Crn) |
| 487 | ecspecrn | Mitochondria | eicosapentaenoyl carnitine (C20:5Crn) |
| 488 | ecstea | Cytosol | eicosatrienoate (C20:3) |
| 489 | ecstea | Extra-organism | eicosatrienoate (C20:3) |
| 490 | ecstea6 | Cytosol | eicosatrienoate (C20:3, n-6) |
| 491 | ecstea9 | Cytosol | eicosatrienoate (C20:3, n-9) |
| 492 | ecsttea3 | Cytosol | eicosatetraenoate (C20:4, n-3) |
| 493 | ecsttea6 | Cytosol | eicosatetraenoate (C20:4, n-6) |
| 494 | edcoa | Mitochondria | endecanoyl-CoA (C11:0CoA) |
| 495 | egme | Endoplasmic Reticulum | ecgonine methyl ester |
| 496 | eicostetcoa | Mitochondria | eicosatetranoyl coenzyme A |
| 497 | esdcoa9 | Cytosol | eicosadienoyl-CoA (C20:2CoA, n-9) |
| 498 | esecoa9 | Cytosol | eicosenoyl-CoA (C20:1CoA, n-9) |
| 499 | esecoa9 | Mitochondria | eicosenoyl-CoA (C20:1CoA, n-9) |
| 500 | espcoa3 | Cytosol | eicosapentaenoyl-CoA (C20:5CoA, n-3) |
| 501 | espcoa3 | Mitochondria | eicosapentaenoyl-CoA (C20:5CoA, n-3) |
| 502 | estcoa | Cytosol | eicosatrienoyl-CoA (C20:3CoA) |
| 503 | estcoa | Mitochondria | eicosatrienoyl-CoA (C20:3CoA) |
| 504 | estcoa6 | Cytosol | eicosatrienoyl-CoA (C20:3CoA, n-6) |
| 505 | estcoa6 | Mitochondria | eicosatrienoyl-CoA (C20:3CoA, n-6) |
| 506 | estcoa9 | Cytosol | eicosatrienoyl-CoA (C20:3CoA, n-9) |
| 507 | estcoa9 | Mitochondria | eicosatrienoyl-CoA (C20:3CoA, n-9) |
| 508 | estcrn | Cytosol | eicosatrienoyl carnitine (C20:3Crn) |
| 509 | estcrn | Mitochondria | eicosatrienoyl carnitine (C20:3Crn) |
| 510 | etfox | Mitochondria | Electron transfer flavoprotein oxidized |
| 511 | etfrd | Mitochondria | Electron transfer flavoprotein reduced |
| 512 | etha | Cytosol | Ethanolamine |
| 513 | etha | Extra-organism | Ethanolamine |
| 514 | ethap | Cytosol | Ethanolamine phosphate |
| 515 | ethap | Endoplasmic Reticulum | Ethanolamine phosphate |
| 516 | etoh | Cytosol | Ethanol |
| 517 | etoh | Peroxisome | Ethanol |
| 518 | ettcoa3 | Cytosol | eicosatetraenoyl-CoA (C20:4CoA, n-3) |
| 519 | ettcoa6 | Cytosol | eicosatetraenoyl-CoA (C20:4CoA, n-6) |
| 520 | ettcoa6 | Mitochondria | eicosatetraenoyl-CoA (C20:4CoA, n-6) |
| 521 | f1a | Lysosome | F1alpha |
| 522 | f26bp | Cytosol | D-Fructose 2,6-bisphosphate |
| 523 | f6p | Cytosol | D-Fructose 6-phosphate |
| 524 | facoa_avg_CHO | Cytosol | Averaged fatty acyl CoA, CHO specific |
| 525 | fad | Mitochondria | FAD |
| 526 | fad | Peroxisome | FAD |
| 527 | fadh2 | Mitochondria | FADH2 |
| 528 | fadh2 | Peroxisome | FADH2 |
| 529 | fald | Cytosol | Formaldehyde |
| 530 | fald | Peroxisome | Formaldehyde |
| 531 | fdp | Cytosol | D-Fructose 1,6-bisphosphate |
| 532 | fe2 | Cytosol | Fe2+ |
| 533 | fe2 | Extra-organism | Fe2+ |
| 534 | fe2 | Mitochondria | Fe2+ |
| 535 | fgam | Cytosol | N2-Formyl-N1-(5-phospho-D-ribosyl)glycinamide |
| 536 | ficytcc | Mitochondria | Ferricytochrome c |
| 537 | fmn | Cytosol | flavin mononucleotide |
| 538 | focytcc | Mitochondria | Ferrocytochrome c |
| 539 | fol | Cytosol | Folate |
| 540 | fol | Extra-organism | Folate |
| 541 | for | Cytosol | Formate |
| 542 | for | Endoplasmic Reticulum | Formate |
| 543 | for | Extra-organism | Formate |
| 544 | for | Mitochondria | Formate |
| 545 | for | Nucleus | Formate |
| 546 | forglu | Cytosol | N-Formimidoyl-L-glutamate |
| 547 | fpram | Cytosol | 2-(Formamido)-N1-(5-phospho-D- |
| | | | ribosyl)acetamidine |
| 548 | fprica | Cytosol | 5-Formamido-1-(5-phospho-D-ribosyl)imidazole-4- |
| | | | carboxamide |
| 549 | frdp | Cytosol | Farnesyl diphosphate |
| 550 | frdp | Endoplasmic Reticulum | Farnesyl diphosphate |
| 551 | fuc-L | Lysosome | L-Fucose |
| 552 | fum | Cytosol | Fumarate |
| 553 | fum | Mitochondria | Fumarate |
| 554 | g1m8mpdol | Endoplasmic Reticulum | alpha-D-Glucosyl-(alpha-D-mannosyl)8-beta-D- |
| | | | mannosyl-diacetylchitobiosyldiphosphodolichol, |
| | | | mammal |
| 555 | g1p | Cytosol | D-Glucose 1-phosphate |
| 556 | g2m8m | Endoplasmic Reticulum | (alpha-D-Glucosyl)2-(alpha-D-mannosyl)8-beta-D- |
| | | | mannosyl-diacetylchitobiose |
| 557 | g2m8mpdol | Endoplasmic Reticulum | (alpha-D-Glucosyl)2-(alpha-D-mannosyl)8-beta-D- |
| | | | mannosyl-diacetylchitobiosyldiphosphodolichol, |
| | | | mammal |
| 558 | g3m8m | Endoplasmic Reticulum | (alpha-D-Glucosyl)3-(alpha-D-mannosyl)8-beta-D- |
| | | | mannosyl-diacetylchitobiose |
| 559 | g3m8mpdol | Endoplasmic Reticulum | (alpha-D-Glucosyl)3-(alpha-D-mannosyl)8-beta-D- |
| | | | mannosyl-diacetylchitobiosyldiphosphodolichol, |
| | | | mammal |
| 560 | g3p | Cytosol | Glyceraldehyde 3-phosphate |
| 561 | g6p | Cytosol | D-Glucose 6-phosphate |
| 562 | g6p | Endoplasmic Reticulum | D-Glucose 6-phosphate |
| 563 | gal | Cytosol | D-Galactose |
| 564 | gal | Lysosome | D-Galactose |
| 565 | gal1p | Cytosol | alpha-D-Galactose 1-phosphate |
| 566 | gam | Cytosol | D-Glucosamine |
| 567 | gam6p | Cytosol | D-Glucosamine 6-phosphate |
| 568 | gar | Cytosol | N1-(5-Phospho-D-ribosyl)glycinamide |
| 569 | gcald | Mitochondria | Glycolaldehyde |
| 570 | gdp | Cytosol | GDP |
| 571 | gdp | Golgi Apparatus | GDP |
| 572 | gdp | Mitochondria | GDP |
| 573 | gdp | Nucleus | GDP |
| 574 | gdpddm | Cytosol | GDP-4-dehydro-6-deoxy-D-mannose |
| 575 | gdpfuc | Cytosol | GDP-L-fucose |
| 576 | gdpfuc | Golgi Apparatus | GDP-L-fucose |
| 577 | gdpman | Cytosol | GDP-D-mannose |
| 578 | glc-D | Cytosol | D-Glucose |
| 579 | glc-D | Endoplasmic Reticulum | D-Glucose |
| 580 | glc-D | Extra-organism | D-Glucose |
| 581 | glc-D | Lysosome | D-Glucose |
| 582 | glcur | Lysosome | D-Glucuronate |
| 583 | gln-L | Cytosol | L-Glutamine |
| 584 | gln-L | Extra-organism | L-Glutamine |
| 585 | gln-L | Mitochondria | L-Glutamine |
| 586 | glu-L | Cytosol | L-Glutamate |
| 587 | glu-L | Extra-organism | L-Glutamate |
| 588 | glu-L | Mitochondria | L-Glutamate |
| 589 | glu5p | Mitochondria | L-Glutamate 5-phosphate |
| 590 | glu5sa | Cytosol | L-Glutamate 5-semialdehyde |
| 591 | glu5sa | Mitochondria | L-Glutamate 5-semialdehyde |
| 592 | gluala | Extra-organism | (5-L-Glutamyl)-L-amino acid |
| 593 | glucys | Cytosol | gamma-L-Glutamyl-L-cysteine |
| 594 | glutcoa | Mitochondria | Glutaryl-CoA |
| 595 | glx | Cytosol | Glyoxylate |
| 596 | glx | Mitochondria | Glyoxylate |
| 597 | gly | Cytosol | Glycine |
| 598 | gly | Extra-organism | Glycine |
| 599 | gly | Mitochondria | Glycine |
| 600 | gly | Peroxisome | Glycine |
| 601 | glyc | Cytosol | Glycerol |
| 602 | glyc | Mitochondria | Glycerol |
| 603 | glyc-S | Cytosol | (S)-Glycerate |
| 604 | glyc3p | Cytosol | sn-Glycerol 3-phosphate |
| 605 | glyc3p | Mitochondria | sn-Glycerol 3-phosphate |
| 606 | glyclt | Mitochondria | Glycolate |
| 607 | glycogen | Cytosol | glycogen |
| 608 | glygn1 | Cytosol | glycogen, structure 1 (glycogenin-11[1,4-Glc]) |
| 609 | glygn2 | Cytosol | glycogen, structure 2 (glycogenin-1,6-{7[1,4-Glc], |
| | | | 4[1,4-Glc]}) |
| 610 | glygn3 | Cytosol | glycogen, structure 3 (glycogenin-7[1,4-Glc]) |
| 611 | gmp | Cytosol | GMP |
| 612 | gmp | Golgi Apparatus | GMP |
| 613 | grdp | Cytosol | Geranyl diphosphate |
| 614 | gsn | Cytosol | Guanosine |
| 615 | gthox | Cytosol | Oxidized glutathione |
| 616 | gthox | Mitochondria | Oxidized glutathione |
| 617 | gthrd | Cytosol | Reduced glutathione |
| 618 | gthrd | Mitochondria | Reduced glutathione |
| 619 | gtp | Cytosol | GTP |
| 620 | gtp | Mitochondria | GTP |
| 621 | gtp | Nucleus | GTP |
| 622 | gua | Cytosol | Guanine |
| 623 | h | Cytosol | H+ |
| 624 | h | Endoplasmic Reticulum | H+ |
| 625 | h | Extra-organism | H+ |
| 626 | h | Golgi Apparatus | H+ |
| 627 | h | Lysosome | H+ |
| 628 | h | Mitochondria | H+ |
| 629 | h | Nucleus | H+ |
| 630 | h | Peroxisome | H+ |
| 631 | h2o | Cytosol | H2O |
| 632 | h2o | Endoplasmic Reticulum | H2O |
| 633 | h2o | Extra-organism | H2O |
| 634 | h2o | Golgi Apparatus | H2O |
| 635 | h2o | Lysosome | H2O |
| 636 | h2o | Mitochondria | H2O |
| 637 | h2o | Nucleus | H2O |
| 638 | h2o | Peroxisome | H2O |
| 639 | h2o2 | Cytosol | Hydrogen peroxide |
| 640 | h2o2 | Mitochondria | Hydrogen peroxide |
| 641 | h2o2 | Nucleus | Hydrogen peroxide |
| 642 | h2o2 | Peroxisome | Hydrogen peroxide |
| 643 | ha | Lysosome | hyaluronan |
| 644 | ha_deg1 | Lysosome | hyaluronan degradation product 1 |
| 645 | ha_pre1 | Lysosome | hyaluronan biosynthesis, precursor 1 |
| 646 | hco3 | Cytosol | Bicarbonate |
| 647 | hco3 | Mitochondria | Bicarbonate |
| 648 | hcys-L | Cytosol | L-Homocysteine |
| 649 | hdca | Cytosol | hexadecanoate (n-C16:0) |
| 650 | hdca | Endoplasmic Reticulum | hexadecanoate (n-C16:0) |
| 651 | hdca | Extra-organism | hexadecanoate (n-C16:0) |
| 652 | hdca | Peroxisome | hexadecanoate (n-C16:0) |
| 653 | hdcea | Cytosol | hexadecenoate (n-C16:1) |
| 654 | hdcea | Extra-organism | hexadecenoate (n-C16:1) |
| 655 | hdcea7 | Cytosol | hexadecenoate (C16:1, n-7) |
| 656 | hdcecrn | Cytosol | Hexadecenoyl carnitine |
| 657 | hdcecrn | Mitochondria | Hexadecenoyl carnitine |
| 658 | hdcoa | Cytosol | Hexadecenoyl-CoA (n-C16:1CoA) |
| 659 | hdcoa | Mitochondria | Hexadecenoyl-CoA (n-C16:1CoA) |
| 660 | hdcoa7 | Cytosol | hexadecenoyl-CoA (C16:1CoA, n-7) |
| 661 | hdcoa7 | Mitochondria | hexadecenoyl-CoA (C16:1CoA, n-7) |
| 662 | hdd2coa | Mitochondria | trans-Hexadec-2-enoyl-CoA |
| 663 | hexccoa | Peroxisome | Hexacosanoyl-CoA (n-C26:0CoA) |
| 664 | hgentis | Cytosol | Homogentisate |
| 665 | hibcoa | Mitochondria | (S)-3-Hydroxyisobutyryl-CoA |
| 666 | hibcoa_#1 | Mitochondria | (S)-3-Hydroxyisobutyryl-CoA |
| 667 | hindoald | Cytosol | 5-Hydroxyindoleacetaldehyde |
| 668 | his-L | Cytosol | L-Histidine |
| 669 | his-L | Extra-organism | L-Histidine |
| 670 | hkyn | Cytosol | 3-Hydroxy-L-kynurenine |
| 671 | hkyn_#1 | Cytosol | 3-Hydroxy-L-kynurenine |
| 672 | hkyna | Cytosol | 3-Hydroxykynurenamine |
| 673 | hmbil | Cytosol | Hydroxymethylbilane |
| 674 | hmgcoa | Cytosol | Hydroxymethylglutaryl-CoA |
| 675 | hmgcoa | Endoplasmic Reticulum | Hydroxymethylglutaryl-CoA |
| 676 | hmgcoa | Mitochondria | Hydroxymethylglutaryl-CoA |
| 677 | hmgcoa | Peroxisome | Hydroxymethylglutaryl-CoA |
| 678 | hom-L | Cytosol | L-Homoserine |
| 679 | hom-L | Extra-organism | L-Homoserine |
| 680 | hpacald | Cytosol | 4-Hydroxyphenylacetaldehyde |
| 681 | hpcoa | Mitochondria | heptanoyl-CoA (C7:0CoA) |
| 682 | hpdca | Cytosol | heptadecanoate (C17:0) |
| 683 | hpdcoa | Cytosol | heptadecanoyl CoA (C17:0CoA) |
| 684 | hpdcoa | Mitochondria | heptadecanoyl CoA (C17:0CoA) |
| 685 | hpyr | Cytosol | Hydroxypyruvate |
| 686 | hs | Lysosome | heparan sulfate, free chain |
| 687 | hs_deg1 | Lysosome | heparan sulfate, degradation product 1 |
| 688 | hs_deg10 | Lysosome | heparan sulfate, degradation product 10 |
| 689 | hs_deg11 | Lysosome | heparan sulfate, degradation product 11 |
| 690 | hs_deg12 | Lysosome | heparan sulfate, degradation product 12 |
| 691 | hs_deg13 | Lysosome | heparan sulfate, degradation product 13 |
| 692 | hs_deg18 | Lysosome | heparan sulfate, degradation product 18 |
| 693 | hs_deg19 | Lysosome | heparan sulfate, degradation product 19 |
| 694 | hs_deg2 | Lysosome | heparan sulfate, degradation product 2 |
| 695 | hs_deg5 | Lysosome | heparan sulfate, degradation product 5 |
| 696 | hs_deg6 | Lysosome | heparan sulfate, degradation product 6 |
| 697 | hs_deg7 | Lysosome | heparan sulfate, degradation product 7 |
| 698 | hs_deg9 | Lysosome | heparan sulfate, degradation product 9 |
| 699 | hxa | Cytosol | Hexanoate |
| 700 | hxan | Cytosol | Hypoxanthine |
| 701 | hxan | Extra-organism | Hypoxanthine |
| 702 | hxcoa | Mitochondria | Hexanoyl-CoA (C6:0CoA) |
| 703 | hxdcal | Endoplasmic Reticulum | Hexadecanal |
| 704 | hyptaur | Cytosol | Hypotaurine |
| 705 | ibcoa | Mitochondria | Isobutyryl-CoA |
| 706 | icit | Cytosol | Isocitrate |
| 707 | icit | Mitochondria | Isocitrate |
| 708 | id3acald | Cytosol | Indole-3-acetaldehyde |
| 709 | idp | Cytosol | IDP |
| 710 | idp | Nucleus | IDP |
| 711 | ile-L | Cytosol | L-Isoleucine |
| 712 | ile-L | Extra-organism | L-Isoleucine |
| 713 | ile-L | Mitochondria | L-Isoleucine |
| 714 | ilnlc | Cytosol | isolinoleic acid (C18:2, n-9) |
| 715 | ilnlcoa | Cytosol | isolinoleoyl-CoA (C18:2CoA, n-9) |
| 716 | imp | Cytosol | IMP |
| 717 | inost | Cytosol | myo-Inositol |
| 718 | inost | Extra-organism | myo-Inositol |
| 719 | ins | Cytosol | Inosine |
| 720 | ins | Extra-organism | Inosine |
| 721 | ipdp | Cytosol | Isopentenyl diphosphate |
| 722 | ipdp | Peroxisome | Isopentenyl diphosphate |
| 723 | itaccoa | Mitochondria | Itaconyl-CoA |
| 724 | itacon | Mitochondria | Itaconate |
| 725 | itp | Cytosol | ITP |
| 726 | itp | Nucleus | ITP |
| 727 | ivcoa | Mitochondria | Isovaleryl-CoA |
| 728 | k | Cytosol | K+ |
| 729 | k | Golgi Apparatus | K+ |
| 730 | kdnp | Cytosol | 2-keto-3-deoxy-D-glycero-D-galactononic acid 9- |
| | | | phosphate |
| 731 | ksi | Lysosome | keratan sulfate I |
| 732 | ksi_deg1 | Lysosome | keratan sulfate I, degradation product 1 |
| 733 | ksi_deg10 | Lysosome | keratan sulfate I, degradation product 10 |
| 734 | ksi_deg11 | Lysosome | keratan sulfate I, degradation product 11 |
| 735 | ksi_deg12 | Lysosome | keratan sulfate I, degradation product 12 |
| 736 | ksi_deg13 | Lysosome | keratan sulfate I, degradation product 13 |
| 737 | ksi_deg14 | Lysosome | keratan sulfate I, degradation product 14 |
| 738 | ksi_deg15 | Lysosome | keratan sulfate I, degradation product 15 |
| 739 | ksi_deg16 | Lysosome | keratan sulfate I, degradation product 16 |
| 740 | ksi_deg17 | Lysosome | keratan sulfate I, degradation product 17 |
| 741 | ksi_deg18 | Lysosome | keratan sulfate I, degradation product 18 |
| 742 | ksi_deg19 | Lysosome | keratan sulfate I, degradation product 19 |
| 743 | ksi_deg2 | Lysosome | keratan sulfate I, degradation product 2 |
| 744 | ksi_deg20 | Lysosome | keratan sulfate I, degradation product 20 |
| 745 | ksi_deg21 | Lysosome | keratan sulfate I, degradation product 21 |
| 746 | ksi_deg22 | Lysosome | keratan sulfate I, degradation product 22 |
| 747 | ksi_deg23 | Lysosome | keratan sulfate I, degradation product 23 |
| 748 | ksi_deg24 | Lysosome | keratan sulfate I, degradation product 24 |
| 749 | ksi_deg25 | Lysosome | keratan sulfate I, degradation product 25 |
| 750 | ksi_deg26 | Lysosome | keratan sulfate I, degradation product 26 |
| 751 | ksi_deg27 | Lysosome | keratan sulfate I, degradation product 27 |
| 752 | ksi_deg28 | Lysosome | keratan sulfate I, degradation product 28 |
| 753 | ksi_deg29 | Lysosome | keratan sulfate I, degradation product 29 |
| 754 | ksi_deg3 | Lysosome | keratan sulfate I, degradation product 3 |
| 755 | ksi_deg30 | Lysosome | keratan sulfate I, degradation product 30 |
| 756 | ksi_deg31 | Lysosome | keratan sulfate I, degradation product 31 |
| 757 | ksi_deg32 | Lysosome | keratan sulfate I, degradation product 32 |
| 758 | ksi_deg33 | Lysosome | keratan sulfate I, degradation product 33 |
| 759 | ksi_deg34 | Lysosome | keratan sulfate I, degradation product 34 |
| 760 | ksi_deg35 | Lysosome | keratan sulfate I, degradation product 35 |
| 761 | ksi_deg36 | Lysosome | keratan sulfate I, degradation product 36 |
| 762 | ksi_deg37 | Lysosome | keratan sulfate I, degradation product 37 |
| 763 | ksi_deg38 | Lysosome | keratan sulfate I, degradation product 38 |
| 764 | ksi_deg39 | Lysosome | keratan sulfate I, degradation product 39 |
| 765 | ksi_deg4 | Lysosome | keratan sulfate I, degradation product 4 |
| 766 | ksi_deg40 | Lysosome | keratan sulfate I, degradation product 40 |
| 767 | ksi_deg41 | Lysosome | keratan sulfate I, degradation product 41 |
| 768 | ksi_deg5 | Lysosome | keratan sulfate I, degradation product 5 |
| 769 | ksi_deg6 | Lysosome | keratan sulfate I, degradation product 6 |
| 770 | ksi_deg7 | Lysosome | keratan sulfate I, degradation product 7 |
| 771 | ksi_deg8 | Lysosome | keratan sulfate I, degradation product 8 |
| 772 | ksi_deg9 | Lysosome | keratan sulfate I, degradation product 9 |
| 773 | ksii_core2 | Lysosome | keratan sulfate II (core 2-linked) |
| 774 | ksii_core2_deg1 | Lysosome | keratan sulfate II (core 2-linked), degradation |
| | | | product 1 |
| 775 | ksii_core2_deg2 | Lysosome | keratan sulfate II (core 2-linked), degradation |
| | | | product 2 |
| 776 | ksii_core2_deg3 | Lysosome | keratan sulfate II (core 2-linked), degradation |
| | | | product 3 |
| 777 | ksii_core2_deg4 | Lysosome | keratan sulfate II (core 2-linked), degradation |
| | | | product 4 |
| 778 | ksii_core2_deg5 | Lysosome | keratan sulfate II (core 2-linked), degradation |
| | | | product 5 |
| 779 | ksii_core2_deg6 | Lysosome | keratan sulfate II (core 2-linked), degradation |
| | | | product 6 |
| 780 | ksii_core2_deg7 | Lysosome | keratan sulfate II (core 2-linked), degradation |
| | | | product 7 |
| 781 | ksii_core2_deg8 | Lysosome | keratan sulfate II (core 2-linked), degradation |
| | | | product 8 |
| 782 | ksii_core2_deg9 | Lysosome | keratan sulfate II (core 2-linked), degradation |
| | | | product 9 |
| 783 | ksii_core4 | Lysosome | keratan sulfate II (core 4-linked) |
| 784 | ksii_core4_deg1 | Lysosome | keratan sulfate II (core 4-linked), degradation |
| | | | product 1 |
| 785 | ksii_core4_deg2 | Lysosome | keratan sulfate II (core 4-linked), degradation |
| | | | product 2 |
| 786 | ksii_core4_deg3 | Lysosome | keratan sulfate II (core 4-linked), degradation |
| | | | product 3 |
| 787 | ksii_core4_deg4 | Lysosome | keratan sulfate II (core 4-linked), degradation |
| | | | product 4 |
| 788 | kynr-L | Cytosol | L-Kynurenine |
| 789 | l2n2m2mn | Lysosome | de-Fuc, reducing GlcNAc removed, de-Sia form of |
| | | | PA6 (w/o peptide linkage) |
| 790 | lac-D | Mitochondria | D-Lactate |
| 791 | lac-L | Cytosol | L-Lactate |
| 792 | lac-L | Extra-organism | L-Lactate |
| 793 | lac-L | Mitochondria | L-Lactate |
| 794 | lald-D | Cytosol | D-Lactaldehyde |
| 795 | lald-D | Mitochondria | D-Lactaldehyde |
| 796 | lald-L | Cytosol | L-Lactaldehyde |
| 797 | lald-L | Mitochondria | L-Lactaldehyde |
| 798 | lanost | Endoplasmic Reticulum | Lanosterol |
| 799 | lathost | Endoplasmic Reticulum | Lathosterol |
| 800 | lcts | Lysosome | Lactose |
| 801 | Lcyst | Cytosol | L-Cysteate |
| 802 | Lcyst | Mitochondria | L-Cysteate |
| 803 | leu-L | Cytosol | L-Leucine |
| 804 | leu-L | Extra-organism | L-Leucine |
| 805 | leu-L | Mitochondria | L-Leucine |
| 806 | Lfmkynr | Cytosol | L-Formylkynurenine |
| 807 | lgnccoa | Cytosol | lignocericyl coenzyme A |
| 808 | lgnccoa | Mitochondria | lignocericyl coenzyme A |
| 809 | lgnccoa | Peroxisome | lignocericyl coenzyme A |
| 810 | lgnccrn | Cytosol | lignoceryl carnitine |
| 811 | lgnccrn | Mitochondria | lignoceryl carnitine |
| 812 | lneldccoa | Mitochondria | linoelaidyl coenzyme A (C18:2CoA) |
| 813 | lnlccoa | Mitochondria | linoleic coenzyme A (C18:2CoA) |
| 814 | lnlecoa | Cytosol | Linolenoyl-CoA (C18:3CoA) |
| 815 | lnlecoa | Mitochondria | Linolenoyl-CoA (C18:3CoA) |
| 816 | lnlecrn | Cytosol | linolenoyl carnitine (C18:3Crn) |
| 817 | lnlecrn | Mitochondria | linolenoyl carnitine (C18:3Crn) |
| 818 | lnlncacoa | Mitochondria | alpha-Linolenoyl-CoA (C18:3CoA, n-3) |
| 819 | lnlncgcoa | Mitochondria | gamma-linolenoyl-CoA (C18:3CoA, n-6) |
| 820 | lnlncgcoa | Peroxisome | gamma-linolenoyl-CoA (C18:3CoA, n-6) |
| 821 | lnlne | Cytosol | Linolenic acid (C18:3) |
| 822 | lnlne | Extra-organism | Linolenic acid (C18:3) |
| 823 | lpam | Mitochondria | Lipoamide |
| 824 | lpro | Mitochondria | Lipoylprotein |
| 825 | Lsacchrp | Mitochondria | L-Saccharopine |
| 826 | lys-L | Cytosol | L-Lysine |
| 827 | lys-L | Extra-organism | L-Lysine |
| 828 | lys-L | Mitochondria | L-Lysine |
| 829 | m1mpdol | Cytosol | alpha-D-mannosyl-beta-D-mannosyl- |
| | | | diacylchitobiosyldiphosphodolichol, mammals |
| 830 | m2mn | Cytosol | (alpha-D-mannosyl)2-beta-D-mannosyl-N- |
| | | | acetylglucosamine |
| 831 | m2mn | Lysosome | (alpha-D-mannosyl)2-beta-D-mannosyl-N- |
| | | | acetylglucosamine |
| 832 | m2mpdol | Cytosol | (alpha-D-mannosyl)2-beta-D-mannosyl- |
| | | | diacetylchitobiosyldiphosphodolichol, mammals |
| 833 | m3mpdol | Cytosol | (alpha-D-mannosyl)3-beta-D-mannosyl- |
| | | | diacetylchitodiphosphodolichol, mammals |
| 834 | m4m | Golgi Apparatus | (alpha-D-mannosyl)4-beta-D-mannosyl- |
| | | | diacetylchitobiose |
| 835 | m4mpdol | Cytosol | (alpha-D-Mannosyl)4-beta-D-mannosyl- |
| | | | diacetylchitobiosyldiphosphodolichol, mammals |
| 836 | m4mpdol | Endoplasmic Reticulum | (alpha-D-Mannosyl)4-beta-D-mannosyl- |
| | | | diacetylchitobiosyldiphosphodolichol, mammals |
| 837 | m5m | Golgi Apparatus | (alpha-D-mannosyl)5-beta-D-mannosyl- |
| | | | diacetylchitobiose |
| 838 | m5mpdol | Endoplasmic Reticulum | (alpha-D-Mannosyl)5-beta-D-mannosyl- |
| | | | diacetylchitobiosyldiphosphodolichol, mammals |
| 839 | m6m | Golgi Apparatus | (alpha-D-mannosyl)6-beta-D-mannosyl- |
| | | | diacetylchitobiose |
| 840 | m6mpdol | Endoplasmic Reticulum | (alpha-D-Mannosyl)6-beta-D-mannosyl- |
| | | | diacetylchitobiosyldiphosphodolichol, mammals |
| 841 | m7m | Endoplasmic Reticulum | (alpha-D-mannosyl)7-beta-D-mannosyl- |
| | | | diacetylchitobiose |
| 842 | m7m | Golgi Apparatus | (alpha-D-mannosyl)7-beta-D-mannosyl- |
| | | | diacetylchitobiose |
| 843 | m7mpdol | Endoplasmic Reticulum | (alpha-D-Mannosyl)7-beta-D-mannosyl- |
| | | | diacetylchitobiosyldiphosphodolichol, mammals |
| 844 | m8m | Endoplasmic Reticulum | (alpha-D-mannosyl)8-beta-D-mannosyl- |
| | | | diacetylchitobiose |
| 845 | m8m | Golgi Apparatus | (alpha-D-mannosyl)8-beta-D-mannosyl- |
| | | | diacetylchitobiose |
| 846 | m8mpdol | Endoplasmic Reticulum | (alpha-D-Mannosyl)8-beta-D-mannosyl- |
| | | | diacetylchitobiosyldiphosphodolichol, mammals |
| 847 | mal-L | Cytosol | L-Malate |
| 848 | mal-L | Mitochondria | L-Malate |
| 849 | malACP | Cytosol | Malonyl-[acyl-carrier protein] |
| 850 | malACP | Mitochondria | Malonyl-[acyl-carrier protein] |
| 851 | malcoa | Cytosol | Malonyl-CoA |
| 852 | malcoa | Mitochondria | Malonyl-CoA |
| 853 | malt | Cytosol | Maltose |
| 854 | malt | Lysosome | Maltose |
| 855 | malttr | Cytosol | Maltotriose |
| 856 | malttr | Lysosome | Maltotriose |
| 857 | man | Cytosol | D-Mannose |
| 858 | man | Endoplasmic Reticulum | D-Mannose |
| 859 | man | Golgi Apparatus | D-Mannose |
| 860 | man | Lysosome | D-Mannose |
| 861 | man1p | Cytosol | D-Mannose 1-phosphate |
| 862 | man6p | Cytosol | D-Mannose 6-phosphate |
| 863 | meoh | Cytosol | Methanol |
| 864 | meoh | Endoplasmic Reticulum | Methanol |
| 865 | mercplac | Cytosol | 3-Mercaptolactate |
| 866 | mercppyr | Cytosol | Mercaptopyruvate |
| 867 | mercppyr | Mitochondria | Mercaptopyruvate |
| 868 | mescoa | Mitochondria | Mesaconyl-CoA |
| 869 | mescon | Mitochondria | Mesaconate |
| 870 | met-L | Cytosol | L-Methionine |
| 871 | met-L | Extra-organism | L-Methionine |
| 872 | methf | Cytosol | 5,10-Methenyltetrahydrofolate |
| 873 | methf | Mitochondria | 5,10-Methenyltetrahydrofolate |
| 874 | mev-R | Cytosol | (R)-Mevalonate |
| 875 | mev-R | Endoplasmic Reticulum | (R)-Mevalonate |
| 876 | mev-R | Peroxisome | (R)-Mevalonate |
| 877 | mglyc_CHO | Cytosol | monoacylglycerol, CHO specific |
| 878 | mhpacd | Cytosol | 3-Methoxy-4-hydroxyphenylacetaldehyde |
| 879 | mhpgald | Cytosol | 3-Methoxy-4-hydroxyphenylglycolaldehyde |
| 880 | mi1p-D | Cytosol | 1D-myo-Inositol 1-phosphate |
| 881 | mizoac | Cytosol | 3-Methylimidazoleacetic acid |
| 882 | mizoacd | Cytosol | 3-Methylimidazole acetaldehyde |
| 883 | mlthf | Cytosol | 5,10-Methylenetetrahydrofolate |
| 884 | mlthf | Mitochondria | 5,10-Methylenetetrahydrofolate |
| 885 | mma | Cytosol | Methylamine |
| 886 | mmal | Cytosol | Methylmalonate |
| 887 | mmal | Mitochondria | Methylmalonate |
| 888 | mmalsa-S | Cytosol | (S)-Methylmalonate semialdehyde |
| 889 | mmalsa-S | Mitochondria | (S)-Methylmalonate semialdehyde |
| 890 | mmcoa-R | Mitochondria | (R)-Methylmalonyl-CoA |
| 891 | mmcoa-S | Mitochondria | (S)-Methylmalonyl-CoA |
| 892 | mn | Cytosol | beta-1,4-mannose-N-acetylglucosamine |
| 893 | mn | Lysosome | beta-1,4-mannose-N-acetylglucosamine |
| 894 | mpdol | Cytosol | beta-D- |
| | | | Mannosyldiacetylchitobiosyldiphosphodolichol, |
| | | | mammals |
| 895 | mthgxl | Cytosol | Methylglyoxal |
| 896 | mxtyrm | Cytosol | 3-Methoxytyramine |
| 897 | N-bi | Cytosol | Gal b1-4 GlcNAc b1-2 Man a1-3(Gal b1- |
| | | | 4 GlcNAc b1-2 Man a1-6) Man b1-4 GlcNAc b1- |
| | | | 4(Fuc a1-6) GlcNAcOH |
| 898 | N-bi | Extra-organism | Gal b1-4 GlcNAc b1-2 Man a1-3(Gal b1- |
| | | | 4 GlcNAc b1-2 Man a1-6) Man b1-4 GlcNAc b1- |
| | | | 4(Fuc a1-6) GlcNAcOH |
| 899 | N-bi | Golgi Apparatus | Gal b1-4 GlcNAc b1-2 Man a1-3(Gal b1- |
| | | | 4 GlcNAc b1-2 Man a1-6) Man b1-4 GlcNAc b1- |
| | | | 4(Fuc a1-6) GlcNAcOH |
| 900 | N-biS1 | Cytosol | Gal b1-4 GlcNAc b1-2 Man a1-3(NeuAc a2-3 |
| | | | Gal b1-4 GlcNAc b1-2 Man a1-6) Man b1- |
| | | | 4 GlcNAc b1-4(Fuc a1-6) GlcNAcOH |
| 901 | N-biS1 | Extra-organism | Gal b1-4 GlcNAc b1-2 Man a1-3(NeuAc a2-3 |
| | | | Gal b1-4 GlcNAc b1-2 Man a1-6) Man b1- |
| | | | 4 GlcNAc b1-4(Fuc a1-6) GlcNAcOH |
| 902 | N-biS1 | Golgi Apparatus | Gal b1-4 GlcNAc b1-2 Man a1-3(NeuAc a2-3 |
| | | | Gal b1-4 GlcNAc b1-2 Man a1-6) Man b1- |
| | | | 4 GlcNAc b1-4(Fuc a1-6) GlcNAcOH |
| 903 | N-tetra/N-triLac1 | Cytosol | Gal b1-4 GlcNAc b1-2(Gal b1-4 GlcNAc b1- |
| | | | 4) Man a1-3(Gal b1-4 GlcNAc b1-2(Gal b1- |
| | | | 4 GlcNAc b1-6) Man a1-6) Man b1-4 GlcNAc b1- |
| | | | 4(Fuc a1-6) GlcNAcOH |
| 904 | N-tetra/N-triLac1 | Extra-organism | Gal b1-4 GlcNAc b1-2(Gal b1-4 GlcNAc b1- |
| | | | 4) Man a1-3(Gal b1-4 GlcNAc b1-2(Gal b1- |
| | | | 4 GlcNAc b1-6) Man a1-6) Man b1-4 GlcNAc b1- |
| | | | 4(Fuc a1-6) GlcNAcOH |
| 905 | N-tetra/N-triLac1 | Golgi Apparatus | Gal b1-4 GlcNAc b1-2(Gal b1-4 GlcNAc b1- |
| | | | 4) Man a1-3(Gal b1-4 GlcNAc b1-2(Gal b1- |
| | | | 4 GlcNAc b1-6) Man a1-6) Man b1-4 GlcNAc b1- |
| | | | 4(Fuc a1-6) GlcNAcOH |
| 906 | N-tetraLac1 | Cytosol | Gal b1-4 GlcNAc b1-2(Gal b1-4 GlcNAc b1- |
| | | | 4) Man a1-3(Gal b1-4 GlcNAc b1-2(Gal b1- |
| | | | 4 GlcNAc b1-3 Gal b1-4 GlcNAc b1-6) Man a1- |
| | | | 6) Man b1-4 GlcNAc b1-4(Fuc a1-6) GlcNAcOH |
| 907 | N-tetraLac1 | Extra-organism | Gal b1-4 GlcNAc b1-2(Gal b1-4 GlcNAc b1- |
| | | | 4) Man a1-3(Gal b1-4 GlcNAc b1-2(Gal b1- |
| | | | 4 GlcNAc b1-3 Gal b1-4 GlcNAc b1-6) Man a1- |
| | | | 6) Man b1-4 GlcNAc b1-4(Fuc a1-6) GlcNAcOH |
| 908 | N-tetraLac1 | Golgi Apparatus | Gal b1-4 GlcNAc b1-2(Gal b1-4 GlcNAc b1- |
| | | | 4) Man a1-3(Gal b1-4 GlcNAc b1-2(Gal b1- |
| | | | 4 GlcNAc b1-3 Gal b1-4 GlcNAc b1-6) Man a1- |
| | | | 6) Man b1-4 GlcNAc b1-4(Fuc a1-6) GlcNAcOH |
| 909 | N-tetraLac1S1 | Cytosol | Gal b1-4 GlcNAc b1-2(Gal b1-4 GlcNAc b1- |
| | | | 4) Man a1-3(Gal b1-4 GlcNAc b1-2(NeuAc a2- |
| | | | 3 Gal b1-4 GlcNAc b1-3 Gal b1-4 GlcNAc b1- |
| | | | 6) Man a1-6) Man b1-4 GlcNAc b1-4(Fuc a1- |
| | | | 6) GlcNAcOH |
| 910 | N-tetraLac1S1 | Extra-organism | Gal b1-4 GlcNAc b1-2(Gal b1-4 GlcNAc b1- |
| | | | 4) Man a1-3(Gal b1-4 GlcNAc b1-2(NeuAc a2- |
| | | | 3 Gal b1-4 GlcNAc b1-3 Gal b1-4 GlcNAc b1- |
| | | | 6) Man a1-6) Man b1-4 GlcNAc b1-4(Fuc a1- |
| | | | 6) GlcNAcOH |
| 911 | N-tetraLac1S1 | Golgi Apparatus | Gal b1-4 GlcNAc b1-2(Gal b1-4 GlcNAc b1- |
| | | | 4) Man a1-3(Gal b1-4 GlcNAc b1-2(NeuAc a2- |
| | | | 3 Gal b1-4 GlcNAc b1-3 Gal b1-4 GlcNAc b1- |
| | | | 6) Man a1-6) Man b1-4 GlcNAc b1-4(Fuc a1- |
| | | | 6) GlcNAcOH |
| 912 | N-tetraLac1S2 | Cytosol | Gal b1-4 GlcNAc b1-2(Gal b1-4 GlcNAc b1- |
| | | | 4) Man a1-3(NeuAc a2-3 Gal b1-4 GlcNAc b1- |
| | | | 2(NeuAc a2-3 Gal b1-4 GlcNAc b1-3 Gal b1- |
| | | | 4 GlcNAc b1-6) Man a1-6) Man b1-4 GlcNAc b1- |
| | | | 4(Fuc a1-6) GlcNAcOH |
| 913 | N-tetraLac1S2 | Extra-organism | Gal b1-4 GlcNAc b1-2(Gal b1-4 GlcNAc b1- |
| | | | 4) Man a1-3(NeuAc a2-3 Gal b1-4 GlcNAc b1- |
| | | | 2(NeuAc a2-3 Gal b1-4 GlcNAc b1-3 Gal b1- |
| | | | 4 GlcNAc b1-6) Man a1-6) Man b1-4 GlcNAc b1- |
| | | | 4(Fuc a1-6) GlcNAcOH |
| 914 | N-tetraLac1S2 | Golgi Apparatus | Gal b1-4 GlcNAc b1-2(Gal b1-4 GlcNAc b1- |
| | | | 4) Man a1-3(NeuAc a2-3 Gal b1-4 GlcNAc b1- |
| | | | 2(NeuAc a2-3 Gal b1-4 GlcNAc b1-3 Gal b1- |
| | | | 4 GlcNAc b1-6) Man a1-6) Man b1-4 GlcNAc b1- |
| | | | 4(Fuc a1-6) GlcNAcOH |
| 915 | N-tetraLac1S3 | Cytosol | Galb1-4GlcNAcb1-2(NeuAca2-3Galb1-4GlcNAcb1- |
| | | | 4)Mana1-3(NeuAca2-3Galb1-4 GlcNAc b1- |
| | | | 2(NeuAca2-3Galb1-4GlcNAcb1-3Galb1-4GlcNAcb1- |
| | | | 6)Mana1-6)Manb1-4GlcNAcb1-4(Fuc a1- |
| | | | 6)GlcNAcOH |
| 916 | N-tetraLac1S3 | Extra-organism | Galb1-4GlcNAcb1-2(NeuAca2-3Galb1-4GlcNAcb1- |
| | | | 4)Mana1-3(NeuAca2-3Galb1-4 GlcNAc b1- |
| | | | 2(NeuAca2-3Galb1-4GlcNAcb1-3Galb1-4GlcNAcb1- |
| | | | 6)Mana1-6)Manb1-4GlcNAcb1-4(Fuc a1- |
| | | | 6)GlcNAcOH |
| 917 | N-tetraLac1S3 | Golgi Apparatus | Galb1-4GlcNAcb1-2(NeuAca2-3Galb1-4GlcNAcb1- |
| | | | 4)Mana1-3(NeuAca2-3Galb1-4 GlcNAc b1- |
| | | | 2(NeuAca2-3Galb1-4GlcNAcb1-3Galb1-4GlcNAcb1- |
| | | | 6)Mana1-6)Manb1-4GlcNAcb1-4(Fuc a1- |
| | | | 6)GlcNAcOH |
| 918 | N-tetraLac1S4 | Cytosol | NeuAca2-3Galb1-4GlcNAcb1-2(NeuAca2-3Galb1- |
| | | | 4GlcNAcb1-4)Mana1-3(NeuAca2-3Galb1-4 GlcNAc |
| | | | b1-2(NeuAca2-3Galb1-4GlcNAcb1-3Galb1- |
| | | | 4GlcNAcb1-6)Mana1-6)Manb1-4GlcNAcb1- |
| | | | 4(Fuc a1-6)GlcNAcOH |
| 919 | N-tetraLac1S4 | Extra-organism | NeuAca2-3Galb1-4GlcNAcb1-2(NeuAca2-3Galb1- |
| | | | 4GlcNAcb1-4)Mana1-3(NeuAca2-3Galb1-4 GlcNAc |
| | | | b1-2(NeuAca2-3Galb1-4GlcNAcb1-3Galb1- |
| | | | 4GlcNAcb1-6)Mana1-6)Manb1-4GlcNAcb1- |
| | | | 4(Fuc a1-6)GlcNAcOH |
| 920 | N-tetraLac1S4 | Golgi Apparatus | NeuAca2-3Galb1-4GlcNAcb1-2(NeuAca2-3Galb1- |
| | | | 4GlcNAcb1-4)Mana1-3(NeuAca2-3Galb1-4 GlcNAc |
| | | | b1-2(NeuAca2-3Galb1-4GlcNAcb1-3Galb1- |
| | | | 4GlcNAcb1-6)Mana1-6)Manb1-4GlcNAcb1- |
| | | | 4(Fuc a1-6)GlcNAcOH |
| 921 | N-tetraLac2 | Cytosol | Galb1-4GlcNAcb1-2(Galb1-4GlcNAcb1-4)Mana1- |
| | | | 3(Galb1-4GlcNAcb1-3Galb1-4GlcNAcb1-2(Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 922 | N-tetraLac2 | Extra-organism | Galb1-4GlcNAcb1-2(Galb1-4GlcNAcb1-4)Mana1- |
| | | | 3(Galb1-4GlcNAcb1-3Galb1-4GlcNAcb1-2(Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 923 | N-tetraLac2 | Golgi Apparatus | Galb1-4GlcNAcb1-2(Galb1-4GlcNAcb1-4)Mana1- |
| | | | 3(Galb1-4GlcNAcb1-3Galb1-4GlcNAcb1-2(Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 924 | N-tetraLac2S1 | Cytosol | Galb1-4GlcNAcb1-2(Galb1-4GlcNAcb1-4)Mana1- |
| | | | 3(Galb1-4GlcNAcb1-3Galb1-4GlcNAcb1- |
| | | | 2(NeuAca2-3Galb1-4GlcNAcb1-3Galb1-4GlcNAcb1- |
| | | | 6)Mana1-6)Manb1-4GlcNAcb1-4(Fuca1- |
| | | | 6)GlcNAcOH |
| 925 | N-tetraLac2S1 | Extra-organism | Galb1-4GlcNAcb1-2(Galb1-4GlcNAcb1-4)Mana1- |
| | | | 3(Galb1-4GlcNAcb1-3Galb1-4GlcNAcb1- |
| | | | 2(NeuAca2-3Galb1-4GlcNAcb1-3Galb1-4GlcNAcb1- |
| | | | 6)Mana1-6)Manb1-4GlcNAcb1-4(Fuca1- |
| | | | 6)GlcNAcOH |
| 926 | N-tetraLac2S1 | Golgi Apparatus | Galb1-4GlcNAcb1-2(Galb1-4GlcNAcb1-4)Mana1- |
| | | | 3(Galb1-4GlcNAcb1-3Galb1-4GlcNAcb1- |
| | | | 2(NeuAca2-3Galb1-4GlcNAcb1-3Galb1-4GlcNAcb1- |
| | | | 6)Mana1-6)Manb1-4GlcNAcb1-4(Fuca1- |
| | | | 6)GlcNAcOH |
| 927 | N-tetraLac2S2 | Cytosol | Galb1-4GlcNAcb1-2(Galb1-4GlcNAcb1-4)Mana1- |
| | | | 3(NeuAca2-3Galb1-4GlcNAcb1-3Galb1-4GlcNAcb1- |
| | | | 2(NeuAca2-3Galb1-4GlcNAcb1-3Galb1-4GlcNAcb1- |
| | | | 6)Mana1-6)Manb1-4GlcNAcb1-4(Fuca1- |
| | | | 6)GlcNAcOH |
| 928 | N-tetraLac2S2 | Extra-organism | Galb1-4GlcNAcb1-2(Galb1-4GlcNAcb1-4)Mana1- |
| | | | 3(NeuAca2-3Galb1-4GlcNAcb1-3Galb1-4GlcNAcb1- |
| | | | 2(NeuAca2-3Galb1-4GlcNAcb1-3Galb1-4GlcNAcb1- |
| | | | 6)Mana1-6)Manb1-4GlcNAcb1-4(Fuca1- |
| | | | 6)GlcNAcOH |
| 929 | N-tetraLac2S2 | Golgi Apparatus | Galb1-4GlcNAcb1-2(Galb1-4GlcNAcb1-4)Mana1- |
| | | | 3(NeuAca2-3Galb1-4GlcNAcb1-3Galb1-4GlcNAcb1- |
| | | | 2(NeuAca2-3Galb1-4GlcNAcb1-3Galb1-4GlcNAcb1- |
| | | | 6)Mana1-6)Manb1-4GlcNAcb1-4(Fuca1- |
| | | | 6)GlcNAcOH |
| 930 | N-tetraLac2S3 | Cytosol | Galb1-4GlcNAcb1-2(NeuAca2-3Galb1-4GlcNAcb1- |
| | | | 4)Mana1-3(NeuAca2-3Galb1-4GlcNAcb1-3Galb1- |
| | | | 4GlcNAcb1-2(NeuAca2-3Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 931 | N-tetraLac2S3 | Extra-organism | Galb1-4GlcNAcb1-2(NeuAca2-3Galb1-4GlcNAcb1- |
| | | | 4)Mana1-3(NeuAca2-3Galb1-4GlcNAcb1-3Galb1- |
| | | | 4GlcNAcb1-2(NeuAca2-3Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 932 | N-tetraLac2S3 | Golgi Apparatus | Galb1-4GlcNAcb1-2(NeuAca2-3Galb1-4GlcNAcb1- |
| | | | 4)Mana1-3(NeuAca2-3Galb1-4GlcNAcb1-3Galb1- |
| | | | 4GlcNAcb1-2(NeuAca2-3Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 933 | N-tetraLac2S4 | Cytosol | NeuAca2-3Galb1-4GlcNAcb1-2(NeuAca2-3Galb1- |
| | | | 4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 934 | N-tetraLac2S4 | Extra-organism | NeuAca2-3Galb1-4GlcNAcb1-2(NeuAca2-3Galb1- |
| | | | 4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 935 | N-tetraLac2S4 | Golgi Apparatus | NeuAca2-3Galb1-4GlcNAcb1-2(NeuAca2-3Galb1- |
| | | | 4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 936 | N-tetraLac3 | Cytosol | Galb1-4GlcNAcb1-2(Galb1-4GlcNAcb1-3Galb1- |
| | | | 4GlcNAcb1-4)Mana1-3(Galb1-4GlcNAcb1-3Galb1- |
| | | | 4GlcNAcb1-2(Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 937 | N-tetraLac3 | Extra-organism | Galb1-4GlcNAcb1-2(Galb1-4GlcNAcb1-3Galb1- |
| | | | 4GlcNAcb1-4)Mana1-3(Galb1-4GlcNAcb1-3Galb1- |
| | | | 4GlcNAcb1-2(Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 938 | N-tetraLac3 | Golgi Apparatus | Galb1-4GlcNAcb1-2(Galb1-4GlcNAcb1-3Galb1- |
| | | | 4GlcNAcb1-4)Mana1-3(Galb1-4GlcNAcb1-3Galb1- |
| | | | 4GlcNAcb1-2(Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 939 | N-tetraLac3S1 | Cytosol | Galb1-4GlcNAcb1-2(Galb1-4GlcNAcb1-3Galb1- |
| | | | 4GlcNAcb1-4)Mana1-3(Galb1-4GlcNAcb1-3Galb1- |
| | | | 4GlcNAcb1-2(NeuAca2-3Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 940 | N-tetraLac3S1 | Extra-organism | Galb1-4GlcNAcb1-2(Galb1-4GlcNAcb1-3Galb1- |
| | | | 4GlcNAcb1-4)Mana1-3(Galb1-4GlcNAcb1-3Galb1- |
| | | | 4GlcNAcb1-2(NeuAca2-3Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 941 | N-tetraLac3S1 | Golgi Apparatus | Galb1-4GlcNAcb1-2(Galb1-4GlcNAcb1-3Galb1- |
| | | | 4GlcNAcb1-4)Mana1-3(Galb1-4GlcNAcb1-3Galb1- |
| | | | 4GlcNAcb1-2(NeuAca2-3Galb1-4GlcNAcb1-3Galb1- |
| | | | 4GlcNAcb1-6)Mana1-6)Manb1-4GlcNAcb1-4(Fuca1- |
| | | | 6)GlcNAcOH |
| 942 | N-tetraLac3S2 | Cytosol | Galb1-4GlcNAcb1-2(Galb1-4GlcNAcb1-3Galb1- |
| | | | 4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 943 | N-tetraLac3S2 | Extra-organism | Galb1-4GlcNAcb1-2(Galb1-4GlcNAcb1-3Galb1- |
| | | | 4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 944 | N-tetraLac3S2 | Golgi Apparatus | Galb1-4GlcNAcb1-2(Galb1-4GlcNAcb1-3Galb1- |
| | | | 4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 945 | N-tetraLac3S3 | Cytosol | Galb1-4GlcNAcb1-2(NeuAca2-3Galb1-4GlcNAcb1- |
| | | | 3Galb1-4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 946 | N-tetraLac3S3 | Extra-organism | Galb1-4GlcNAcb1-2(NeuAca2-3Galb1-4GlcNAcb1- |
| | | | 3Galb1-4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 947 | N-tetraLac3S3 | Golgi Apparatus | Galb1-4GlcNAcb1-2(NeuAca2-3Galb1-4GlcNAcb1- |
| | | | 3Galb1-4GlcNAcb1-4)Mana1-3(NeuAca2-3Galb1- |
| | | | 4GlcNAcb1-3Galb1-4GlcNAcb1-2(NeuAca2-3Galb1- |
| | | | 4GlcNAcb1-3Galb1-4GlcNAcb1-6)Mana1-6)Manb1- |
| | | | 4GlcNAcb1-4(Fuca1-6)GlcNAcOH |
| 948 | N-tetraS1/N-triLac1S1 | Cytosol | Gal b1-4 GlcNAc b1-2(Gal b1-4 GlcNAc b1- |
| | | | 4) Man a1-3(NeuAc a2-3 Gal b1-4 GlcNAc b1-2 |
| | | | (Gal b1-4 GlcNAc b1-6) Man a1-6) Man b1- |
| | | | 4 GlcNAc b1-4(Fuc a1-6) GlcNAcOH |
| 949 | N-tetraS1/N-triLac1S1 | Extra-organism | Gal b1-4 GlcNAc b1-2(Gal b1-4 GlcNAc b1- |
| | | | 4) Man a1-3(NeuAc a2-3 Gal b1-4 GlcNAc b1-2 |
| | | | (Gal b1-4 GlcNAc b1-6) Man a1-6) Man b1- |
| | | | 4 GlcNAc b1-4(Fuc a1-6) GlcNAcOH |
| 950 | N-tetraS1/N-triLac1S1 | Golgi Apparatus | Gal b1-4 GlcNAc b1-2(Gal b1-4 GlcNAc b1- |
| | | | 4) Man a1-3(NeuAc a2-3 Gal b1-4 GlcNAc b1-2 |
| | | | (Gal b1-4 GlcNAc b1-6) Man a1-6) Man b1- |
| | | | 4 GlcNAc b1-4(Fuc a1-6) GlcNAcOH |
| 951 | N-tetraS2/N-triLac1S2 | Cytosol | Gal b1-4 GlcNAc b1-2(Gal b1-4 GlcNAc b1- |
| | | | 4) Man a1-3(NeuAc a2-3 Gal b1-4 GlcNAc b1- |
| | | | 2(NeuAc a2-3 Gal b1-4 GlcNAc b1-6) Man a1- |
| | | | 6) Man b1-4 GlcNAc b1-4(Fuc a1-6) GlcNAcOH |
| 952 | N-tetraS2/N-triLac1S2 | Extra-organism | Gal b1-4 GlcNAc b1-2(Gal b1-4 GlcNAc b1- |
| | | | 4) Man a1-3(NeuAc a2-3 Gal b1-4 GlcNAc b1- |
| | | | 2(NeuAc a2-3 Gal b1-4 GlcNAc b1-6) Man a1- |
| | | | 6) Man b1-4 GlcNAc b1-4(Fuc a1-6) GlcNAcOH |
| 953 | N-tetraS2/N-triLac1S2 | Golgi Apparatus | Gal b1-4 GlcNAc b1-2(Gal b1-4 GlcNAc b1- |
| | | | 4) Man a1-3(NeuAc a2-3 Gal b1-4 GlcNAc b1- |
| | | | 2(NeuAc a2-3 Gal b1-4 GlcNAc b1-6) Man a1- |
| | | | 6) Man b1-4 GlcNAc b1-4(Fuc a1-6) GlcNAcOH |
| 954 | N-tetraS3 | Cytosol | Gal b1-4 GlcNAc b1-2(NeuAc a2-3 Gal b1- |
| | | | 4 GlcNAc b1-4) Man a1-3(NeuAc a2-3 Gal b1- |
| | | | 4 GlcNAc b1-2(NeuAc a2-3 Gal b1-4 GlcNAc b1- |
| | | | 6) Man a1-6) Man b1-4 GlcNAc b1-4(Fuc a1- |
| | | | 6) GlcNAcOH |
| 955 | N-tetraS3 | Extra-organism | Gal b1-4 GlcNAc b1-2(NeuAc a2-3 Gal b1- |
| | | | 4 GlcNAc b1-4) Man a1-3(NeuAc a2-3 Gal b1- |
| | | | 4 GlcNAc b1-2(NeuAc a2-3 Gal b1-4 GlcNAc b1- |
| | | | 6) Man a1-6) Man b1-4 GlcNAc b1-4(Fuc a1- |
| | | | 6) GlcNAcOH |
| 956 | N-tetraS3 | Golgi Apparatus | Gal b1-4 GlcNAc b1-2(NeuAc a2-3 Gal b1- |
| | | | 4 GlcNAc b1-4) Man a1-3(NeuAc a2-3 Gal b1- |
| | | | 4 GlcNAc b1-2(NeuAc a2-3 Gal b1-4 GlcNAc b1- |
| | | | 6) Man a1-6) Man b1-4 GlcNAc b1-4(Fuc a1- |
| | | | 6) GlcNAcOH |
| 957 | N-tetraS4 | Cytosol | NeuAc a2-3 Gal b1-4 GlcNAc b1-2(NeuAc a2- |
| | | | 3 Gal b1-4 GlcNAc b1-4) Man a1-3(NeuAc a2- |
| | | | 3 Gal b1-4 GlcNAc b1-2(NeuAc a2-3 Gal b1- |
| | | | 4 GlcNAc b1-6) Man a1-6) Man b1-4 GlcNAc b1- |
| | | | 4(Fuc a1-6) GlcNAcOH |
| 958 | N-tetraS4 | Extra-organism | NeuAc a2-3 Gal b1-4 GlcNAc b1-2(NeuAc a2- |
| | | | 3 Gal b1-4 GlcNAc b1-4) Man a1-3(NeuAc a2- |
| | | | 3 Gal b1-4 GlcNAc b1-2(NeuAc a2-3 Gal b1- |
| | | | 4 GlcNAc b1-6) Man a1-6) Man b1-4 GlcNAc b1- |
| | | | 4(Fuc a1-6) GlcNAcOH |
| 959 | N-tetraS4 | Golgi Apparatus | NeuAc a2-3 Gal b1-4 GlcNAc b1-2(NeuAc a2- |
| | | | 3 Gal b1-4 GlcNAc b1-4) Man a1-3(NeuAc a2- |
| | | | 3 Gal b1-4 GlcNAc b1-2(NeuAc a2-3 Gal b1- |
| | | | 4 GlcNAc b1-6) Man a1-6) Man b1-4 GlcNAc b1- |
| | | | 4(Fuc a1-6) GlcNAcOH |
| 960 | N-tri | Cytosol | Gal b1-4 GlcNAc b1-2 (Gal b1-4 GlcNAc b1-4) |
| | | | Man a1-3(Gal b1-4 GlcNAc b1-2 Man a1-6) Man b1- |
| | | | 4 GlcNAc b1-4(Fuc a1-6) GlcNAcOH |
| 961 | N-tri | Extra-organism | Gal b1-4 GlcNAc b1-2 (Gal b1-4 GlcNAc b1-4) |
| | | | Man a1-3(Gal b1-4 GlcNAc b1-2 Man a1-6) Man b1- |
| | | | 4 GlcNAc b1-4(Fuc a1-6) GlcNAcOH |
| 962 | N-tri | Golgi Apparatus | Gal b1-4 GlcNAc b1-2 (Gal b1-4 GlcNAc b1-4) |
| | | | Man a1-3(Gal b1-4 GlcNAc b1-2 Man a1-6) Man b1- |
| | | | 4 GlcNAc b1-4(Fuc a1-6) GlcNAcOH |
| 963 | N-triS1 | Cytosol | Gal b1-4 GlcNAc b1-2 (Gal b1-4 GlcNAc b1-4) |
| | | | Man a1-3(NeuAc a2-3 Gal b1-4 GlcNAc b1- |
| | | | 2 Man a1-6) Man b1-4 GlcNAc b1-4(Fuc a1- |
| | | | 6) GlcNAcOH |
| 964 | N-triS1 | Extra-organism | Gal b1-4 GlcNAc b1-2 (Gal b1-4 GlcNAc b1-4) |
| | | | Man a1-3(NeuAc a2-3 Gal b1-4 GlcNAc b1- |
| | | | 2 Man a1-6) Man b1-4 GlcNAc b1-4(Fuc a1- |
| | | | 6) GlcNAcOH |
| 965 | N-triS1 | Golgi Apparatus | Gal b1-4 GlcNAc b1-2 (Gal b1-4 GlcNAc b1-4) |
| | | | Man a1-3(NeuAc a2-3 Gal b1-4 GlcNAc b1- |
| | | | 2 Man a1-6) Man b1-4 GlcNAc b1-4(Fuc a1- |
| | | | 6) GlcNAcOH |
| 966 | N-triS2 | Cytosol | Gal b1-4 GlcNAc b1-2 (NeuAc a2-3 Gal b1- |
| | | | 4 GlcNAc b1-4) Man a1-3(NeuAc a2-3 Gal b1-4 |
| | | | GlcNAc b1-2 Man a1-6) Man b1-4 GlcNAc b1- |
| | | | 4(Fuc a1-6) GlcNAcOH |
| 967 | N-triS2 | Extra-organism | Gal b1-4 GlcNAc b1-2 (NeuAc a2-3 Gal b1- |
| | | | 4 GlcNAc b1-4) Man a1-3(NeuAc a2-3 Gal b1-4 |
| | | | GlcNAc b1-2 Man a1-6) Man b1-4 GlcNAc b1- |
| | | | 4(Fuc a1-6) GlcNAcOH |
| 968 | N-triS2 | Golgi Apparatus | Gal b1-4 GlcNAc b1-2 (NeuAc a2-3 Gal b1- |
| | | | 4 GlcNAc b1-4) Man a1-3(NeuAc a2-3 Gal b1-4 |
| | | | GlcNAc b1-2 Man a1-6) Man b1-4 GlcNAc b1- |
| | | | 4(Fuc a1-6) GlcNAcOH |
| 969 | n2m2m | Golgi Apparatus | ((N-acetyl-D-glucosaminyl)2-(alpha-D-mannosyl)2- |
| | | | beta-D-mannosyl-diacetylchitobiose |
| 970 | n2m2mf | Golgi Apparatus | GlcNAc b1-2 Man a1-3(GlcNAc b1-2 Man a1- |
| | | | 6) Man b1-4 GlcNAc b1-4(Fuc a1-6) GlcNAcOH |
| 971 | n2m2mn | Lysosome | de-Fuc, reducing GlcNAc removed, de-Sia, de-Gal |
| | | | form of PA6 (w/o peptide linkage) |
| 972 | n2m2nm | Lysosome | n2m2nmasn (w/o peptide linkage) |
| 973 | n2m2nmasn | Lysosome | N-Acetyl-beta-D-glucosaminyl-1,2-alpha-D- |
| | | | mannosyl-1,3-(N-acetyl-beta-D-glucosaminyl-1,2- |
| | | | alpha-D-mannosyl-1,6)-(N-acetyl-beta-D- |
| | | | glucosaminyl-1,4)-beta-D-mannosyl-1,4-N-acetyl- |
| | | | beta-D-glucosaminyl-R |
| 974 | n2m2nmn | Lysosome | reducing GlcNAc removed form of n2m2nmasn (w/o |
| | | | peptide) |
| 975 | n3m2m | Golgi Apparatus | ((N-acetyl-D-glucosaminyl)3-(alpha-D-mannosyl)2- |
| | | | beta-D-mannosyl-diacetylchitobiose |
| 976 | n3m2mf | Golgi Apparatus | GlcNAc b1-2 (GlcNAc b1-4) Man a1-3(GlcNAc b1- |
| | | | 2 Man a1-6) Man b1-4 GlcNAc b1-4(Fuc a1- |
| | | | 6) GlcNAcOH |
| 977 | n4abutn | Cytosol | N4-Acetylaminobutanal |
| 978 | n4m2m | Golgi Apparatus | ((N-acetyl-D-glucosaminyl)4-(alpha-D-mannosyl)2- |
| | | | beta-D-mannosyl-diacetylchitobiose |
| 979 | n4m2mf | Golgi Apparatus | GlcNAc b1-2(GlcNAc b1-4) Man a1-3(GlcNAc b1- |
| | | | 2(GlcNAc b1-6) Man a1-6) Man b1-4 GlcNAc b1- |
| | | | 4(Fuc a1-6) GlcNAcOH |
| 980 | na1 | Cytosol | Sodium |
| 981 | na1 | Extra-organism | Sodium |
| 982 | na1 | Golgi Apparatus | Sodium |
| 983 | nac | Cytosol | Nicotinate |
| 984 | nad | Cytosol | Nicotinamide adenine dinucleotide |
| 985 | nad | Endoplasmic Reticulum | Nicotinamide adenine dinucleotide |
| 986 | nad | Mitochondria | Nicotinamide adenine dinucleotide |
| 987 | nad | Nucleus | Nicotinamide adenine dinucleotide |
| 988 | nad | Peroxisome | Nicotinamide adenine dinucleotide |
| 989 | nadh | Cytosol | Nicotinamide adenine dinucleotide—reduced |
| 990 | nadh | Endoplasmic Reticulum | Nicotinamide adenine dinucleotide—reduced |
| 991 | nadh | Mitochondria | Nicotinamide adenine dinucleotide—reduced |
| 992 | nadh | Peroxisome | Nicotinamide adenine dinucleotide—reduced |
| 993 | nadp | Cytosol | Nicotinamide adenine dinucleotide phosphate |
| 994 | nadp | Endoplasmic Reticulum | Nicotinamide adenine dinucleotide phosphate |
| 995 | nadp | Mitochondria | Nicotinamide adenine dinucleotide phosphate |
| 996 | nadp | Peroxisome | Nicotinamide adenine dinucleotide phosphate |
| 997 | nadph | Cytosol | Nicotinamide adenine dinucleotide phosphate— |
| | | | reduced |
| 998 | nadph | Endoplasmic Reticulum | Nicotinamide adenine dinucleotide phosphate— |
| | | | reduced |
| 999 | nadph | Mitochondria | Nicotinamide adenine dinucleotide phosphate— |
| | | | reduced |
| 1000 | nadph | Peroxisome | Nicotinamide adenine dinucleotide phosphate— |
| | | | reduced |
| 1001 | naglc2p | Cytosol | N-Acetyl-D-glucosaminyldiphosphodolichol |
| | | | (mammals) |
| 1002 | ncam | Cytosol | Nicotinamide |
| 1003 | nh4 | Cytosol | Ammonium |
| 1004 | nh4 | Extra-organism | Ammonium |
| 1005 | nh4 | Mitochondria | Ammonium |
| 1006 | nicrns | Cytosol | Nicotinate D-ribonucleoside |
| 1007 | nicrnt | Cytosol | Nicotinate D-ribonucleotide |
| 1008 | nicrnt | Mitochondria | Nicotinate D-ribonucleotide |
| 1009 | nicrnt | Nucleus | Nicotinate D-ribonucleotide |
| 1010 | nm2m | Golgi Apparatus | (N-acetyl-D-glucosaminyl-(alpha-D-mannosyl)2-beta- |
| | | | D-mannosyl-diacetylchitobiose |
| 1011 | nm4m | Golgi Apparatus | (alpha-D-mannosyl)4-beta-D-mannosyl- |
| | | | diacetylchitobiose |
| 1012 | nmn | Cytosol | NMN |
| 1013 | nmn | Mitochondria | NMN |
| 1014 | nmn | Nucleus | NMN |
| 1015 | nmnphr | Cytosol | L-Normetanephrine |
| 1016 | nncoa | Mitochondria | nonanoyl-CoA (C9:0CoA) |
| 1017 | nrpphr | Cytosol | Norepinephrine |
| 1018 | nrvnc | Cytosol | nervonic acid |
| 1019 | nrvnc | Extra-organism | nervonic acid |
| 1020 | nrvnccoa | Cytosol | nervonyl coenzyme A |
| 1021 | nrvnccoa | Mitochondria | nervonyl coenzyme A |
| 1022 | nrvnccoa | Peroxisome | nervonyl coenzyme A |
| 1023 | nrvnccrn | Cytosol | Nervonyl carnitine |
| 1024 | nrvnccrn | Mitochondria | Nervonyl carnitine |
| 1025 | ntm2amep | Cytosol | N-Trimethyl-2-aminoethylphosphonate |
| 1026 | nwharg | Cytosol | N-(omega)-Hydroxyarginine |
| 1027 | o2 | Cytosol | O2 |
| 1028 | o2 | Endoplasmic Reticulum | O2 |
| 1029 | o2 | Extra-organism | O2 |
| 1030 | o2 | Mitochondria | O2 |
| 1031 | o2 | Nucleus | O2 |
| 1032 | o2 | Peroxisome | O2 |
| 1033 | o2− | Cytosol | Superoxide |
| 1034 | o2− | Mitochondria | Superoxide |
| 1035 | o2− | Nucleus | Superoxide |
| 1036 | o2− | Peroxisome | Superoxide |
| 1037 | oaa | Cytosol | Oxaloacetate |
| 1038 | oaa | Mitochondria | Oxaloacetate |
| 1039 | occoa | Cytosol | Octanoyl-CoA (C8:0CoA) |
| 1040 | occoa | Mitochondria | Octanoyl-CoA (C8:0CoA) |
| 1041 | occoa | Peroxisome | Octanoyl-CoA (C8:0CoA) |
| 1042 | ocdca | Cytosol | octadecanoate (n-C18:0) |
| 1043 | ocdca | Extra-organism | octadecanoate (n-C18:0) |
| 1044 | ocdcea | Cytosol | octadecenoate (n-C18:1) |
| 1045 | ocdcea | Extra-organism | octadecenoate (n-C18:1) |
| 1046 | ocdcea9 | Cytosol | octadecenoate (C18:1, n-9) |
| 1047 | ocdctra3 | Cytosol | octadecatrienoate (C18:3, n-3) |
| 1048 | ocdctra6 | Cytosol | octadecatrienoate (C18:3, n-6) |
| 1049 | ocdcya | Cytosol | octadecdienoate (n-C18:2) |
| 1050 | ocdcya | Extra-organism | octadecdienoate (n-C18:2) |
| 1051 | ocddea6 | Cytosol | octadecadienoate (C18:2, n-6) |
| 1052 | ocdycacoa | Cytosol | octadecadienoyl-CoA (n-C18:2CoA) |
| 1053 | ocdycacoa | Mitochondria | octadecadienoyl-CoA (n-C18:2CoA) |
| 1054 | ocdycacoa6 | Cytosol | octadecadienoyl-CoA (C18:2CoA, n-6) |
| 1055 | ocdycacoa6 | Mitochondria | octadecadienoyl-CoA (C18:2CoA, n-6) |
| 1056 | ocdycacrn | Cytosol | octadecadienoyl carnitine (C18:2Crn) |
| 1057 | ocdycacrn | Mitochondria | octadecadienoyl carnitine (C18:2Crn) |
| 1058 | ocsttea6 | Cytosol | ocosatetraenoate (C22:4, n-6) |
| 1059 | ocsttea6 | Extra-organism | ocosatetraenoate (C22:4, n-6) |
| 1060 | octa | Cytosol | octanoate |
| 1061 | od2coa | Cytosol | trans-Octadec-2-enoyl-CoA |
| 1062 | od2coa | Mitochondria | trans-Octadec-2-enoyl-CoA |
| 1063 | odcoa3 | Cytosol | octadecatrienoyl-CoA (C18:3CoA, n-3) |
| 1064 | odcoa3 | Mitochondria | octadecatrienoyl-CoA (C18:3CoA, n-3) |
| 1065 | odcoa6 | Cytosol | octadecatrienoyl-CoA (C18:3CoA, n-6) |
| 1066 | odcoa6 | Mitochondria | octadecatrienoyl-CoA (C18:3CoA, n-6) |
| 1067 | odecoa | Cytosol | Octadecenoyl-CoA (n-C18:1CoA) |
| 1068 | odecoa | Mitochondria | Octadecenoyl-CoA (n-C18:1CoA) |
| 1069 | odecoa | Peroxisome | Octadecenoyl-CoA (n-C18:1CoA) |
| 1070 | odecoa9 | Cytosol | octadecenoyl-CoA (C18:1CoA, n-9) |
| 1071 | odecoa9 | Mitochondria | octadecenoyl-CoA (C18:1CoA, n-9) |
| 1072 | odecrn | Cytosol | octadecenoyl carnitine |
| 1073 | odecrn | Mitochondria | octadecenoyl carnitine |
| 1074 | orn | Cytosol | Ornithine |
| 1075 | orn | Extra-organism | Ornithine |
| 1076 | orn-L | Cytosol | L-Ornithine |
| 1077 | orn-L | Extra-organism | L-Ornithine |
| 1078 | orn-L | Mitochondria | L-Ornithine |
| 1079 | orot | Cytosol | Orotate |
| 1080 | orot5p | Cytosol | Orotidine 5′-phosphate |
| 1081 | osttcoa6 | Cytosol | ocosatetraenoyl-CoA (C22:4CoA, n-6) |
| 1082 | osttcoa6 | Mitochondria | ocosatetraenoyl-CoA (C22:4CoA, n-6) |
| 1083 | oxa | Cytosol | Oxalate |
| 1084 | pa_CHO | Cytosol | Phosphatidate, CHO specific |
| 1085 | pa_CHO | Mitochondria | Phosphatidate, CHO specific |
| 1086 | pacald | Cytosol | Phenylacetaldehyde |
| 1087 | pan4p | Cytosol | Pantetheine 4′-phosphate |
| 1088 | pap | Cytosol | Adenosine 3′,5′-bisphosphate |
| 1089 | paps | Cytosol | 3′-Phosphoadenylyl sulfate |
| 1090 | pc_CHO | Cytosol | phosphatidylcholine, CHO specific |
| 1091 | pdcoa | Cytosol | pentadecanoyl-CoA (C15:0CoA) |
| 1092 | pdcoa | Mitochondria | pentadecanoyl-CoA (C15:0CoA) |
| 1093 | pdx5p | Cytosol | Pyridoxine 5′-phosphate |
| 1094 | pe_CHO | Cytosol | phosphatidylethanolamine, CHO specific |
| 1095 | pep | Cytosol | Phosphoenolpyruvate |
| 1096 | pep | Mitochondria | Phosphoenolpyruvate |
| 1097 | pg_CHO | Mitochondria | phosphatidylglycerol, CHO specific |
| 1098 | pgp_CHO | Mitochondria | Phosphatidylglycerophosphate, CHO specific |
| 1099 | phe-L | Cytosol | L-Phenylalanine |
| 1100 | phe-L | Extra-organism | L-Phenylalanine |
| 1101 | phe-L | Mitochondria | L-Phenylalanine |
| 1102 | pheamn | Cytosol | Phenethylamine |
| 1103 | pheme | Cytosol | Protoheme |
| 1104 | pheme | Extra-organism | Protoheme |
| 1105 | pheme | Mitochondria | Protoheme |
| 1106 | phom | Cytosol | O-Phospho-L-homoserine |
| 1107 | phpyr | Cytosol | Phenylpyruvate |
| 1108 | phpyr | Mitochondria | Phenylpyruvate |
| 1109 | phyt | Cytosol | phytanic acid |
| 1110 | phytcoa | Cytosol | phytanyl coa |
| 1111 | phytcoa | Peroxisome | phytanyl coa |
| 1112 | pi | Cytosol | Phosphate |
| 1113 | pi | Endoplasmic Reticulum | Phosphate |
| 1114 | pi | Extra-organism | Phosphate |
| 1115 | pi | Golgi Apparatus | Phosphate |
| 1116 | pi | Mitochondria | Phosphate |
| 1117 | pi | Peroxisome | Phosphate |
| 1118 | pino_CHO | Cytosol | phosphatidyl-1D-myo-inositol, CHO specific |
| 1119 | pmtcoa | Cytosol | Palmitoyl-CoA (n-C16:0CoA) |
| 1120 | pmtcoa | Mitochondria | Palmitoyl-CoA (n-C16:0CoA) |
| 1121 | pmtcoa | Peroxisome | Palmitoyl-CoA (n-C16:0CoA) |
| 1122 | pmtcrn | Cytosol | L-Palmitoylcarnitine (C16:0Crn) |
| 1123 | pmtcrn | Mitochondria | L-Palmitoylcarnitine (C16:0Crn) |
| 1124 | pnto-R | Cytosol | (R)-Pantothenate |
| 1125 | pnto-R | Extra-organism | (R)-Pantothenate |
| 1126 | ppa | Cytosol | Propionate |
| 1127 | ppbng | Cytosol | Porphobilinogen |
| 1128 | ppcoa | Cytosol | Propanoyl-CoA (C3:0CoA) |
| 1129 | ppcoa | Mitochondria | Propanoyl-CoA (C3:0CoA) |
| 1130 | ppcoa | Peroxisome | Propanoyl-CoA (C3:0CoA) |
| 1131 | ppi | Cytosol | Diphosphate |
| 1132 | ppi | Endoplasmic Reticulum | Diphosphate |
| 1133 | ppi | Mitochondria | Diphosphate |
| 1134 | ppi | Nucleus | Diphosphate |
| 1135 | ppi | Peroxisome | Diphosphate |
| 1136 | ppp9 | Cytosol | Protoporphyrin |
| 1137 | ppp9 | Mitochondria | Protoporphyrin |
| 1138 | pppg9 | Cytosol | Protoporphyrinogen IX |
| 1139 | pppg9 | Mitochondria | Protoporphyrinogen IX |
| 1140 | pppi | Cytosol | Inorganic triphosphate |
| 1141 | pram | Cytosol | 5-Phospho-beta-D-ribosylamine |
| 1142 | prgnlone | Cytosol | Pregnenolone |
| 1143 | prgstrn | Cytosol | Progesterone |
| 1144 | prist | Cytosol | pristanic acid |
| 1145 | pristcoa | Cytosol | pristanoyl coa |
| 1146 | pristcoa | Peroxisome | pristanoyl coa |
| 1147 | pro-L | Cytosol | L-Proline |
| 1148 | pro-L | Extra-organism | L-Proline |
| 1149 | pro-L | Mitochondria | L-Proline |
| 1150 | prpncoa | Mitochondria | Propenoyl-CoA |
| 1151 | prpp | Cytosol | 5-Phospho-alpha-D-ribose 1-diphosphate |
| 1152 | ps_CHO | Cytosol | Phosphatidylserine, CHO specific |
| 1153 | pser-L | Cytosol | O-Phospho-L-serine |
| 1154 | ptcoa | Mitochondria | Pentanoyl-CoA (C5:0CoA) |
| 1155 | ptdca | Cytosol | pentadecanoate (C15:0) |
| 1156 | ptdcacoa | Mitochondria | pentadecanoyl Coenzyme A |
| 1157 | ptrc | Cytosol | Putrescine |
| 1158 | ptrc | Extra-organism | Putrescine |
| 1159 | ptrc | Mitochondria | Putrescine |
| 1160 | pyam5p | Cytosol | Pyridoxamine 5′-phosphate |
| 1161 | pydam | Cytosol | Pyridoxamine |
| 1162 | pydx | Cytosol | Pyridoxal |
| 1163 | pydx5p | Cytosol | Pyridoxal 5′-phosphate |
| 1164 | pydxn | Cytosol | Pyridoxine |
| 1165 | pyr | Cytosol | Pyruvate |
| 1166 | pyr | Extra-organism | Pyruvate |
| 1167 | pyr | Mitochondria | Pyruvate |
| 1168 | q10h2 | Mitochondria | Ubiquinol-10 |
| 1169 | r1p | Cytosol | alpha-D-Ribose 1-phosphate |
| 1170 | r5p | Cytosol | alpha-D-Ribose 5-phosphate |
| 1171 | retinal | Cytosol | Retinal |
| 1172 | ribflv | Cytosol | Riboflavin |
| 1173 | rnam | Cytosol | N-Ribosylnicotinamide |
| 1174 | Rtotalcoa | Cytosol | R total Coenzyme A |
| 1175 | Rtotalcoa | Mitochondria | R total Coenzyme A |
| 1176 | Rtotalcoa | Peroxisome | R total Coenzyme A |
| 1177 | ru5p-D | Cytosol | D-Ribulose 5-phosphate |
| 1178 | s2l2fn2m2masn | Lysosome | PA6 |
| 1179 | s2l2n2m2m | Lysosome | de-Fuc form of PA6 (w/o peptide linkage) |
| 1180 | s2l2n2m2masn | Lysosome | de-Fuc form of PA6 |
| 1181 | s2l2n2m2mn | Lysosome | de-Fuc, reducing GlcNAc removed form of PA6 (w/o |
| | | | peptide linkage) |
| 1182 | s7p | Cytosol | Sedoheptulose 7-phosphate |
| 1183 | sarcs | Cytosol | Sarcosine |
| 1184 | sarcs | Mitochondria | Sarcosine |
| 1185 | sarcs | Peroxisome | Sarcosine |
| 1186 | seahcys | Cytosol | Se-Adenosylselenohomocysteine |
| 1187 | seasmet | Cytosol | Se-Adenosylselenomethionine |
| 1188 | sel | Cytosol | Selenate |
| 1189 | selcys | Cytosol | Selenocysteine |
| 1190 | selhcys | Cytosol | Selenohomocysteine |
| 1191 | selmeth | Cytosol | Selenomethionine |
| 1192 | seln | Cytosol | Selenide |
| 1193 | selnp | Cytosol | Selenophosphate |
| 1194 | ser-L | Cytosol | L-Serine |
| 1195 | ser-L | Extra-organism | L-Serine |
| 1196 | ser-L | Mitochondria | L-Serine |
| 1197 | sl-L | Mitochondria | L-sulfolactate |
| 1198 | so3 | Cytosol | Sulfite |
| 1199 | so3 | Extra-organism | Sulfite |
| 1200 | so4 | Cytosol | Sulfate |
| 1201 | so4 | Lysosome | Sulfate |
| 1202 | sopyr | Cytosol | 3-Sulfopyruvate |
| 1203 | sopyr | Mitochondria | 3-Sulfopyruvate |
| 1204 | sph1p | Endoplasmic Reticulum | Sphinganine 1-phosphate |
| 1205 | sphgmy_CHO | Cytosol | Sphingomyeline, CHO specific |
| 1206 | sphgn | Cytosol | Sphinganine |
| 1207 | sphs1p | Endoplasmic Reticulum | Sphingosine 1-phosphate |
| 1208 | spmd | Cytosol | Spermidine |
| 1209 | spmd | Extra-organism | Spermidine |
| 1210 | sprm | Cytosol | Spermine |
| 1211 | spyr | Cytosol | 3-Sulfinylpyruvate |
| 1212 | spyr | Mitochondria | 3-Sulfinylpyruvate |
| 1213 | sql | Endoplasmic Reticulum | Squalene |
| 1214 | srtn | Cytosol | Serotonin |
| 1215 | Ssq23epx | Endoplasmic Reticulum | (S)-Squalene-2,3-epoxide |
| 1216 | strcoa | Cytosol | Stearyl-CoA (n-C18:0CoA) |
| 1217 | strcoa | Mitochondria | Stearyl-CoA (n-C18:0CoA) |
| 1218 | strcoa | Peroxisome | Stearyl-CoA (n-C18:0CoA) |
| 1219 | strcrn | Cytosol | Stearoylcarnitine (C18:0Crn) |
| 1220 | strcrn | Mitochondria | Stearoylcarnitine (C18:0Crn) |
| 1221 | strdnccoa | Cytosol | stearidonyl coenzyme A (C18:4CoA) |
| 1222 | strdnccoa | Mitochondria | stearidonyl coenzyme A (C18:4CoA) |
| 1223 | strdnccoa | Peroxisome | stearidonyl coenzyme A (C18:4CoA) |
| 1224 | succ | Mitochondria | Succinate |
| 1225 | succoa | Mitochondria | Succinyl-CoA |
| 1226 | sucsal | Mitochondria | Succinic semialdehyde |
| 1227 | t2m26dcoa | Mitochondria | trans-2-Methyl-5-isopropylhexa-2,5-dienoyl-CoA |
| 1228 | t2m26dcoa | Peroxisome | trans-2-Methyl-5-isopropylhexa-2,5-dienoyl-CoA |
| 1229 | taur | Cytosol | Taurine |
| 1230 | tcggrpp | Cytosol | trans,trans,cis-Geranylgeranyl pyrophosphate |
| 1231 | tdcoa | Cytosol | Tetradecanoyl-CoA (n-C14:0CoA) |
| 1232 | tdcoa | Mitochondria | Tetradecanoyl-CoA (n-C14:0CoA) |
| 1233 | tdcoa | Peroxisome | Tetradecanoyl-CoA (n-C14:0CoA) |
| 1234 | tdcrn | Cytosol | tetradecanoylcarnitine (C14:0Crn) |
| 1235 | tdcrn | Mitochondria | tetradecanoylcarnitine (C14:0Crn) |
| 1236 | tdecoa7 | Cytosol | tetradecenoyl-CoA (C14:1CoA, n-7) |
| 1237 | tdecoa7 | Mitochondria | tetradecenoyl-CoA (C14:1CoA, n-7) |
| 1238 | tethex3coa | Peroxisome | tetracosahexaenoyl coenzyme A |
| 1239 | tetpent3coa | Peroxisome | tetracosapentaenoyl coenzyme A, n-3 |
| 1240 | tetpent6coa | Peroxisome | tetracosapentaenoyl coenzyme A, n-6 |
| 1241 | tettet6coa | Peroxisome | tetracosatetraenoyl coenzyme A |
| 1242 | thbpt | Cytosol | Tetrahydrobiopterin |
| 1243 | thcholstoic | Endoplasmic Reticulum | 3alpha,7alpha,12alpha-Trihydroxy-5beta- |
| | | | cholestanoate |
| 1244 | thcholstoic | Peroxisome | 3alpha,7alpha,12alpha-Trihydroxy-5beta- |
| | | | cholestanoate |
| 1245 | thf | Cytosol | 5,6,7,8-Tetrahydrofolate |
| 1246 | thf | Mitochondria | 5,6,7,8-Tetrahydrofolate |
| 1247 | thm | Cytosol | Thiamin |
| 1248 | thmpp | Cytosol | Thiamine diphosphate |
| 1249 | thr-L | Cytosol | L-Threonine |
| 1250 | thr-L | Extra-organism | L-Threonine |
| 1251 | thr-L | Mitochondria | L-Threonine |
| 1252 | thym | Cytosol | Thymine |
| 1253 | thymd | Cytosol | Thymidine |
| 1254 | thymd | Extra-organism | Thymidine |
| 1255 | trans-dd2coa | Mitochondria | trans-Dodec-2-enoyl-CoA |
| 1256 | trdcoa | Mitochondria | tridecanoyl-CoA (C13:0CoA) |
| 1257 | trdox | Cytosol | Oxidized thioredoxin |
| 1258 | trdox | Mitochondria | Oxidized thioredoxin |
| 1259 | trdrd | Cytosol | Reduced thioredoxin |
| 1260 | trdrd | Mitochondria | Reduced thioredoxin |
| 1261 | tre | Cytosol | Trehalose |
| 1262 | triglyc_CHO | Cytosol | Triglyceride, CHO specific |
| 1263 | trp-L | Cytosol | L-Tryptophan |
| 1264 | trp-L | Extra-organism | L-Tryptophan |
| 1265 | trypta | Cytosol | Tryptamine |
| 1266 | tsul | Cytosol | Thiosulfate |
| 1267 | ttc | Cytosol | tetracosanoate (n-C24:0) |
| 1268 | ttc | Extra-organism | tetracosanoate (n-C24:0) |
| 1269 | ttccoa | Peroxisome | tetracosanoyl-CoA (n-C24:0CoA) |
| 1270 | ttdca | Cytosol | tetradecanoate (C14:0) |
| 1271 | ttdca | Extra-organism | tetradecanoate (C14:0) |
| 1272 | ttdcea7 | Cytosol | tetradecenoate (C14:1, n-7) |
| 1273 | Tyr-ggn | Cytosol | Tyr-194 of apo-glycogenin protein (primer for |
| | | | glycogen synthesis) |
| 1274 | tyr-L | Cytosol | L-Tyrosine |
| 1275 | tyr-L | Extra-organism | L-Tyrosine |
| 1276 | tyr-L | Mitochondria | L-Tyrosine |
| 1277 | tyramine | Cytosol | Tyramine |
| 1278 | uacgam | Cytosol | UDP-N-acetyl-D-glucosamine |
| 1279 | uacgam | Golgi Apparatus | UDP-N-acetyl-D-glucosamine |
| 1280 | ubq10 | Mitochondria | Ubiquinone-10 |
| 1281 | udp | Cytosol | UDP |
| 1282 | udp | Golgi Apparatus | UDP |
| 1283 | udp | Nucleus | UDP |
| 1284 | udpacgal | Cytosol | UDP-N-acetyl-D-galactosamine |
| 1285 | udpg | Cytosol | UDPglucose |
| 1286 | udpgal | Cytosol | UDPgalactose |
| 1287 | udpgal | Golgi Apparatus | UDPgalactose |
| 1288 | udpglcur | Cytosol | UDP-D-glucuronate |
| 1289 | udpglcur | Golgi Apparatus | UDP-D-glucuronate |
| 1290 | udpxyl | Golgi Apparatus | UDP-D-xylose |
| 1291 | ump | Cytosol | UMP |
| 1292 | ump | Golgi Apparatus | UMP |
| 1293 | ump | Nucleus | UMP |
| 1294 | uppg3 | Cytosol | Uroporphyrinogen III |
| 1295 | ura | Cytosol | Uracil |
| 1296 | urcan | Cytosol | Urocanate |
| 1297 | urea | Cytosol | Urea |
| 1298 | urea | Extra-organism | Urea |
| 1299 | urea | Mitochondria | Urea |
| 1300 | uri | Cytosol | Uridine |
| 1301 | utp | Cytosol | UTP |
| 1302 | utp | Nucleus | UTP |
| 1303 | vacccoa | Cytosol | vaccenyl coenzyme A (C18:1CoA) |
| 1304 | vacccoa | Mitochondria | vaccenyl coenzyme A (C18:1CoA) |
| 1305 | val-L | Cytosol | L-Valine |
| 1306 | val-L | Extra-organism | L-Valine |
| 1307 | val-L | Mitochondria | L-Valine |
| 1308 | xan | Cytosol | Xanthine |
| 1309 | xmp | Cytosol | Xanthosine 5′-phosphate |
| 1310 | xol7a | Endoplasmic Reticulum | 7 alpha-Hydroxycholesterol |
| 1311 | xol7aone | Endoplasmic Reticulum | 7alpha-Hydroxycholest-4-en-3-one |
| 1312 | xtp | Cytosol | XTP |
| 1313 | xtsn | Cytosol | Xanthosine |
| 1314 | xu5p-D | Cytosol | D-Xylulose 5-phosphate |
| 1315 | zym_int2 | Endoplasmic Reticulum | zymosterone |
| 1316 | zymst | Endoplasmic Reticulum | Zymosterol |
| 1317 | zymstnl | Endoplasmic Reticulum | Zymostenol |

1. A computer readable medium or media having stored thereon computer-implemented instructions suitably programmed to cause a processor to perform the computer executable steps of:
(a) providing a data structure relating a plurality of reactants to a plurality of reactions, wherein said plurality of reactants and said plurality of reactions are a selection of reactants and reactions as shown in Tables 1, 3 and 4 for a Chinese hamster ovary (CHO) cell, and wherein said data structure relates a plurality of reactants and a plurality of reactions selected from the reactants and reactions as shown in Tables 1 and 2 for a CHO cell transcriptome, or
providing a data structure relating a plurality of reactants to a plurality of reactions, wherein said plurality of reactants and said plurality of reactions are a selection of reactants and reactions as shown in Tables 5, 8 and 9 for a Chinese hamster ovary (CHO) cell, and wherein said data structure relates a plurality of reactants and a plurality of reactions selected from the reactants and reactions as shown in Tables 5, 6 and 7 for a CHO cell transcriptome;
(b) providing a constraint set for said plurality of reactions for said data structure;
(c) determining at least one flux distribution that minimizes or maximizes an objective function when said constraint set is applied to said data structure, wherein said at least one flux distribution is predictive of a physiological function of said CHO cell or a culture condition for said CHO cell; and
(d) providing output to a user of said at least one flux distribution determined in step (c).

2. The computer readable medium or media of claim 1, wherein said objective function is uptake rate of two or more nutrients, wherein said two or more nutrients are carbon sources;
wherein said objective function comprises product formation, energy synthesis, biomass production, or a combination thereof; or
wherein said objective function comprises decreasing byproduct formation.

3-4. (canceled)

5. The computer readable medium or media of claim 1, wherein said culture condition is selected from the group consisting of optimized culture medium for said cell, optimized cell culture process, optimized cell productivity, and metabolic engineering of said cell.

6. The computer readable medium or media of claim 5, wherein optimized cell productivity is selected from the group consisting of increased biomass production and increased product yield.

7. The computer readable medium or media of claim 1, wherein said culture condition is selected from the group consisting of reduced scale up variability, reduced batch to batch variability, reduced clonal variability, improved cell growth, viable cell density and cell productivity in exponential growth phase or stationary phase.

8-10. (canceled)

11. The computer readable medium or media of claim 1, wherein said physiological function is selected from the group consisting of growth, energy production, redox equivalent production, biomass production, production of biomass precursors, production of a protein, production of an amino acid, production of a purine, production of a pyrimidine, production of a lipid, production of a fatty acid, production of a cofactor, transport of a metabolite, and consumption of carbon, nitrogen, sulfur, phosphate, hydrogen or oxygen.

12. The computer readable medium or media of claim 1, wherein said plurality of reactions comprises at least one reaction from peripheral metabolic pathway.

13. The computer readable medium or media of claim 12, wherein said peripheral metabolic pathway is selected from the group consisting of amino acid biosynthesis, amino acid degradation, purine biosynthesis, pyrimidine biosynthesis, lipid biosynthesis, fatty acid metabolism, cofactor biosynthesis and transport processes.

14-18. (canceled)

19. The computer readable medium or media of claim 1, wherein at least one reactant in said plurality of reactants or at least one reaction in said plurality of reactions is annotated with an assignment to a subsystem or compartment.

20. The computer readable medium or media of claim 19, wherein at least a first substrate or product in said plurality of reactions is assigned to a first compartment and at least a second substrate or product in said plurality of reactions is assigned to a second compartment.

21. A method for predicting a culture condition for a CHO cell, comprising:
(a) providing a data structure relating a plurality of reactants to a plurality of reactions from a CHO cell, wherein said plurality of reactants and said plurality of reactions are a selection of reactants and reactions as shown in Table 1, 3 and 4 for a Chinese hamster ovary (CHO) cell, and wherein said data structure relates a plurality of reactants and a plurality of reactions selected from the reactants and reactions as shown in Tables 1 and 2 for a CHO cell transcriptome, each of said reactions comprising a reactant identified as a substrate of the reaction, a reactant identified as a product of the reaction and a stoichiometric coefficient relating said substrate and said product, wherein said plurality of reactions comprises one or more extracellular exchange reactions, or
providing a data structure relating a plurality of reactants to a plurality of reactions from a CHO cell, wherein said plurality of reactants and said plurality of reactions are a selection of reactants and reactions as shown in Tables 5, 8 and 9 for a Chinese hamster ovary (CHO) cell, and wherein said data structure relates a plurality of reactants and a plurality of reactions selected from the reactants and reactions as shown in Tables 5, 6 and 7 for a CHO cell transcriptome, each of said reactions comprising a reactant identified as a substrate of the reaction, a reactant identified as a product of the reaction and a stoichiometric coefficient relating said substrate and said product, wherein said plurality of reactions comprises one or more extracellular exchange reactions;
(b) providing a constraint set for said plurality of reactions for said data structure;
(c) providing an objective function, wherein said objective function is uptake rate of two or more nutrients, wherein said two or more nutrients are carbon sources;
(d) determining at least one flux distribution that minimizes or maximizes the objective function when said constraint set is applied to said data structure, wherein said at least one flux distribution is predictive of a culture condition for said eukaryotic cell; and
(e) providing output to a user of said at least one flux distribution determined in step (d).

22. The method of claim 21, wherein said objective function further comprises product formation, energy synthesis, biomass production, decreasing byproduct formation or a combination thereof.

23. (canceled)

24. The method of claim 21, wherein said culture condition is selected from optimized culture medium for said cell, optimized cell culture process, optimized cell productivity, and metabolic engineering of said cell.

25. The method of claim 24, wherein optimized cell productivity is selected from the group consisting of increased biomass production and increased product yield.

26. The method of claim 21, wherein said culture condition is selected from the group consisting of reduced scale up variability, reduced batch to batch variability, reduced clonal variability, improved cell growth, viable cell density and cell productivity in exponential growth phase or stationary phase.

27-33. (canceled)

34. The method of claim 21, wherein at least one reactant in said plurality of reactants or at least one reaction in said plurality of reactions is annotated with an assignment to a subsystem or compartment.

35. The method of claim 34, wherein at least a first substrate or product in said plurality of reactions is assigned to a first compartment and at least a second substrate or product in said plurality of reactions is assigned to a second compartment.

36. A method for optimizing a Chinese hamster ovary (CHO) cell to produce a product comprising:
(a) providing a data structure relating a plurality of reactants to a plurality of reactions, wherein said plurality of reactants and said plurality of reactions are a selection of reactants and reactions as shown in Tables 1, 3, and 4 for a CHO cell, and wherein said data structure relates a plurality of reactants and a plurality of reactions selected from the reactants and reactions as shown in Tables 1 and 2 for a CHO cell transcriptome, or
providing a data structure relating a plurality of reactants to a plurality of reactions, wherein said plurality of reactants and said plurality of reactions are a selection of reactants and reactions as shown in Tables 5, 8 and 9 for a Chinese hamster ovary (CHO) cell, and wherein said data structure relates a plurality of reactants and a plurality of reactions selected from the reactants and reactions as shown in Tables 5, 6 and 7 for a CHO cell transcriptome;
(b) providing a constraint set for said plurality of reactions for said data structure;
(c) determining at least one flux distribution that minimizes or maximizes an objective function when said constraint set is applied to said data structure, wherein said at least one flux distribution is predictive of producing a product in said CHO cell; and
(d) modifying said CHO cell as determined in step (c).

37. (canceled)

38. The method of claim 36, wherein said objective function comprises product formation, energy synthesis, biomass production, decreasing byproduct formation, production of said product or a combination thereof.

39. (canceled)

40. The method of claim 36, wherein said culture condition is selected from the group consisting of optimized culture medium for said cell, optimized cell culture process, optimized cell productivity, and metabolic engineering of said cell.

41-84. (canceled)
